(19) United States
(12) Patent Application Publication
(10) Pub. No.: US 2008/0119994 A1
(43) Pub. Date: May 22, 2008

(54) VEHICULAR USER HOSPITALITY SYSTEM

(75) Inventor: Shougo KAMEYAMA, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/940,594

(22) Filed: Nov. 15, 2007

(30) Foreign Application Priority Data
Nov. 20, 2006 (JP) 2006-313529

(51) Int. Cl. G05D 27/02; G06F 9/00; G06F 19/00

(52) U.S. Cl. 701/48; 701/1; 701/36; 701/49

(57) ABSTRACT

A vehicular user hospitality system is provided for detecting a condition of a user, and for controlling operations of a vehicular devices autonomously in the manner most desired (or estimated to be desired) by the user. A content of an operation of a hospitality operation portion changes in accordance with a content of user biological characteristic information. Service (hospitality) effect for the user using a vehicle can be further optimized in accordance with a mental or physical condition of the user. Specifically, standard reference information about an operation control of a function specified from a function extraction matrix is extracted. A physical or mental condition reflected by separately obtained user biological characteristic information is added to this standard reference information. Accordingly, the operation content of the selected function can be optimized.

### CROSS REFERENCE TO RELATED APPLICATION

This application is based on and incorporates herein by reference Japanese Patent Application No. 2006-313529 filed on Nov. 20, 2006.

### FIELD OF THE INVENTION

The present invention relates to a vehicular user hospitality system for assisting use of a vehicle by a user or entertaining (servicing) the user in at least one of a scene when the user approaches the vehicle, a scene when the user gets in the vehicle, a scene when the user drives the vehicle, a scene when the user gets off the vehicle, and a scene when the user separates from the vehicle.

### BACKGROUND OF THE INVENTION

An automatic adjustment device of a vehicular device using a mobile phone is disclosed in Patent Document 1. In this device, a mobile phone carried by a passenger of a vehicle communicates with a radio device mounted in the vehicle to adjust an air conditioner, a car stereo, a light axis of a headlamp, an electric seat, or an electric mirror under the condition registered by each user of a mobile phone. A technique for grasping the number of passengers in a vehicle and a position of the vehicle by use of the GPS (Global Positioning System) to adjust a balance of a sound volume of and a frequency characteristic of an audio device is disclosed in Patent Document 1.

A vehicular user hospitality system in which operations of hospitality operation portions change in accordance with a distance between a user and a vehicle is disclosed in Patent Document 2.

However, the above device adjusts the vehicular devices after the passenger (user) gets in the vehicle. The above Patent Documents do not disclose a concept for adjusting the vehicular devices before the user gets in the vehicle. This is clear from the fact that, in the Documents, the vehicular communications device for mobile phones is a short distance radio communications device (blue tooth terminal: a distance within which communications are possible is defined in the specification as 10 m at most), and the blue tooth terminal communicates with only the mobile phone inside the vehicle. Additionally, a content of a hospitality (hospitality object of the vehicle) desired by the user and a condition of the user change slightly in various scenes where the user uses the vehicle, but the vehicular device is adjusted uniformly regardless of the change.

Therefore, disadvantageously, a hospitality content not desired by the user is executed, and the user gets tired of the hospitalities after several uses of the hospitalities.
Patent Document 1: JP-A-2003-312391
Patent Document 2; JP-A-2006-69296 (US2006/0046684)

### SUMMARY OF THE INVENTION

An object of the present invention is to provide a vehicular user hospitality system for autonomously controlling operations of vehicular devices in the manner most desired (or considered to be most desired) by a user, and for actively offering hospitality to the user as a host or guest in the vehicle, by more clearly specifying a hospitality object in various scenes to optimize an applied hospitality function, and by considering a condition of the user.

To achieve the above object, according to an example of the present invention, a vehicular user hospitality system is provided to comprise: hospitality operation portions for executing a hospitality operation to assist use of a vehicle by a user or to entertain the user in each of a plurality of scenes, into which a series of motions of the user using the vehicle when the user approaches, gets on, drives or stays in, and gets off the vehicle are divided; a hospitality determination section including (i) a scene estimation information obtaining means for obtaining a position or a motion of the user as scene estimation information, the position and the motion being predetermined in each of the scenes, (ii) a scene specifying means for specifying each of the scenes in accordance with the obtained scene estimation information, and (iii) a hospitality content determining means for determining a hospitality operation portion to be used and a content of a hospitality operation by the hospitality operation portion to be used in accordance with the specified scene; and a hospitality control section (3) for executing the hospitality operation in accordance with the content determined by the hospitality determination section by controlling an operation of the corresponding hospitality operation portion. Here, the hospitality determination section further includes (i) a function extraction matrix storage portion for storing a function extraction matrix having a two-dimensional array formed by type items of hospitality objects prepared for each of the scenes and function items of the hospitality operation portions, the function extraction matrix including standard reference information referenced as a standard to recognize whether a function corresponding to each matrix cell matches the hospitality object corresponding to the each matrix cell when an operation of the function is controlled, (ii) a function extracting means for extracting a function matching the hospitality object for the specified scene, and reading the standard reference information corresponding to the extracted function, (iii) a user biological characteristic information obtaining means for obtaining at least one of a physical condition and a mental condition of the user, and (iv) an operation content determining means for determining an operation content of a corresponding function in accordance with the obtained user biological characteristic information and the obtained standard reference information.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing one example of an electric structure of a vehicular user hospitality system of the present invention;

FIG. 2 is a block diagram showing one example of an electric structure of a vehicle interior light;

FIG. 3 is a schematic diagram showing an example of a structure of illumination control data of a lighting device;

FIG. 4 is a circuit diagram showing one example of the lighting device using a light emitting diode;

FIG. 5 shows a relationship between mixture ratios of each illumination light of RGB full color lighting and luminous colors;

FIG. 6 is a block diagram showing one example of an electric structure of a car audio system;

FIG. 7 is a schematic block diagram showing one example of an structure of a noise canceller;

FIG. 8 is a block diagram showing one example of an structure of hardware;

FIG. 9 is a circuit diagram showing one example of hardware generating an attitude signal waveform;

FIG. 10 is an image of various specified conditions;

FIG. 11 is a schematic diagram showing a content of a music source database;

FIG. 12 is a diagram showing content of a scene flag;

FIG. 13 shows a first example of an object estimation matrix;

FIG. 14 shows a first example of a function extraction matrix;

FIG. 15 shows a second example of the object estimation matrix;

FIG. 16 shows a second example of the function extraction matrix;

FIG. 17 shows a third example of the object estimation matrix;

FIG. 18 shows a third example of the function extraction matrix;

FIG. 19 shows a forth example of the object estimation matrix;

FIG. 20 shows a forth example of the function extraction matrix;

FIG. 21 is a flowchart showing an entire flow of a hospitality process;

FIG. 22 is a flowchart showing a flow of a scene determination process;

FIG. 23 is a schematic diagram showing a content of user registration information;

FIG. 24 is a schematic diagram showing a content of a music selection history storage portion;

FIG. 25 is a schematic diagram showing a content of statistics information about the music selection history;

FIG. 26 shows one example of a music selection random number table;

FIG. 27 is a flowchart showing one example of a hospitality source determination process;

FIG. 28 is a flowchart showing one example of a facial expression analysis algorithm;

FIGS. 29A, 29B are a flowchart showing one example of body temperature waveform acquisition and of its analysis algorithm;

FIG. 30 is a diagram showing some waveform analysis techniques;

FIG. 31 shows one example of a determination table;

FIG. 32 is a flowchart showing one example of a condition specifying process;

FIG. 33 is a diagram showing one example of a hospitality operation in an approach scene;

FIG. 34 is a schematic diagram showing a content of a stress reflecting operation statistics storage portion;

FIG. 35 is a flowchart showing a flow of a character analysis process;

FIGS. 36A, 36B are a flowchart showing one example of obtaining a skin resistance waveform and of its analysis algorithm;

FIGS. 37A, 37B are a flowchart showing one example of obtaining an attitude signal waveform and of its analysis algorithm;

FIGS. 38A, 38B are a flowchart showing one example of obtaining a visual axis angle waveform and of its analysis algorithm;

FIGS. 39A, 39B are a flowchart showing one example of obtaining a pupil diameter waveform and of its analysis algorithm;

FIGS. 40A, 40B are a flowchart showing one example of obtaining a steering angle waveform and of its analysis algorithm;

FIG. 41 is an image of a traveling monitor;

FIG. 42 is a flowchart showing one example of a traveling monitor data obtaining process;

FIG. 43 is a flowchart showing one example of a steering accuracy analysis process using the traveling monitor data; and

FIGS. 44A, 44B are a flowchart showing one example of obtaining a blood pressure waveform and of its analysis algorithm.

### DETAILED DESCRIPTION OF THE PREFERRED EMBODIMENTS

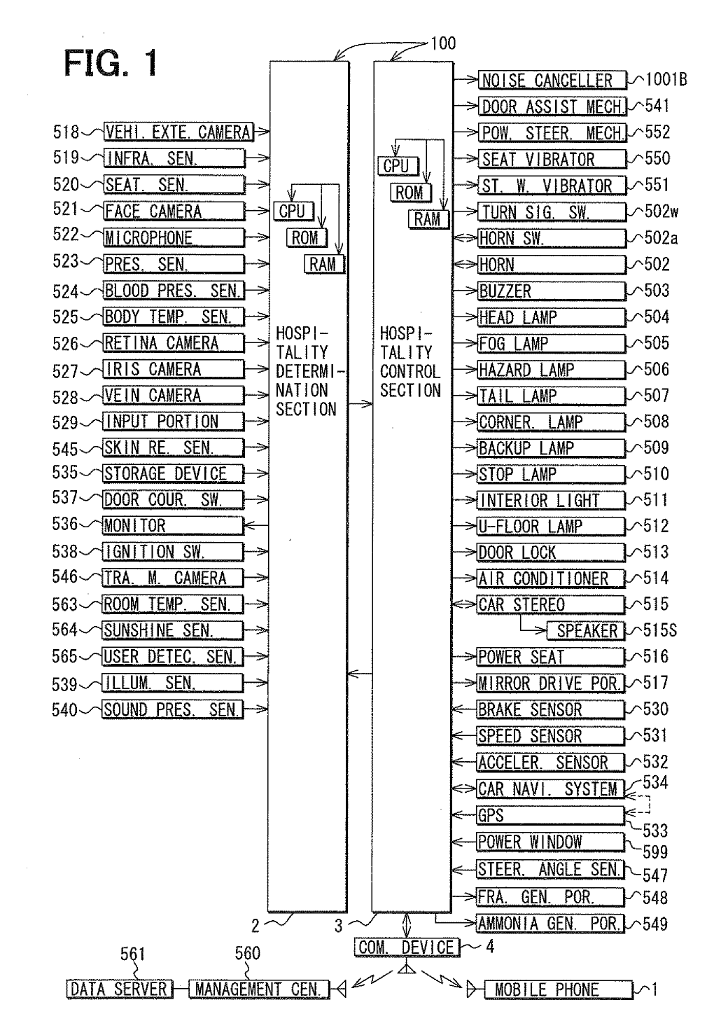

Embodiments of the present invention is explained in detail below in reference to the appended drawings. FIG. 1 is a conceptual block diagram of a vehicular user hospitality system (hereinafter also called just a “system”) 100, showing one embodiment of the present invention. The system 100 comprises a vehicle-mounted portion 100 as its main portion. The vehicle-mounted portion 100 comprises a hospitality control section 3 including a first computer connected to various hospitality operation portions 502 to 517, 534, 541, 548, 549, 550, 551, 552, and 1001B, and a hospitality determination section 2 including a second computer connected to various sensors and cameras 518 to 528. The first and second computers have CPUs, ROMs, and RAMs, and execute control software stored in the ROMs by use of the RAMs as working memory to achieve after-mentioned various functions.

In the system 100, motions of a user using a vehicle when the user approaches the vehicle, gets in the vehicle, drives the vehicle or stays in the vehicle, and gets out the vehicle, are divided into multiple predetermined scenes. In the respective divided scenes, the hospitality operating portions 502 to 517, 534, 541, 548, 549, 550, 551, 552, and 1001B execute hospitality operations for assisting the use of the vehicle by the users or for entertaining the user. In this embodiment, a horn 502 and a buzzer 503 are connected as devices for generating sound wave out of the vehicle. As lighting devices (lamps), a headlamp 504 (its beam can be switched between high and low), a fog lamp 505, a hazard lamp 506, a tale lamp 507, a cornering lamp 508, a backup lamp 509, a stop lamp 510, an interior light 511, and an under-floor lamp 512 are connected. As the other hospitality operation portions, an air conditioner 514, a car audio system (car stereo) 515, a driving portion 517 for adjusting angles of, e.g., power seat-steering 516 and side and rearview mirrors, a car navigation system 534, an electric door mechanism (hereinafter called a door assist mechanism) 541 for opening and closing doors, an fragrance generation portion 548 for outputting fragrance, an ammonia generation portion 549 (for example, mounted to the center of a steering wheel to output ammonia toward the face of the driver) for awaking the driver in serious physical condition (including strong sleepiness), a seat vibrator 550 (embedded in a bottom portion or backrest of the seat) for warning the driver or awaking the driver from sleepiness, a steering wheel vibrator 551 (mounted to a shaft of the steering wheel), and a noise canceller 1001B for decreasing noise in the vehicle, are connected.

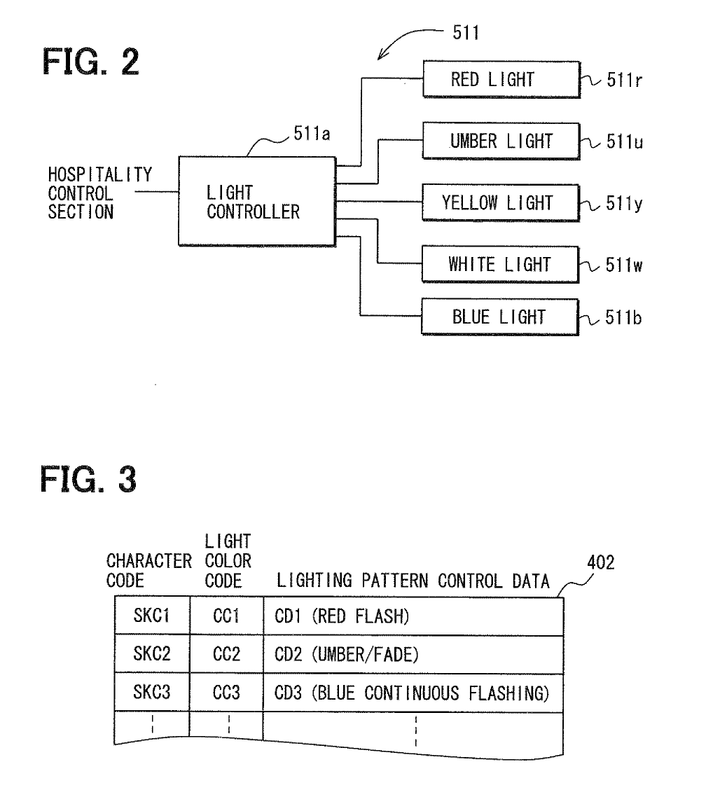

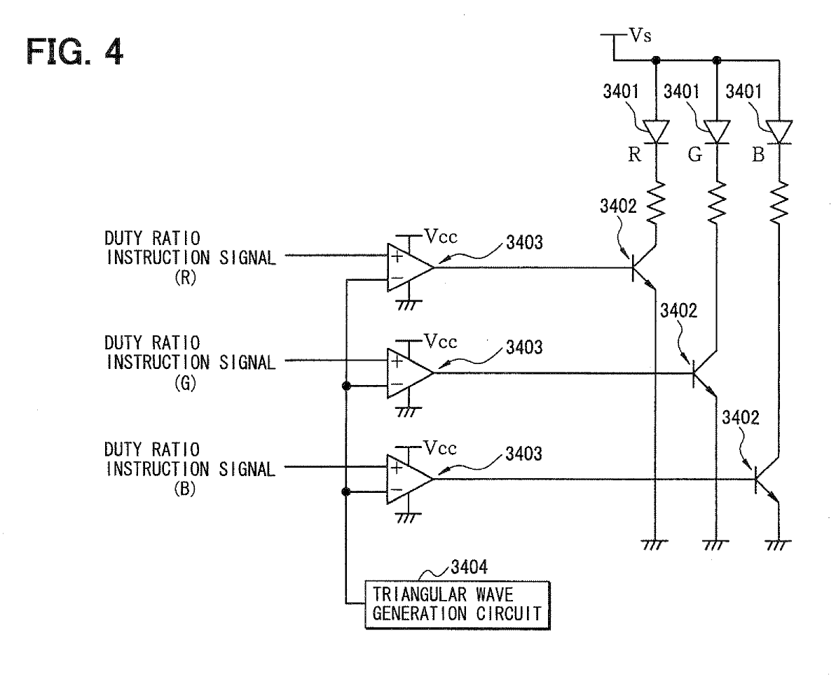

FIG. 2 shows an example of a structure of the interior light 511. The interior light 511 includes multiple light portions (in this embodiment, including a red light 511r, an umber light 511u, a yellow light 511y, a white light 511w, and a blue light 511b). In response to a control instruction signal inputted from the hospitality determination section 2 via the hospitality control section 3, a specified light is selected, and the lighting of the selected light arise controlled in various lighting patterns in accordance with the control instruction signal. FIG. 4 shows an example of a structure of light control data determined in accordance with a character type of the user. The light control data is stored in the ROM of the hospitality determination section 2, and read by the control software as needed. For example, with respect to an active character (SKC1, see FIG. 11), the red light 511r is selected, and flashes (only at first, then continuously lights). Additionally, with respect to a gentle character (SKC2), the umber light 511u is selected, and fades in. These are only part of the examples. Lighting intensity and colors of the lights are adjusted in accordance with a calculation value of the after-mentioned user condition index G.

The lighting device can use an incandescent lamp, a fluorescent lamp, and a lighting device using a light emitting diode. Especially, light emitting diodes of the three primary colors, red (R), green (G), and blue (B) can be combined to obtain various lights easily. FIG. 4 shows one example of a structure of the circuit for emitting various lights. A red light emitting diode 3401 (R), a green light emitting diode 3401 (G), and a blue light emitting diode 3401 (B) are connected to a power supply (Vs), and switched and driven by transistors 3402. This switching is controlled by PWM in accordance with a duty ratio determined by a cycle of a triangular wave (a saw tooth wave may be used) inputted to a comparator 3403 and by a voltage level of an instruction signal. Each input waveform of an instruction signal into each light emitting diode 3401 can be changed separately. Light of any color can be obtained in accordance with a mixed ratio of the three emitted lights. The colors and light intensity patterns can be changed over time in accordance with the input waveform of the instruction signal. In addition to the above the PWM control, a light emitting intensity of each light emitting diode 3401 can be adjusted by a level of a driving current on the premise of continuous lighting. The combination of this adjustment and the PWM control is possible.

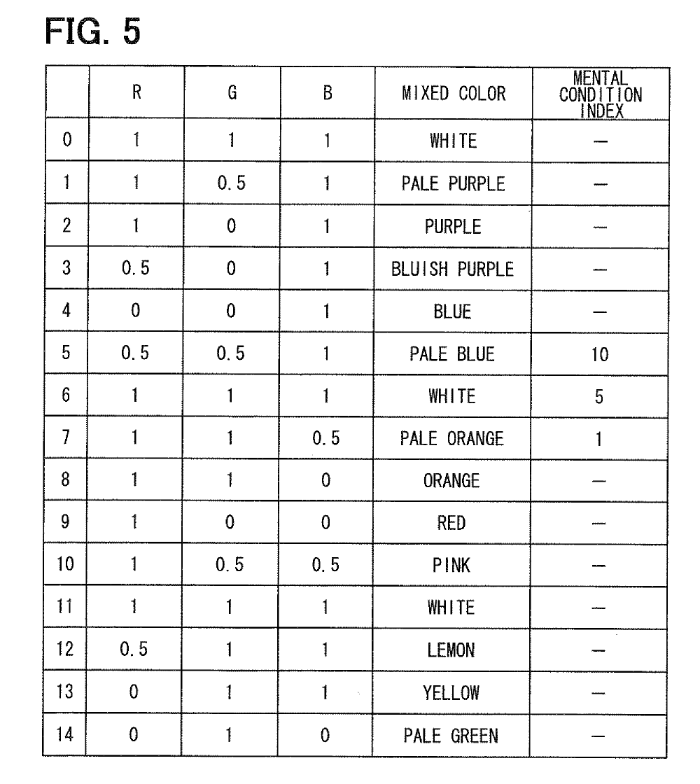

FIG. 5 shows relationship between mixed ratios (in accordance with duty ratios) of red light (R), green light (G), and blue light (B) and colors of viewed mixed lights (the mixture ratios are shown by relative mixture ratios of a color having “1” and of the other colors relative to the color having “1,” and absolute brightness is set separately in reference to the mixture ratios). The mixture ratios and mixed colors are provided with indexes (0 to 14), which are stored in the ROM of the hospitality control section 3 (or in a storage device 535 of the hospitality determination section 2: information required for the control may be sent to the hospitality control section 3 by communications) as control reference information. White light is frequently used. To achieve smooth switches between the white light and colored light, the indexes of white light appear periodically multiple times in the arrangement of the indexes. Especially, warm colors (pale orange, orange, red) are arranged after the white color (index 6) in the middle, and cold colors (light blue, blue, blue-purple) before the white color (index 6). In accordance with physical condition and mental condition of the user, white light can be switched to warm color light or cold color light smoothly.

The white light colors are mainly set in the normal light setting in which effect is unnecessary. Mental condition indexes (the larger index shows a more uplifted mental condition) correspond to the colors in the normal light setting. The white light is selected in a neutral mental condition (mental condition index: 5). The larger mental condition index (more uplifted mental condition) corresponds to the blue lights, namely the shorter wavelength color lights. The smaller mental condition index (more depressed mental condition) corresponds to the red lights, namely the longer wavelength color lights. In this embodiment, the RGB relative set values are set to obtain “light blue” when the mental condition index is 10, the RGB relative set values are set to obtain “pale orange” when the mental condition index is 1, and the RGB relative set values are set by interpolation when the mental condition index is in the middle of 1 and 10.

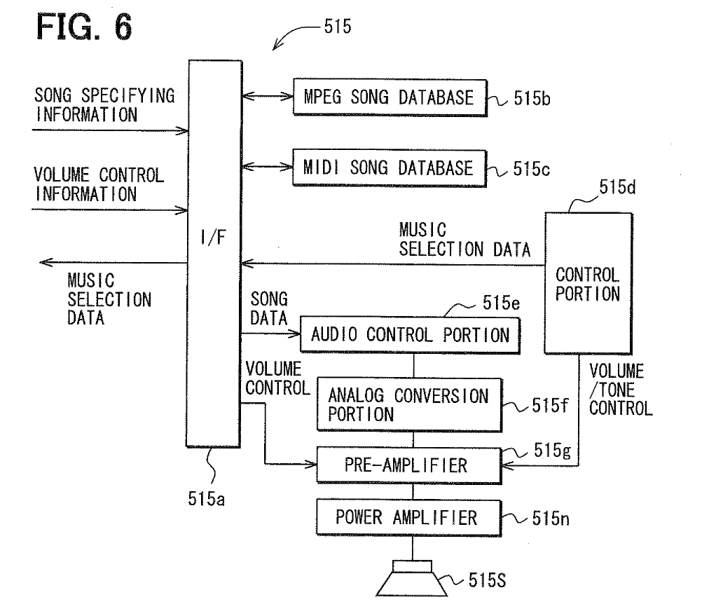

FIG. 6 shows an example of a structure of the car audio system 515. The car audio system 515 has an interface portion 515a to which hospitality song play control information such as song specifying information and volume controlling information is inputted from the hospitality determination section 2 via the hospitality control section 3. A digital audio control portion 515e, music source databases 515b, 515c containing many music source data (the former is an MPEG3 database, and the latter is an MIDI database) are connected to the interface portion 515a. The music source data selected in accordance with the song specifying information is sent to the audio control portion via the interface portion 515a. Then, the music source data is decoded to digital music waveform data, and converted into analog in an analog conversion portion 515f. After that, the source data is outputted from a speaker 515j at a volume specified by the hospitality song play control information, via a preamplifier 515g and a power amplifier 515h.

In FIG. 1, the door assist mechanism 541 assists automatic opening and closing and power opening and closing of a sliding door or swing door for passengers by use of a motor (actuator) (not shown).

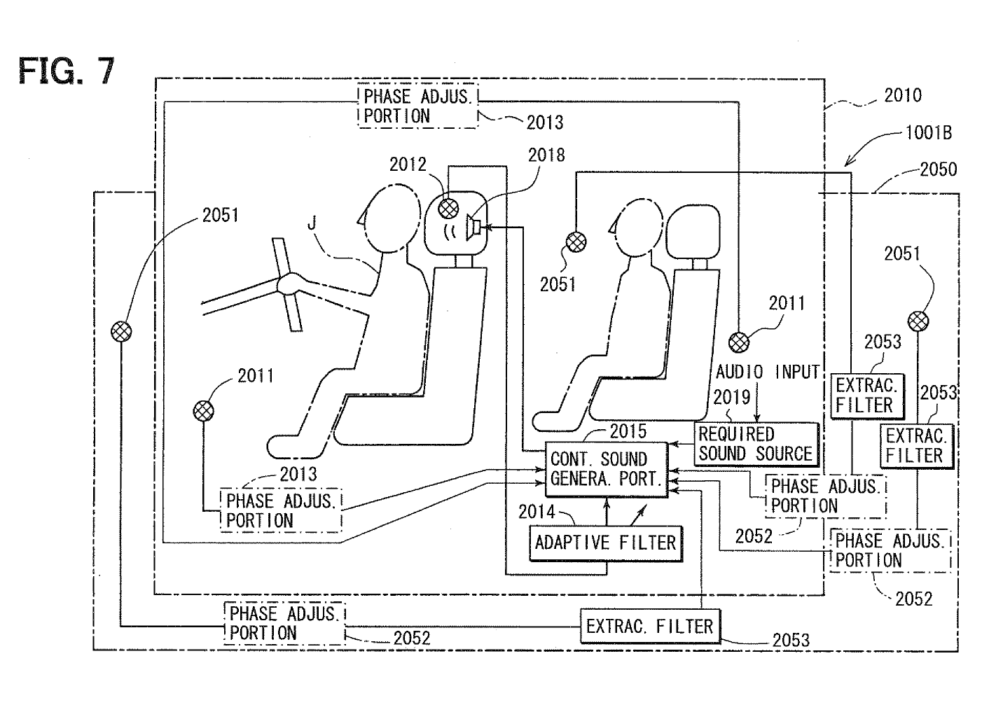

FIG. 7 is a functional block diagram showing an example of a structure of a noise canceller 1001B A main portion of the noise canceller 1001B includes an active noise control mechanism body 2010 forming a noise restriction means and a required sound emphasis portion (means) 2050. The active noise control mechanism body 2010 has vehicle interior noise detection microphones (noise detection microphones) 2011 for detecting a noise intruding into the vehicle and a noise control waveform synthesis portion (control sound generation portion) 2015 for synthesizing a noise control waveform having a reverse phase to a noise waveform detected by the vehicle interior noise detection microphone 2011. The noise control waveform is outputted from a noise control speaker 2018. An error detection microphone 2012 for detecting a remaining noise element contained in the vehicle interior sound on which a noise control sound wave has been superimposed, and an adaptive filter 2014 for adjusting a filter factor to decrease a level of the remaining noise, are also provided.

The vehicle interior noise generated from the vehicle itself includes, e.g., an engine noise, a road noise, and a wind noise. The multiple vehicle interior noise detection microphones 2011 are distributed to positions for detecting the respective vehicle interior noises. The vehicle interior noise detection microphones 2011 are positioned differently when viewed from a passenger J. Noise waveforms picked up by the microphones 2011 are quite different in phase from noise waveforms the passenger J actually hears. To adjust the phase difference, detection waveforms of the vehicle interior noise detection microphones 2011 are sent to the control sound generation portion 2015 properly via a phase adjustment portion 2013.

Next, the required sound emphasis portion 2050 includes emphasized sound detection microphones 2051 and a required sound extraction filter 2053. An extracted waveform of the required sound is sent to the control sound generation portion 2015. In accordance with the same situation as the vehicle interior noise detection microphones 2011, a phase adjustment portion 2052 is provided properly. The emphasized sound detection microphones 2051 include a vehicle exterior microphone 2051 for collecting required sounds outside the vehicle and a vehicle interior microphone 2051 for collecting vehicle interior required sounds inside the vehicle. Both microphones can be formed of known directional microphones. The vehicle exterior microphone is such that a strong directional angular area for sound detection is directed outside the vehicle, and a weak directional angular area is directed inside the vehicle. In this embodiment, the whole of the vehicle exterior microphone 2051 is mounted outside the vehicle. The vehicle exterior microphone 2051 can be mounted across inside and outside the vehicle such that the weak directional angular area is mounted inside the vehicle and only the strong directional angular area is outside the vehicle. On the other hand, the vehicle interior microphone 2051 is mounted corresponding to each seat to detect a conversation sound of the passenger selectively such that the strong directional angular area for sound detection is directed to a front of the passenger, and the weak directional angular area is directed opposite the passenger. These emphasized sound detection microphones 2051 are connected to the required sound extraction filter 2053 for sending required sound elements of the inputted waveforms (detected waveforms) preferentially. An audio input of the car audio system 515 of FIG. 6 is used as a vehicle interior required sound source 2019. An output sound from a speaker of this audio device (the speaker may be also used as the noise control speaker 2018, or may be provided separately) is controlled not to be offset even when superimposed with the noise control waveforms.

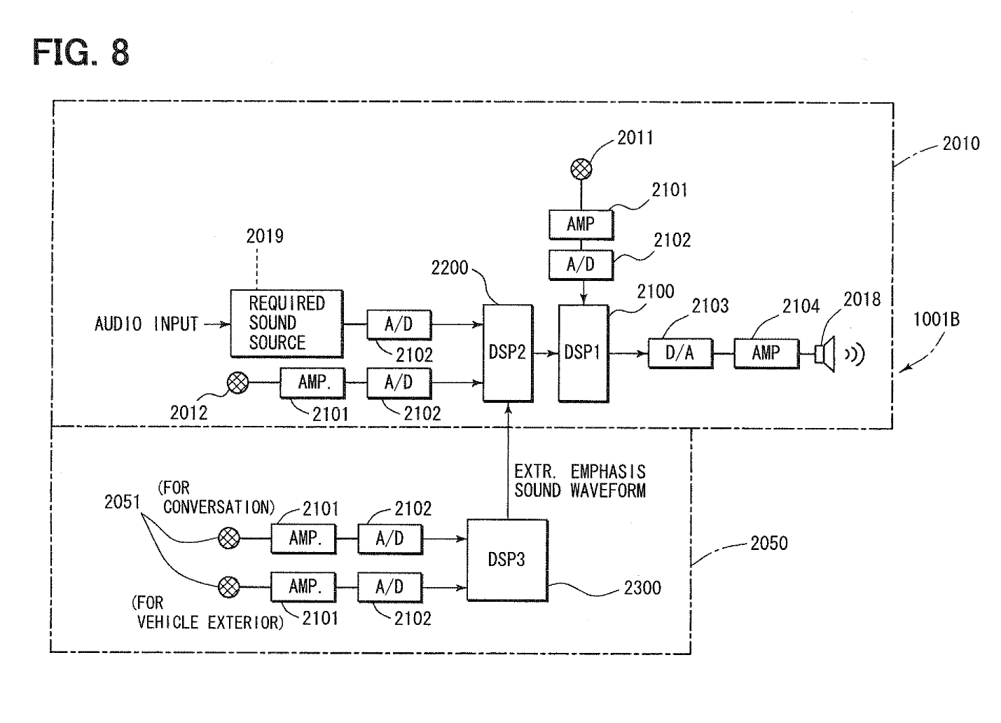

FIG. 8 is one example of a hardware block diagram corresponding to the functional block diagram of FIG. 7. A first DSP (Digital Signal Processor) 2100 forms a noise control waveform synthesis portion (control sound generation portion) 2015 and an adaptive filter 2014 (and a phase adjustment portion 2013). The vehicle interior noise detection microphones 2011 are connected to the first DSP 2100 via a microphone amplifier 2101 and an AD converter 2102. The noise control speaker 2018 is connected to the first DSP 2100 via a DA converter 2103 and an amplifier 2104. On the other hand, a second DSP 2200 forms an extraction portion for noise elements to be restricted. The error detection microphone 2012 is connected to the second DSP 2200 via the microphone amplifier 2101 and the AD converter 2102. The sound signal source not to be restricted, such as audio inputs, namely, the required sound source 2019 is connected to the second DSP 2200 via the AD converter 2102.

The required sound emphasis portion 2050 has a third DSP 2300 functioning as the required sound extraction filter 2053. The required sound detection microphones (emphasized sound detection microphones) 2051 are connected to the third DSP 2300 via the microphone amplifier 2101 and AD converter 2102. The third DSP 2300 functions as a digital adaptive filter. A process for setting a filter factor is explained below.

Sirens of emergency vehicles (such as an ambulance, a fire engine, and a patrol car), railroad crossing warning sounds horns of following vehicles, whistles, cries of persons (children and women) are defined as vehicle exterior required sounds (emphasized sounds) to be noted or recognized as danger. Their sample sounds are recorded in, e.g., a disk as a library of readable and reproducible reference emphasized sound data. As conversation sounds, model sounds of multiple persons are recorded as a library of the reference emphasized sound data. When passenger candidates of a vehicle are determined, the model sounds can be prepared as the reference emphasized sound data obtained from the phonation of the candidates. Accordingly, the emphasis accuracy of the conversation sounds can be increased when the candidates get in the vehicle.

An initial value is provided to the filter factor. An emphasized sound detection level by the emphasis sound detection microphone 2051 is set to the initial value. Next, each reference emphasized sound is read and outputted, and detected by the emphasized sound detection microphones 2051. Waveforms passing through the adaptive filter are read. Levels of the waveforms which can pass through the filter as the reference emphasized sound are measured. The above process is repeated until the detection level reaches a target value. The reference emphasized sounds of the vehicle exterior sounds and vehicle interior sounds (conversation) are switched one after another. Then, a training process for the filter factor is executed to optimize the detection level of the passing waveform. The required sound extraction filter 2053 having the filter factor adjusted as described above extracts a required sound from the waveforms from the emphasized sound detection microphones 2051. The extracted emphasized sound waveform is sent to the second DSP 2200. The second DSP 2200 calculates a difference between an input waveform from the required sound source (audio output) 2019 and an extracted emphasized sound waveform from the third DSP 2300, from a detection waveform of the vehicle interior noise detection microphone 2011.

A filter factor of the digital adaptive filter embedded in the first DSP 2100 is initialized before use of the system. First, various noises to be restricted are determined. Sample sounds of the noises are recorded in, e.g., a disk as a library of reproducible reference noises. An initial value is provided to the filter factor. A level of a remaining noise from the error detection microphone 2012 is set to the initial value. The reference noises are read and outputted sequentially, and detected by the vehicle interior noise detection microphone 2011. A detection waveform of the vehicle interior noise detection microphone 2011, the waveform passing through the adaptive filter, is read, and applied the fast Fourier transformation. Accordingly, the noise detection waveform is decomposed to fundamental sine waves each having a different wavelength. Reversed elementary waves are generated by reversing phases of respective fundamental sine waves, and synthesized again, so that a noise control waveform in anti-phase to the noise detection waveform is obtained. This noise control waveform is outputted from the noise control speaker 2018.

When a factor of the adaptive filter is determined properly, only noise elements can be extracted from the waveforms of the vehicle interior noise detection microphones 2011 efficiently. The noise control waveform negative-phase-synthesized in accordance with the factor can offset the noise in the vehicle exactly. However, when the filter factor is not set properly, the waveform elements which are not offset is generated as remaining noise elements. These elements are detected by the error detection microphone 2012. A level of the remaining noise elements is compared to a target value. When the level is over the target value, the filter factor is updated. This process is repeated until the level is the target value or under. Accordingly, the reference noises are switched one after another to execute the training process of the filter factor so that the remaining noise elements are minimized. Actually, the remaining noise elements are regularly monitored. The filter actor is updated in real time to always minimize the remaining noise elements, and the same process as above is executed. As a result, while required sound wave elements remain, a noise level inside the vehicle can be decreased efficiently.

In FIG. 1, the user terminal device 1 is structured as a known mobile phone in this embodiment (hereinafter also called “mobile phone 1”). The mobile phone 1 can download ring alert data and music data (MPEG3 data or MIDI data: also used as a ring alert) for outputting a ring alert and playing music, and output the music playing through a music synthesis circuit (not shown) in accordance with the data.

The following sensors and cameras are connected to the hospitality determination section 2. Part of these sensors and cameras function as a scene estimation information obtaining means, and as a user biological characteristic information obtaining means.

An vehicle exterior camera 518 takes a user approaching a vehicle, and obtains a gesture and facial expression of the user as static images and moving images. To magnify and take the user, an optical zoom method using a zoom lens and a digital zoom method for digitally magnifying a taken image can be used together.

An infrared sensor 519 takes a thermography in accordance with radiant infrared rays from the user approaching the vehicle or from a face of the user in the vehicle. The infrared sensor 519 functions as a body temperature measurement portion, which is the user biological characteristic information obtaining means, and can estimate a physical or mental condition of the user by measuring a time changing waveform of the body temperature (i.e., the user biological characteristic information obtaining means includes a user biological condition change detection portion).

A seating sensor 520 detects whether the user is seated on a seat. The seating sensor 520 can include, e.g., a contact switch embedded in the seat of the vehicle. The seating sensor can include a camera taking the user who has been seated on the seat. In this method, the case where a load other than a person, such as baggage, is placed on the seat, and the case where a person is seated on the seat, can be distinguished from each other. A selectable control is possible, in which, for example, only when a person is seated on the seat, the hospitality operation is executed. By use of the camera, a motion of the user seated on the seat can be detected, so that the detection information can be varied. To detect a motion of the user on the seat, a method using a pressure sensor mounted to the seat is also used.

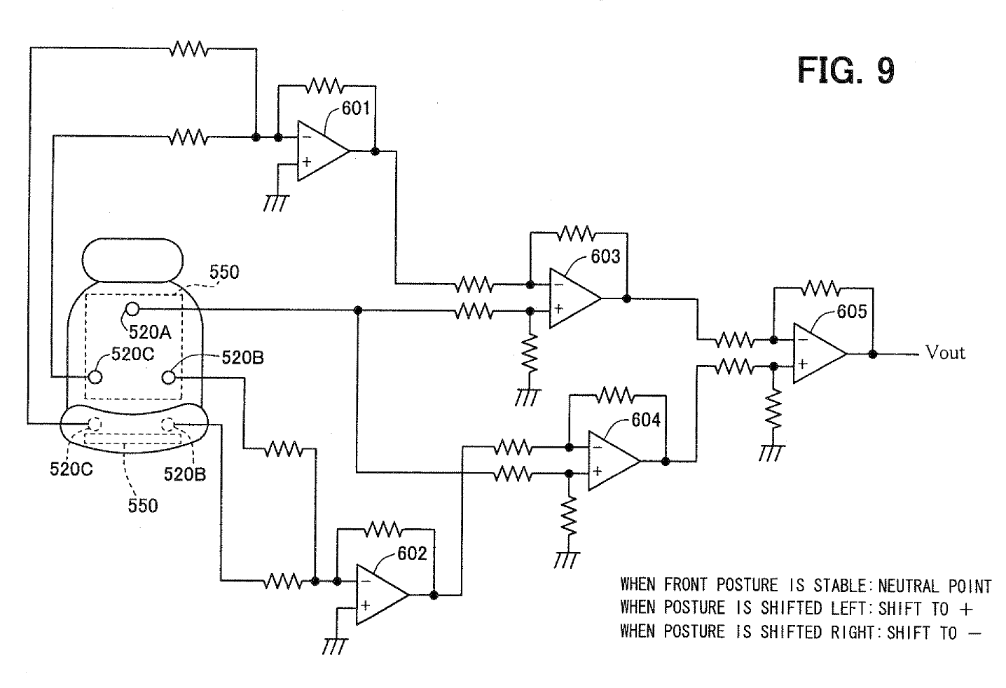

In this embodiment, as shown in FIG. 9, in accordance with the detection outputs of seating sensors 520A, 520B, 520C distributed and embedded in a seating portion and backrest portion of the seat, a change of an attitude of the user (driver) on the seat is detected as a waveform. The seating sensors are pressure sensors for detecting seating pressures. Especially, the standard sensor 520A is placed to the center of a back of the user who has seated facing the front. The sensors for the seating portion are a left sensor 520B placed on the left of the standard sensor 520A, and a right sensor 520C placed on the right of the standard sensor 520A. A difference between an output of the standard sensor 520A and an output of the right sensor 520C and a difference between an output of the standard sensor 520A and an output of the left sensor 520B are calculated in a differential amplifiers 603, 604. The differential outputs are inputted to a differential amplifier 605 for outputting an attitude signal. The attitude signal output Vout (second type biological condition parameter) is almost a standard value (here, zero V) when the user is seated facing the front. When the attitude inclines right, an output of the right sensor 520C increases, and an output of the left sensor 520B decreases, so that the attitude signal output Vout shifts to a negative. When the attitude inclines left, the attitude signal output Vout shifts to a positive. Outputs of the right sensor 520C and left sensor 520B are outputted as additional values of an output of the seat sensor and an output of the back-rest sensor by adders 601, 602. Difference values between the seating portion sensor and the back-rest sensor may be outputted (in this case, when the driver is plunged forward, an output of the back-rest sensor decreases, and the difference value increases, so that the plunge can be detected as a larger change of the attitude).

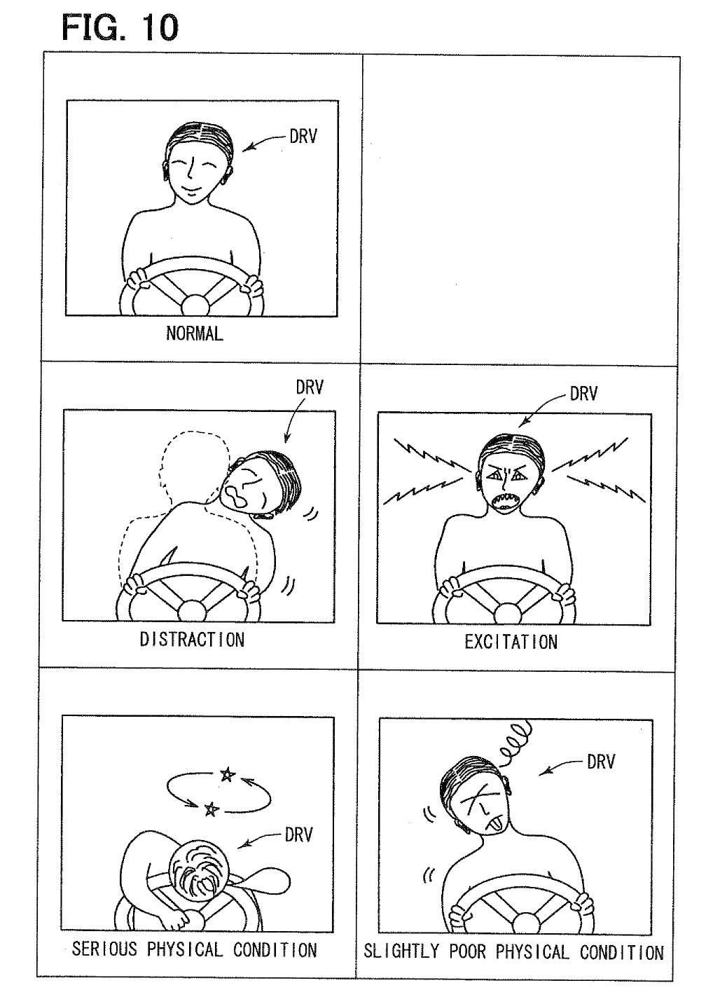

A face camera 521 takes a facial expression of the user who has been seated. The face camera 521 is mounted to, e.g., a rearview mirror, and takes a bust of the user (driver) who has been seated on the seat, including the face, from diagonally above through a windshield. An image of the face portion is extracted from the taken image. By comparing the extracted image to master images of previously taken various facial expressions of the user, as shown in FIG. 10, the facial expression of the user in the extracted image can be specified. The order of the facial expressions is determined in accordance with goodness of the physical condition and mental condition. The facial expressions are provided with points in this order (for example, in case of the mental condition, stability is “1,” distraction and anxiety are “2,” excitation and anger are “3”). The facial expressions can be used as discrete numeral parameters (second biological parameter). The time change of the facial expressions can be measured as discrete waveforms. As a result, in accordance with the waveforms, the mental or physical condition can be estimated. From a shape of the image of the bust including the face and a position of the center of gravity on the image, a change of the attitude of the driver can be detected. Namely, a waveform of the change of the position of the center of the gravity can be used as a change waveform of the attitude (second type biological condition parameter). In accordance with the waveform, the mental or physical condition can be estimated. The face camera 521 has a function for user authentication using biometrics, as well as the function for obtaining the user biological condition information used for the hospitality control (user biological characteristic information obtaining means). The face camera 521 can magnify and detect a direction of an iris of an eye to specify a direction of the face or eye (for example, when the user sees a watch frequently, the user is estimated to be “upset about time”). In accordance with a time change waveform of an angle of the eye direction (a direction when the user faces a just front is defined as a standard direction, and an angle of the shift to right and left relative to the standard direction is detected as a change of the waveform) (second type biological condition parameter), the face camera 521 is used for estimating the physical or mental condition of the driver.

A microphone 522 detects a voice of the user. The microphone 522 can function as the user biological characteristic information obtaining means.

A pressure sensor 523 is mounted to a position grasped by the user, such as a steering wheel or shift lever, and detects a grip of the user and a repeating frequency of the gripping and releasing (user biological characteristic information obtaining means).

A blood pressure sensor 524 is mounted to a user-grasped position of the steering wheel of the vehicle (user biological characteristic information obtaining means). A time change of a value of a blood pressure detected by the blood pressure sensor 524 is recorded as a waveform (first type biological condition parameter). In accordance with the waveform, the blood pressure sensor 524 is used for estimating the physical and mental condition of the driver.

A body temperature sensor 525 includes a temperature sensor mounted to a user-grasped position of the steering wheel of the vehicle (user biological characteristic information obtaining means). A time change of a value of a body temperature detected by the body temperature sensor 525 is recorded as a waveform (first type biological condition parameter). In accordance with the waveform, the body temperature sensor 525 is used to estimate physical or mental condition of the driver.

A skin resistance sensor 545 is a known sensor for measuring a resistance value of the surface of a body due to sweat, and is mounted to a user-grasped position of the steering wheel of the vehicle. A time change of a skin resistance value detected by the skin resistance sensor 545 is recorded as a waveform (first type biological condition parameter). The skin resistance sensor 545 is used for estimating the physical or mental condition of the driver in accordance with the waveform.

A retina camera 526 takes a retina pattern of the user. The retina pattern is used for a user authentication by use of biometrics.

An iris camera 527 is mounted to, e.g., a rearview mirror, and takes an image of an iris of the user. The iris is used for a user authentication by use of biometrics. When an image of an iris is used, characteristics of a pattern and color of the iris is used for the verification and authentication. Especially, a pattern of an iris is an acquired element, and has less genetic influence. Even identical twins have significantly different irises. Accordingly, by use of irises, reliable identifications can be achieved. By use of the identification using iris patterns, recognition and verification are executed rapidly, in which a ratio that a wrong person is recognized is low. In accordance with a time change of a size of a pupil of the driver taken by the iris camera (second type biological condition parameter), the physical or mental condition can be estimated.

A vein camera 528 takes a vein pattern of the user, which is used for the user identification by use of biometrics.

A door courtesy switch 537 detects the opening and closing of the door, and is used as a scene estimation information obtaining means for detecting a shift to the scene of getting in the vehicle and to the scene of getting off the vehicle.

An output of an ignition switch 538 for detecting an engine start is branched and inputted to the hospitality determination section 2. An illumination sensor 539 for detecting a level of an illumination inside the vehicle and a sound pressure sensor 540 for measuring a sound level inside the vehicle are connected to the hospitality determination section 2.

An input portion 529 including, e.g., a touch panel (which may use a touch panel superimposed on the monitor of the car navigation system 534: in this case, input information is transmitted from the hospitality control section 3 to the hospitality determination section 2) and a storage device 535 including, e.g., a hard disk drive functioning as a hospitality operation information storage portion are connected to the hospitality determination section 2.

A GPS 533 for obtaining vehicular position information (used also in the car navigation system 534), a brake sensor 530, a speed sensor 531, and an acceleration sensor 532 are connected to the hospitality control section 3.

The hospitality determination section 2 obtains user biological condition information including at least one of a character, mental condition, and physical condition of the user from detection information from one or two of the sensors and cameras 518 to 528. The hospitality determination section 2 determines what hospitality operation is executed in which hospitality operation portion in accordance with contents of the information, and instructs the hospitality control section 3 to execute the determined hospitality operation. In response to the instruction, the hospitality control section 3 makes the corresponding hospitality operation portions 502 to 517, 534, 541, 548, 549, 550, 551, 552, and 1001B execute the hospitality operation. Namely, the hospitality determination section 2 and hospitality control section 3 operate together to change an operation content of the hospitality operation portions 502 to 517, 534, 541, 548, 549, 550, 551, 552, and 1001B in accordance with the contents of the obtained user biological condition information. A radio communications device 4 forming a vehicular communications means (host communications means) is connected to the hospitality control section 3. The radio communications device 4 communicates via the user terminal device (mobile phone) 1 and the radio communications network.

An operation portion 515d (FIG. 6) operated by the user manually is provided to the car audio system 515. Selected music data is inputted from the operation portion 515d to read desired music source data and play the music. A volume/tone control signal from the operation portion 515d is inputted to the preamplifier 515g. This selected music data is sent from the interface portion 515a to the hospitality determination section 2 via the hospitality control section 3 of FIG. 1, and accumulated as selected music history data in the music selection history portion 403 of the storage device 535 connected to the hospitality determination section 2. In accordance with the accumulated contents, the after-mentioned user character detection process is executed (namely, the operation portion 515d of the car audio system 515 forms a function of the user biological characteristic information obtaining means).

FIG. 11 shows one example of a database structure of the music source data. Music source data (MPEG3 or MIDI) is stored corresponding to song Ids, song names, and genre codes. In each music source data, character type codes showing character types (e.g., “active,” “gentle,” “decadent,” “physical,” “intelligent,” or “romanticist”), and age codes (e.g., “infant,” “child,” “junior,” “youth,” “middle age,” “senior,” “mature age,” “old,” or “regardless of age”) estimated from a user who has selected the song of the music source data are respectively stored corresponding to sex codes (“male,” “female,” and “regardless of sex”). The character type code is one of pieces of the user character specifying information. The age code and sex code are sub classifications unrelated to the characters. Even when a character of the user can be specified, a music source unsuitable for an age and sex of the user is ineffective for offering hospitality to the user. To specify suitability of the music source provided to the user, the above sub classification is effective.

Song mode codes are stored in each music source data correspondingly. The song mode code shows relationship between mental and physical conditions of the user who has selected a song, and the song. In this embodiment, the song codes are classified into “uplifting” “refreshing,” “mild and soothing,” “healing and a wave,” and so on. Because the character type codes, age codes, sex codes, genre codes, and song mode codes are referenced to select a hospitality content unique to each user, these codes are collectively called hospitality reference data.

After-mentioned physical condition index PL and mental condition index SL are stored in each music source data correspondingly. These indexes are provided in advance to specify the music data source suitable for a physical or mental condition shown by the index. The use of the indexes are explained later.

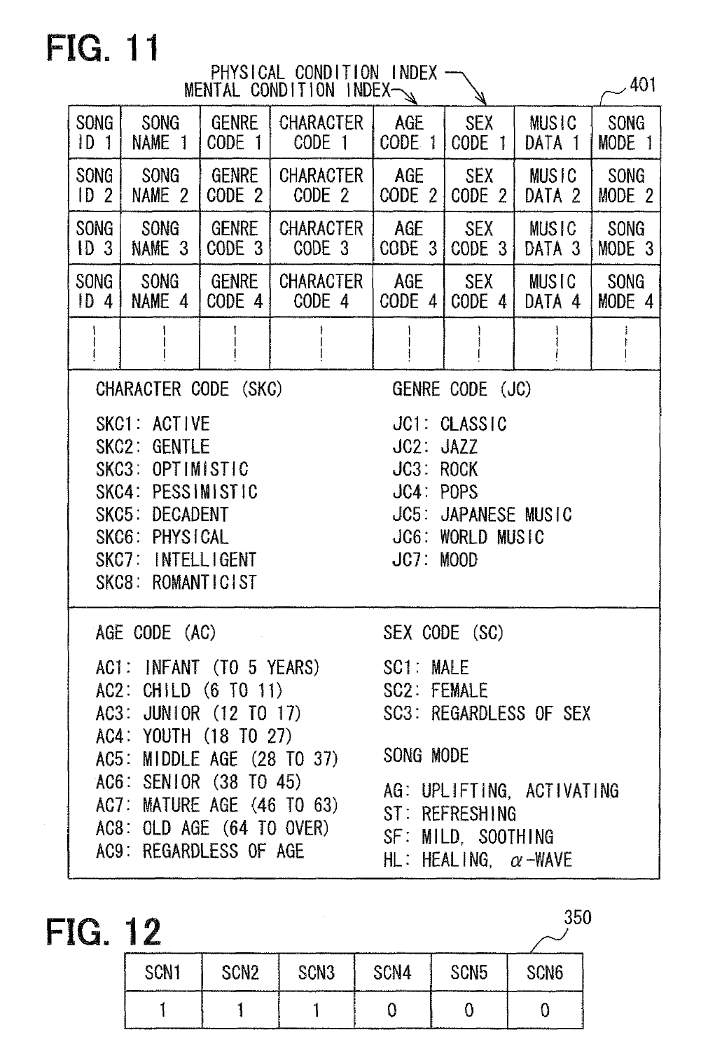

Next, in this embodiment, an approach scene SCN1, a getting-in scene SCN2, a preparation scene SCN3, a drive/stay scene SCN4, a getting-off scene SCN5, and a separation scene SCN6 are set time-sequentially in this order. To specify the approach scene, as described later, the GPS of the user and the GPS 533 of the vehicle specify a relative distance between the vehicle and the user outside the vehicle and a change of the distance to detect that the user has approached to within a predetermined distance to the vehicle. The getting-in scene and getting-off scene are specified in accordance with a door-opening detection output of the door courtesy switch 537. Since the getting-in scene or getting-off scene cannot be specified by use of only the door opening information, a scene flag 350 is provided in the RAM of the hospitality determination section 2 as a current scene specifying information storage means, as shown in FIG. 12. The scene flag 350 has an individual scene flag corresponding to each scene. In each scene whose coming order is determined time-sequentially, the flag corresponding to the scene is set to “coming (flag value 1).” In the scene flag 350, to specify the latest flag having a value of “1” (the last of the flag string), which scene is in progress can be specified.

The preparation scene and drive/stay scene are specified in accordance with whether the seating sensor detects the user. The period from the time that the user gets in the vehicle until the user turns on the ignition switch 538, or the period until the user is seated for over a predetermined time although the ignition switch 538 is not turned on, is recognized as the preparation scene. The shift to the separation scene is recognized when the door courtesy switch 537 detects the door closing after the getting-off scene.

Each hospitality operation is controlled by an operation control application of the corresponding hospitality operation portion. The operation control applications are stored in the ROM (or the storage device 535) of the hospitality control section 3.

In accordance with the operation control applications, it is determined which hospitality operation portion (hospitality function) is selected and in which content the selected hospitality operation portion is operated in each scene in the following procedure. In other words, in the ROM of the hospitality determination section 2 (or in the storage device 535), an object estimation matrix structured as a two dimensional array matrix including classification items of security and convenience for the use of the vehicle by the user and control target environment items of at least tactile sense, visual sense, and hearing sense relating to the environment of the user outside or inside the vehicle is prepared in each scene, and stored.

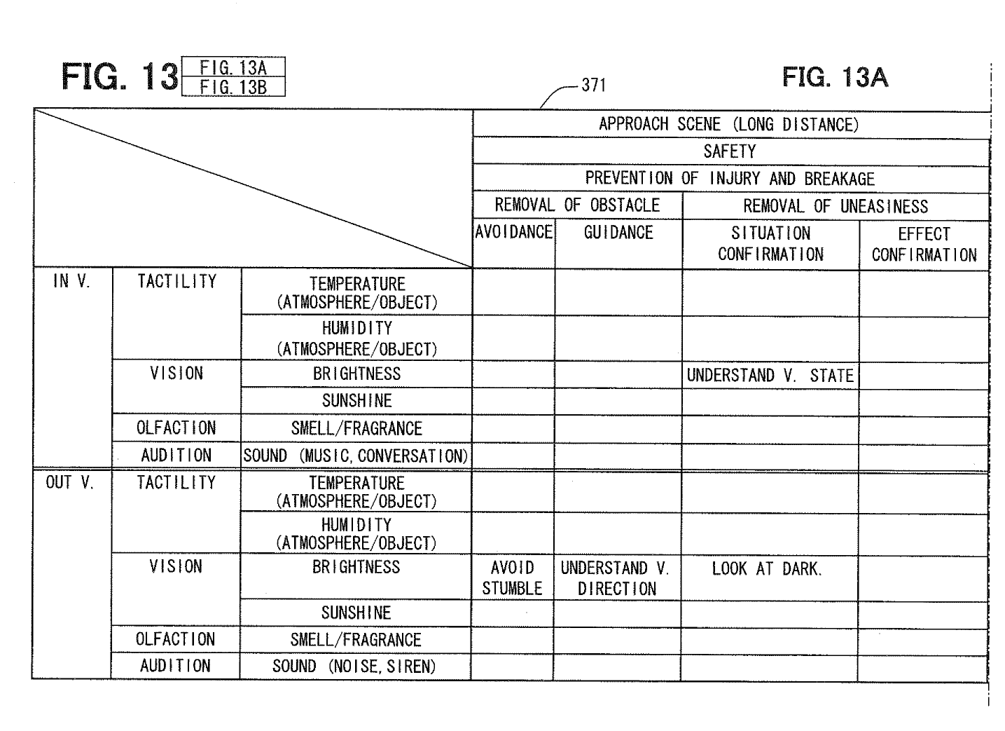

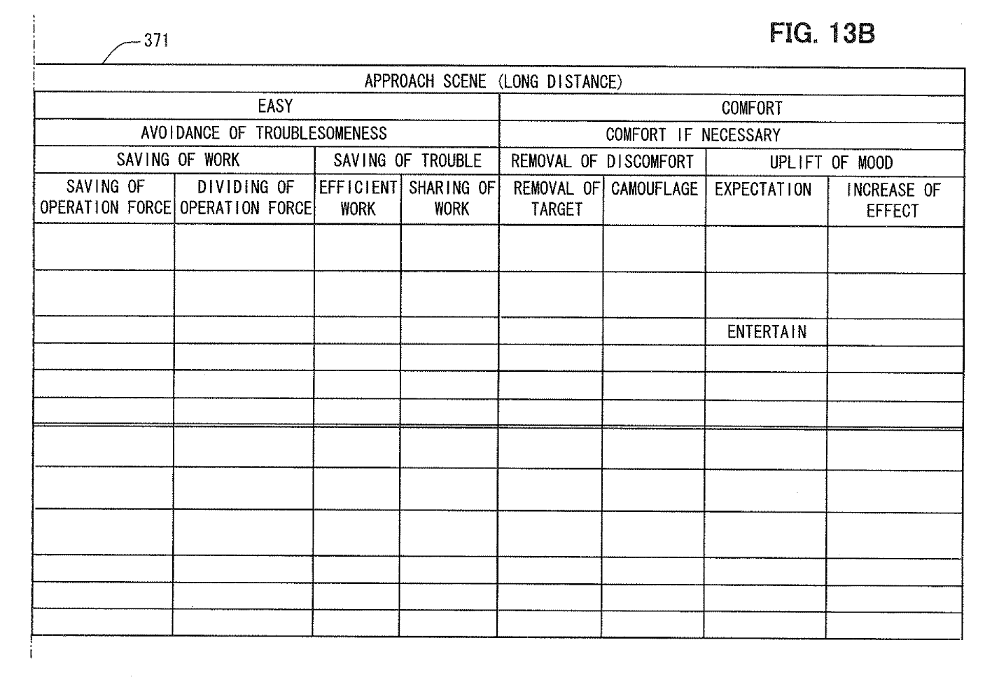

FIG. 13 shows part of an object estimation matrix 371 used in the approach scene (long distance). In each matrix cell of the object estimation matrix 371, a hospitality object corresponding to each classification item and control target environment item estimated to be desired by the user in the scene is stored. In the approach scene, the hospitality objects are roughly separated into vehicle-interior ones and vehicle-exterior ones. The following hospitality objects are specified particularly.

(In Vehicle)

“Understanding of state in vehicle”

Classification item: “safety” (Sub item: “prevention of injury and breakage”→“removal of uneasiness”→“understanding of state in vehicle”)

Control target environment item: “brightness (visual sense type (vision))”

“entertainment”

Classification item: “comfort”

(Sub item: “comfort if necessary”→“uplift of mood”→“expectation”)/

Control target environment item: “brightness (visual sense type)”

(Outside Vehicle)

“Avoidance of stumble”

Classification item: “safety”

(Sub item: “prevention of injury and breakage”→“removal of obstacle”→“avoidance”)/

Control target environment item: “brightness (visual sense type)”

“understanding of direction of vehicle”

Classification item: “safety”

(Sub item: “prevention of injury and breakage”→“removal of uneasiness” “guidance”)/

Control target environment item: “brightness (visual sense type)”

“looking at dark place”

Classification item: “safety”

(Sub item: “prevention of injury and breakage”→“removal of uneasiness”→“confirmation of situation”)/

Control target environment item. “brightness (visual sense type)”

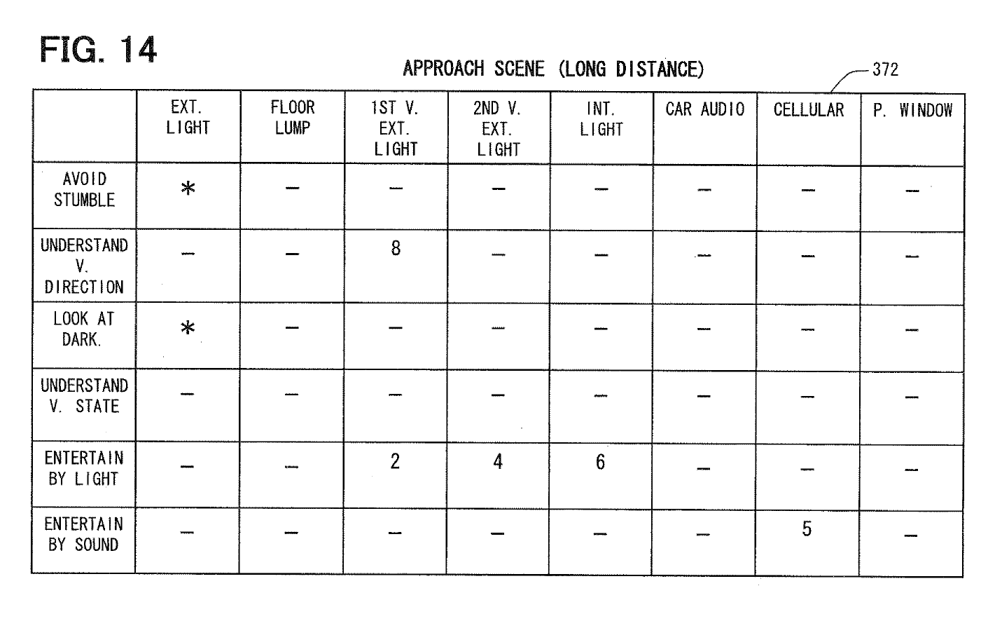

In the above ROM, a function extraction matrix structured as a two-dimensional array matrix including type items of the hospitality objects and function type items of the hospitality operating portions, is stored. FIG. 14 shows part of a function extraction matrix 372 used in the approach scene. Each matrix cell of the function extraction matrix 372 includes standard reference information referenced to identify whether a function corresponding to a hospitality object in the matrix cell matches the hospitality object as a standard for controlling an operation of the function.

In the system of this embodiment, in the hospitality determination section 2, in accordance with the user biological characteristic information obtained from the above sensors or cameras, user condition indexes (physical condition index and mental condition index) reflecting at least physical and mental conditions of the user as values are calculated (user condition index calculating means). The above standard reference information is provided as a standard reference index reflecting a user condition, which is a standard for operating the corresponding function. In the hospitality control section 3, operation instruction information of the hospitality function to be selected is calculated as value instruction information relating to at least a physical condition of the user, the physical condition being shown by the user biological characteristic information, by compensating the above standard reference index by use of the user condition index (value instruction information calculating means).

Specifically, the above value instruction information is calculated as a difference value between the user condition index and standard reference index. The standard reference index is a standard value for providing a branch point to determine whether to actively operate a target function for improving a physical condition. A difference value between the standard reference index and the user condition index reflecting a level of an actual physical condition is a parameter directly showing a gap from a state where a functional effect is the most optimized, namely, from a target state where the user is most satisfied. As the difference value becomes larger, an operation level of the function is set to more largely improve the physical condition reflected by the user condition index or more strongly inhibit the physical condition from deteriorating.

In this embodiment, as the user's physical condition reflected by the obtained user biological characteristic information is more excellent, the user condition index is calculated to change in the predetermined increasing or decreasing direction unilaterally. As a departure (difference value) reflected by the user's physical condition (user condition index) from the appropriate environment becomes larger, an electric output level of the function selected to cancel the departure increases. The user condition index may be equal to the physical condition index directly calculated from the user biological characteristic information, and may be obtained by compensating the physical condition index by a mental condition index calculated from the user biological characteristic information.

The standard reference index defines a standard level of the user condition index in determining whether to operate the corresponding function. In other words, the standard reference index is a parameter for providing relatively branch point showing whether the user is satisfied by using a physical condition of the user as an indicator (independently of an absolute level of a control value). The standard reference index is determined in accordance with relationship between various biological characteristic information relating to the calculation of a statistically and experimentally obtained, after-mentioned physical condition index or mental condition index, and actual physical or mental conditions of the user. When a difference (required to be improved) is generated between the user condition index and standard reference index, operations of the related functions are controlled to reduce the difference.

The explanation is done in reference to FIG. 14. In other words, the hospitality objects specified in the approach scene (long distance) in the object estimation matrix 371 of FIG. 13 are “avoidance of stumble,” “understanding of direction of vehicle,” “looking at dark place,” “understanding of state of vehicle,” and “entertainment” (entertainment by lighting and entertainment by sound), as shown in the function extraction matrix 372 in FIG. 14. In the matrix cell having no standard reference index, no hospitality function corresponds to the corresponding hospitality object. In contrast, in the matrix cell having the standard reference index, a hospitality function corresponds to the corresponding hospitality object. When a difference between a separately calculated physical condition index (user condition index) and this standard reference index is larger than a predetermined standard value (for example, larger than zero), the function corresponding to the standard reference index is selected. The same hospitality object (and its related hospitality function) can be assigned to multiple matrix cells.

As the difference value becomes larger (in other words, dissatisfaction (or requirement) of the user becomes higher), an electric output value of the corresponding function is set higher. Then, the function operation control is done to satisfy the user quickly. For example, a standard reference index for a first vehicle exterior light (headlamp, floor lamp or tale lamp) in “entertainment by lighting” is set relatively small. Even when the user is a little tired (even when the user is a little depressed in the compensation using the mental condition), a difference value from the user condition index (in normal state, “5”; the larger value shows a better user condition) is a positive value. Accordingly, the lighting is done for the entertainment. In this case, when the user condition index is large (in other words, when the user condition is excellent), the luminous intensity for the entertainment becomes high. In contrast, when the user condition index is small (in other words, when the user condition is poor), the luminous intensity for the entertainment becomes low.

A calculation value of the user condition index is always updated in accordance with the latest acquired user biological characteristic information. When the user condition index is improved, the difference value becomes larger. As a result, the luminous intensity is enhanced. In contrast, when the user condition index becomes worse, the difference value becomes smaller. As a result, the luminous intensity is lowered. When the user condition index becomes almost stable, the corresponding luminous intensity is maintained. For example, when the user is in excellent physical condition and uplifted emotionally, strong lighting entertainment is done. When the user thinks that this entertainment is excessive (uncomfortable), the user condition index decreases to soften the light for the entertainment. On the other hand, when the mood of the user who is depressed at first is uplifted by soft lighting entertainment, the user condition index increases to enhance the light for the entertainment. A control value of the luminous intensity is stabilized when the user feels the lighting to be “appropriate.” When the user condition index continues decreasing no matter how the lighting is reduced, the user feels the lighting entertainment to be unpleasant. Therefore, when the difference value becomes zero (or a predetermined value), the lighting entertainment function is removed and stopped.

In addition to the above first vehicle exterior light, a second vehicle exterior light (small lamp, cornering lamp, or hazard flasher) and a vehicle interior light, which correspond to the same hospitality object as the above first vehicle exterior light, and whose functions are different from each other, are assigned to the “entertainment by lighting.” The standard reference indexes of the first vehicle exterior light, second vehicle exterior light, and vehicle interior light become greater in this order. As a result, difference values between the calculated user condition index and the standard reference indexes of the first vehicle exterior light, second vehicle exterior light, and vehicle interior light become smaller in this order. Priorities of the operations of the functions are lowered also in that order. Accordingly, when the user condition index is so excellent as to be about over six, the first vehicle exterior light, second vehicle exterior light, and vehicle interior light are all operated to uplift the entertainment. As the user condition index decreases further, the second vehicle exterior light and vehicle interior light are turned off sequentially, and the entertainment becomes smaller.

The functions for some hospitality objects are selected uniformly and independently of a value of the user condition index, and controlled independently of a value of the user condition index (hereinafter called “uniform control target functions”: on the other hand, the functions controlled to be optimized in accordance with a value of the user condition index (the above difference value) are called “State-dependent functions”). In the function extraction matrix 372, the matrix cells corresponding to the uniform control target functions contains identification information (“*”). The function corresponding to the identification information is determined as the uniform control target function, and a predetermined control of the function is executed.

For example, in FIG. 14, to achieve two hospitality objects “avoidance of stumble” and “looking at dark place” corresponding to the classification item “safety,” an exterior light (after-mentioned) required for securing an approach to the vehicle of the user is specified as the uniform control target function.

A single function is sometimes shared by multiple objects. In this case, an appropriate control content of the function may change in accordance with the hospitality object. In this case, to prevent the control contents for different hospitality objects from interfering with each other, the following countermeasures are done.

(1) When only one of the multiple hospitality objects to which the function is assigned uses the function as the “state-dependent function” (hereinafter called a first hospitality object) and the other hospitality objects use the function as the “uniform control target function” (hereinafter called a second hospitality object), the hospitality object using the function as “state-dependent function” is prioritized to execute the corresponding control. In this case, as shown in FIG. 14, in the function extraction matrix 372, the matrix cells corresponding to the second hospitality objects contain information “8” showing that a control of the first hospitality object is prioritized. When the matrix cell contains this information, the function corresponding to the matrix cell is selected, but the control for the hospitality object corresponding to the matrix cell containing the standard reference index is prioritized. Then, the control based on the above difference value using the standard reference index is executed. In FIG. 14, “entertainment” corresponding to the first vehicle exterior light is defined as the first type hospitality object, and “understanding of direction of vehicle” corresponding to the first vehicle exterior light is defined as the second type hospitality object.

(2) When the “state-dependent function” is assigned to two or more of the multiple hospitality objects to which the function is assigned, it is determined in advance which hospitality object is prioritized in referencing the standard reference index (for example, the hospitality object corresponding to the minimum standard reference index is prioritized).

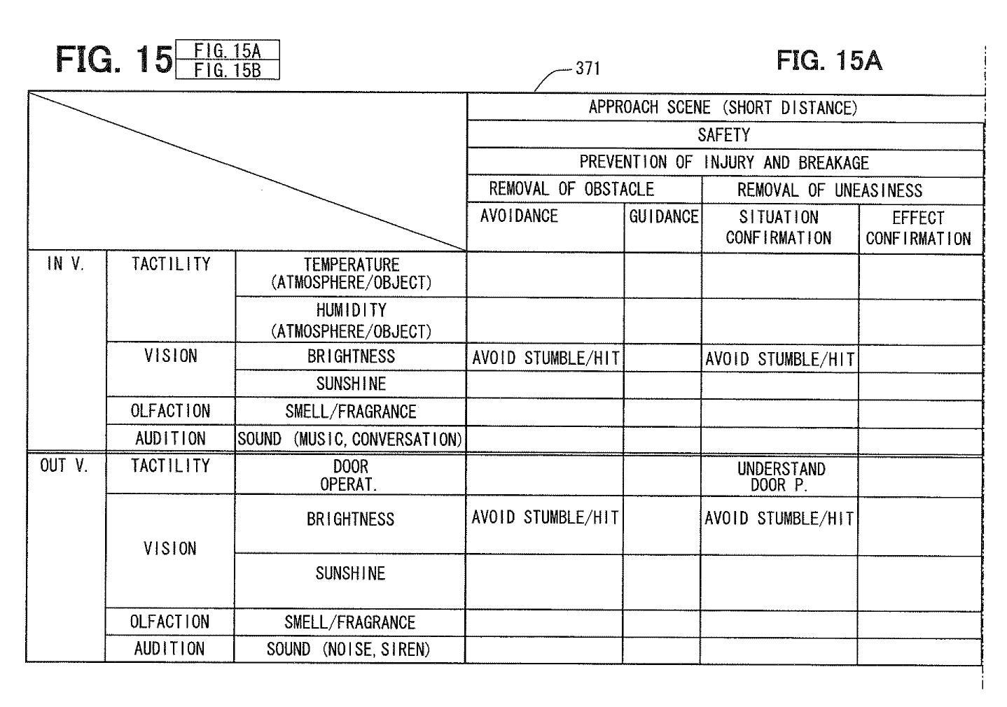

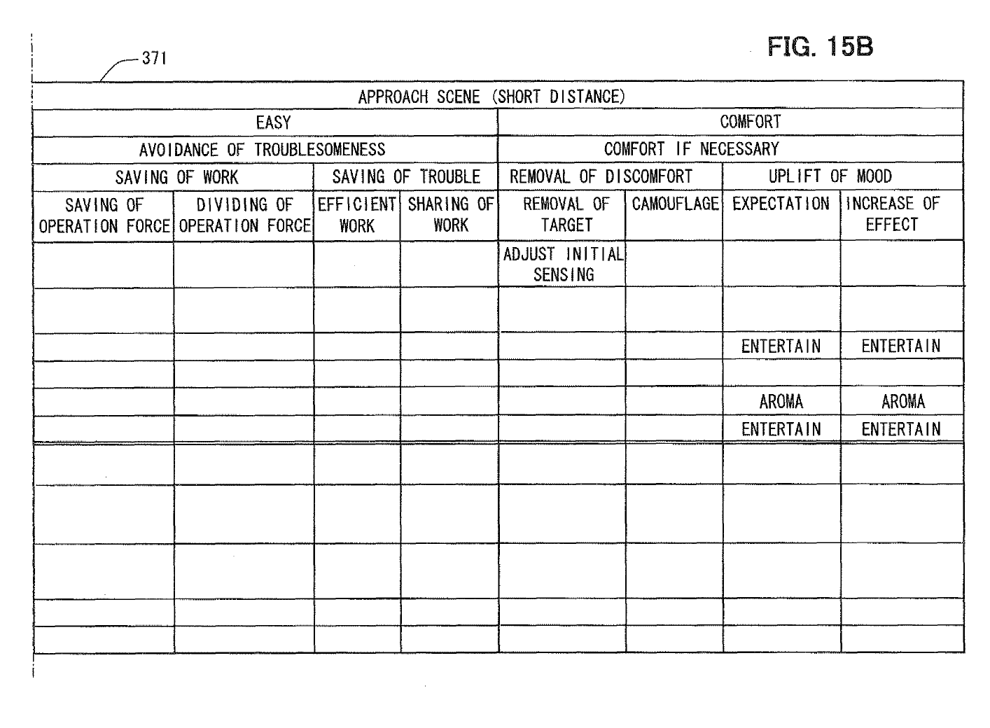

Next, FIG. 15 is an example showing part of an object estimation matrix in the approach scene (short distance), The content is as follows.

(In Vehicle)

“avoidance of stumble and hit”

Classification item: “safety” (Sub item: “prevention of injury and breakage”→“removal of obstacle”→“avoidance”)/

Control target environment item: “brightness (visual sense type)”

“avoidance of stumble and hit”

Classification item: “safety” (Sub item: “prevention of injury and breakage”

“removal of uneasiness”→“confirmation of situation”)/

Control target environment item: “brightness (visual sense type)”

“adjustment of initial thermal sensing”

Classification item: “comfort” (sub item: “comfort if necessary”→“removal of discomfort”→“removal of target”)/

Control target environment item: “temperature (tactile sense type (tactility))”

“entertainment”

Classification item: “comfort” (Sub item: “comfort if necessary”→“uplift of mood”→“expectation/increase of effect”)/

Control target environment item: “brightness (visual sense type)” “sound (hearing sense type (audition))”

“aroma (fragrance)”

Classification item: “comfort” (Sub item: “comfort if necessary”→“uplift of mood”→“expectation/increase of effect”)/

Control target environment item: “smell/fragrance (olfactory sense type (olfaction))”

(Outside Vehicle)

“avoidance of stumble and hit”

Classification item: “safety” (Sub item: “prevention of injury and breakage” “removal of uneasiness”→“confirmation of situation”)/

Control target environment item: “brightness (visual sense type)”

“understanding of position of door (entrance)”

Classification item: “safety” (Sub item: “prevention of injury and breakage”→“removal of uneasiness”→“confirmation of situation”)/

Control target environment item: “door operation (tactile sense type)”

“avoidance of stumble and hit”

classification item: “safety” (Sub item: “prevention of injury and breakage” “removal of uneasiness”→“confirmation of situation”/

Control target environment item: “brightness (visual sense type)”

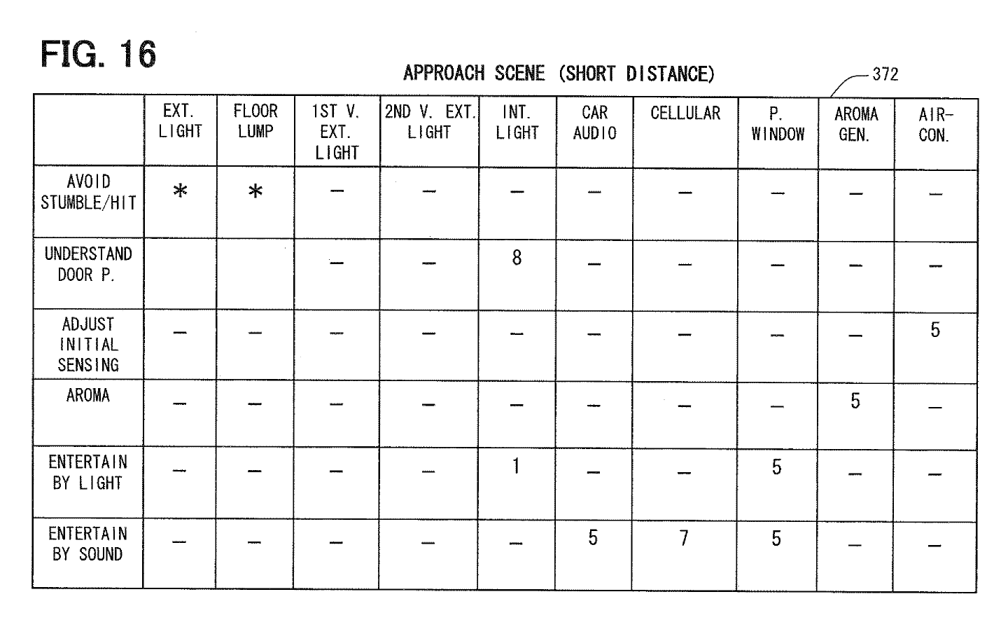

FIG. 16 shows part of the function extraction matrix 372, corresponding to the approach scene. The content of the function extraction matrix 372 is as follows.

“avoidance of stumble and hit” (first type hospitality object)

Selected function: exterior light and under-floor light (headlamp) (Both are uniform control target functions.)

“understanding of position of door (entrance)” (second type hospitality object)

Selected operation: interior light (entertainment of lighting is prioritized)

“adjustment of initial thermal sensing” (first type hospitality object)

Selected function: air conditioning (state-dependent function)

“aroma (fragrance)”

Selected function: fragrance generation portion (state-dependent function)

“entertainment by lighting”

Selected function: Interior light (state-dependent function: Leakage of the light is used for understanding a position of the door (entrance): The standard reference index is set small (in this case, “1”) so that an amount of the leakage of the light increases by illuminating the vehicle interior brightly even when the user is a little sick.)

“entertainment by sound”

Selected function: car audio system, Mobile phone (cellular) (state-dependent function: Reception sound is outputted from a mobile phone of the user.), power window (The window is opened slightly, from which performance sound of the car audio system in the vehicle is leaked to the outside of the vehicle.)

The mobile phone has a larger standard reference index than that of the car audio system. The priority of use of the mobile phone is made lower than that of the car audio system.

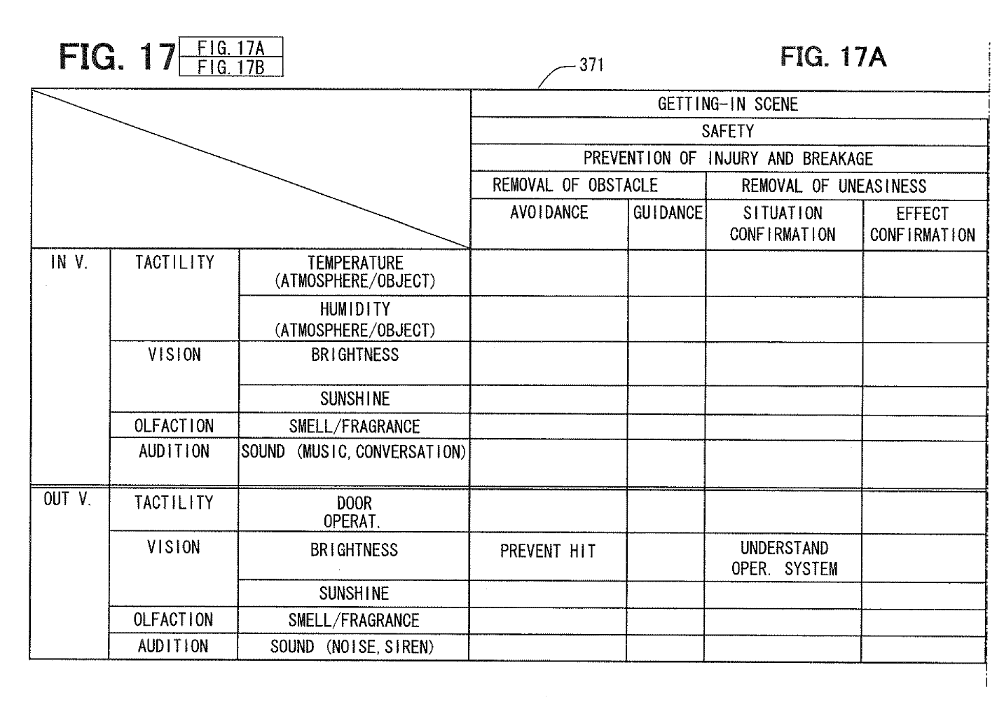

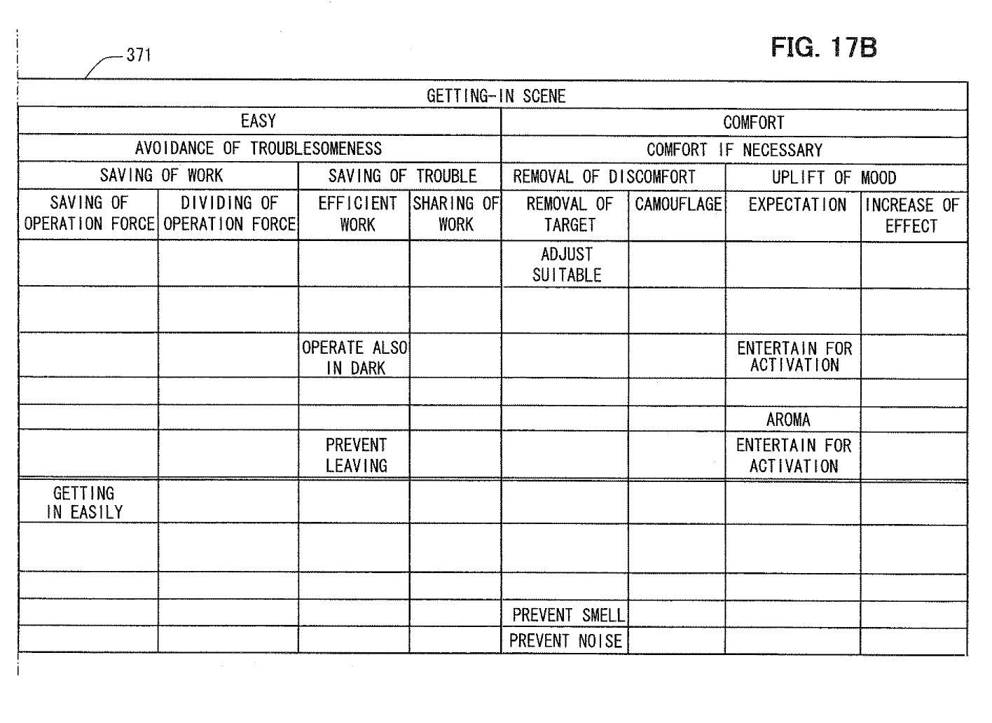

FIG. 17 is an example showing part of an object estimation matrix in the getting-in scene. The content of the object estimation matrix is as follows.

(In Vehicle)

“Suitable temperature adjustment”

Classification item: “Comfort” (Sub item: “comfort if necessary”)→“removal of discomfort”→“removal of target”/

Control target environment item: “temperature (tactile sense type)”

“operation also in dark”

Classification item: “easy” (Sub item: “avoidance of troublesomeness”→“saving of trouble”→“efficient work”)/

Control target environment item: “brightness (visual sense type)”

“/prevention of leaving something behind”

Classification item: “easy” (Sub item: “avoidance of troublesomeness” “saving of trouble”→“efficient work”)/

Control target environment item: “sound (hearing sense type)”

“entertainment for activation”

Classification item: “comfort” (Sub item: “comfort if necessary”→“uplift of mood”→“expectation”)/

Control target environment item: “brightness (visual sense type)” and “sound (hearing sense type)”

“aroma (fragrance)”

Classification item: “comfort” (Sub item: “comfort if necessary”→“uplift of mood”→“expectation”)/

Control target environment item: “smell/fragrance (olfactory sense type)”

(Outside Vehicle)

“prevention of hit (of user)”

Classification item: “safety” (Sub item: “prevention of injury and breakage”→“removal of obstacle”→“avoidance”)/

Control target environment item: “brightness (visual sense type)”

“understanding of operation system”

Classification item: “safety” (Sub item: “prevention of injury and breakage”→“removal of uneasiness”→“confirmation of situation”)/

Control target environment item: “brightness (visual sense type)”

“getting in vehicle easily”

Classification item: “easy” (Sub item: “avoidance of troublesomeness”→“saving of work”→“saving of operation force”)/

Control target environment item: “door operation (tactile sense type)”

“prevention of entering of bad smell”

Classification item: “comfort” (Sub item: “comfort if necessary”→“removal of discomfort”→“removal of target”)/

Control target environment item: “smell/fragrance (olfactory sense type)”

“prevention of interference of noise”

Classification item: “comfort” (Sub item: “comfort if necessary”→“removal of discomfort”→“removal of target”)/

Control target environment item: “sound (hearing sense type)”

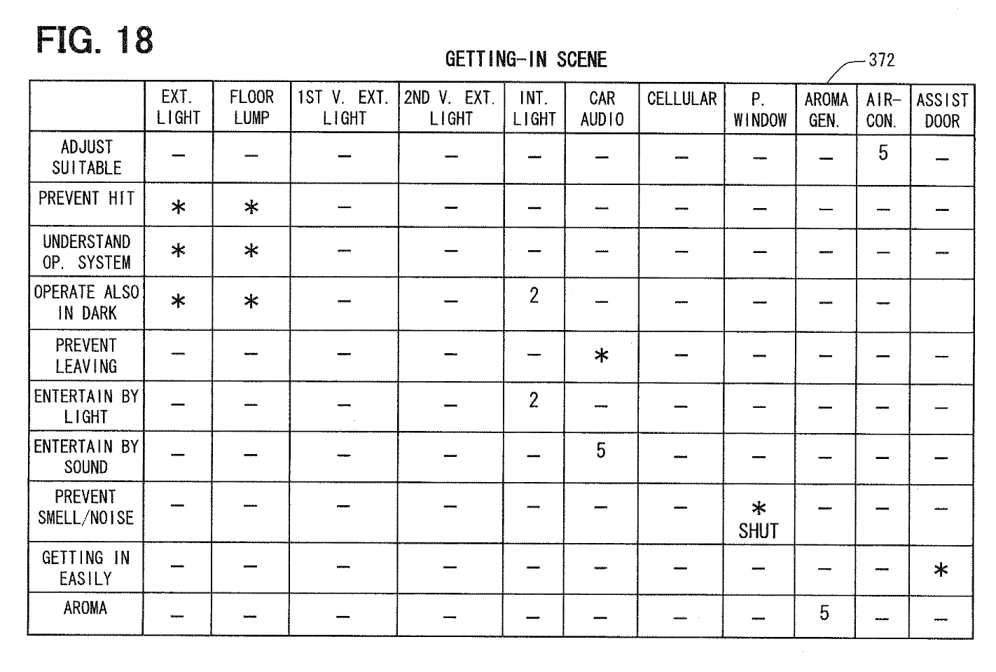

FIG. 18 shows part of the function extraction matrix 372 corresponding to the getting-in scene. Its content is as follows.

“adjustment of suitable temperature” (first type hospitality object)

Selected function: air conditioning (state-dependent function)

“prevention of hit (of user)” (first type hospitality object)

Selected function: exterior light and under-floor light (Both are uniform control target functions.)

“understanding of operation”

Selected function: exterior light and under-floor light (Both are uniform control target functions.)

“operation also in dark” (first type hospitality object)

Selected function: exterior light and under-floor light (Both are uniform control target functions.) and vehicle interior light (state-dependent function)

“prevention of leaving something behind” (first type hospitality object)

Selected function: car audio system (uniform control target function: output of message for confirmation of not leaving anything behind)

“entertainment by lighting (for activation)”

Selected function: vehicle interior light (state-dependent function)

“sound entertainment”

Selected function: car audio system (state-dependent function)

“prevention of entering of bad smell” “prevention of interference of noise”

Selected function: power window (uniform control target function: Window is shut.)

“getting-in vehicle easily”

Selected function: power electric assist door (uniform control target function)

“aroma (fragrance)”

Selected function: fragrance generation portion (state-dependent function)

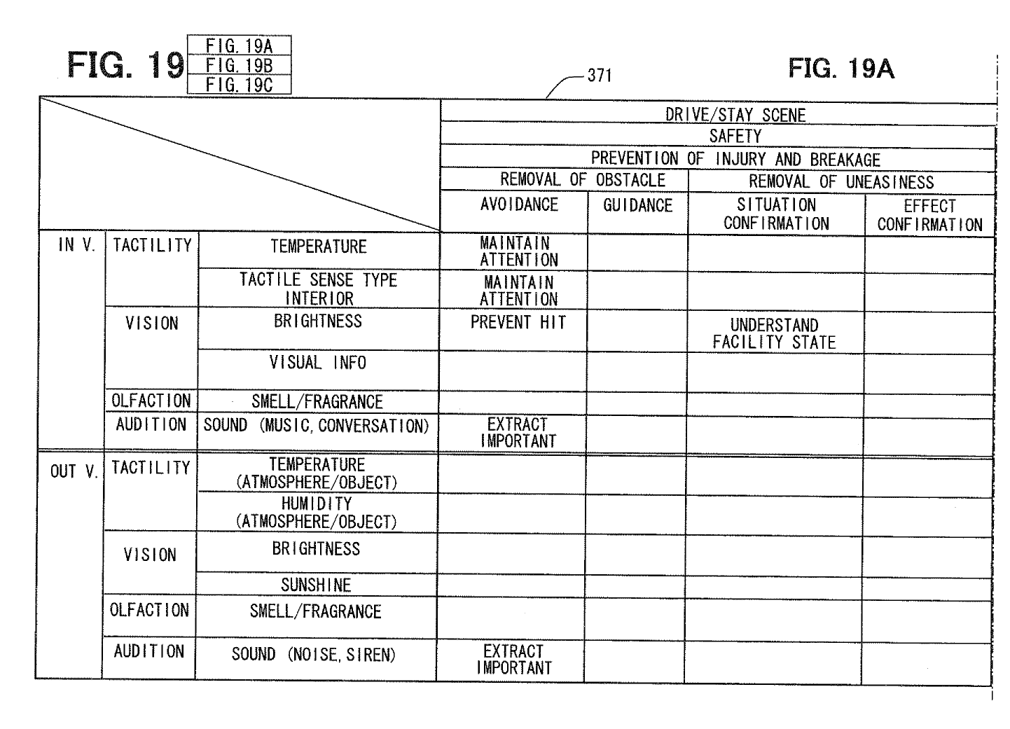

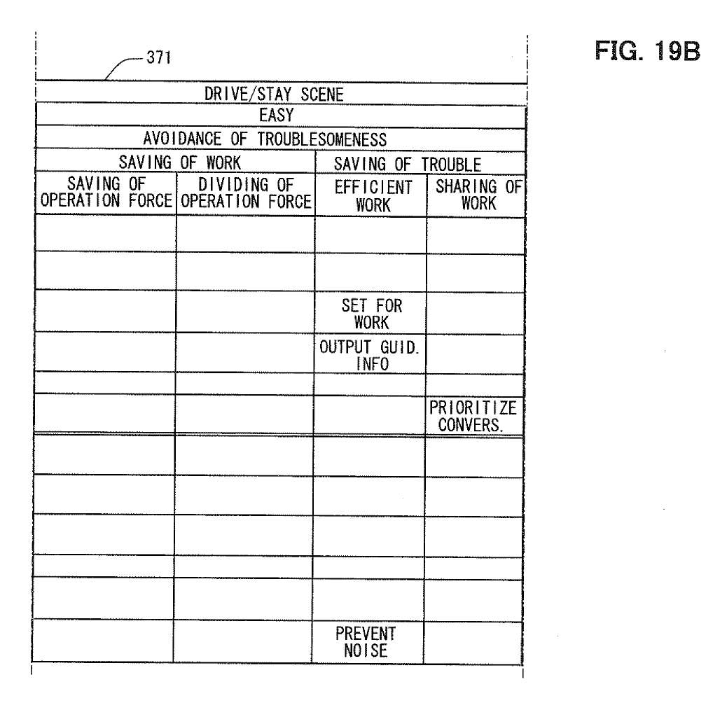

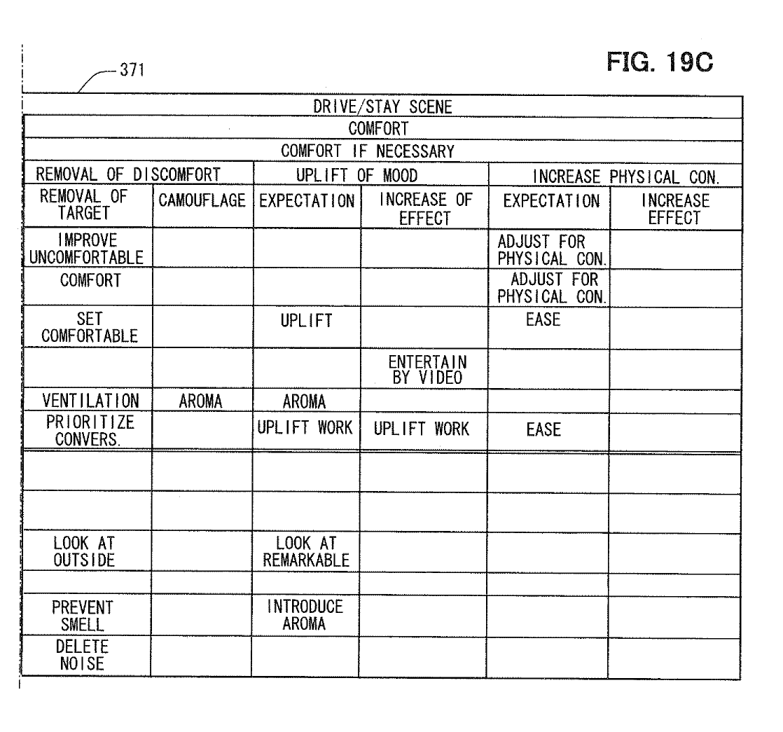

FIG. 19 is an example showing part of the object estimation matrix 371 in the drive/stay scene.

Its content is as follows.

(In Vehicle)

“maintenance of attention”

Classification item: “safety” (Sub item: “prevention of injury and breakage”→“removal of obstacles”→“avoidance”)/

Control target environment item: “temperature (tactile sense type)”

“improvement of uncomfortable temperature”

Classification item: “comfort” (Sub item: “comfort if necessary”→“removal of discomfort”→“removal of target”)/

Control target environment item: “temperature (tactile sense type)”

“adjustment for physical condition”

Classification item: “comfort” (Sub item: “comfort if necessary”→“increase (improvement) of physical condition”→“expectation”)/

Control target environment item: “temperature (tactile sense type)”

“maintenance of attention”

Classification item: “safety” (Sub item: “prevention of injury and breakage”→“removal of obstacles”→“avoidance”)/

Control target environment item: “tactile sense type interior (tactile sense type)”

“comfort”

Classification item: “comfort” (Sub item: “comfort if necessary”→“removal of discomfort”→“removal of target”)/

Control target environment item: “tactile sense type interior (tactile sense type)”

“adjustment for physical condition”

Classification item: “comfort” (Sub item: “comfort if necessary”→“increase of physical condition”→“expectation”)/

Control target environment item: “tactile sense type interior (tactile sense type)”

“prevention of hit”

Classification item: “safety” (Sub item: “prevention of injury and breakage”→“removal of obstacles”→“avoidance”)/

Control target environment item: “brightness (visual sense type)”

“understanding of state of facilities”

Classification item: “safety” (Sub item: “prevention of injury and breakage”→“removal of uneasiness”→“confirmation of situation”)/

Control target environment item: “brightness (visual sense type)”

“setting of brightness in consideration of work”

Classification item: “easy” (Sub item: “avoidance of troublesomeness”→“saving of trouble”→“efficient work”)/

Control target environment item: “brightness (visual sense type)”

“setting of comfortable brightness”

Classification item: “comfort” (Sub item: “comfort if necessary”→“removal of discomfort”→“removal of target”)/

Control target environment item: “brightness (visual sense type)”

“uplift (entertainment by lighting)”

Classification item: “comfort” (Sub item: “comfort if necessary”→“uplift of mood”→“expectation”)/

Control target environment item: “brightness (visual sense type)”

“ease (entertainment by lighting)”

Classification item: “comfort” (Sub item: “comfort if necessary”→“increase of physical condition”→“expectation”)/

Control target environment item: “brightness (visual sense type)”

“output of guidance information”

Classification item: “easy” (Sub item: “avoidance of troublesomeness”→“saving of trouble”→“efficient work”)/

Control target environment item: “visual information (visual sense type)”

“uplift by video”

Classification item: “comfort” (Sub item: “comfort if necessary”→“uplift of mood”→“increase of effect”)/

Control target environment item: “visual information (visual sense type)”

“prioritizing of conversation”

Classification items: “easy” (Sub items “avoidance of troublesomeness”→“saving of trouble”→“sharing of work”)/

Control target environment item: “sound (hearing sense type)”

“prioritizing of conversation/sound”

Classification item: “comfort” (Sub item: “comfort if necessary”→“removal of discomfort”→“removal of target”)/

Control target environment item: “sound (hearing sense type)”

“uplift of work (sound entertainment)”

Classification item: “comfort” (Sub item: “comfort if necessary”→“uplift of mood”→“expectation”)/

Control target environment item: “sound (hearing sense type)”

“uplift of work/conversation (sound entertainment)”

Classification item: “comfort” (Sub item: “comfort if necessary”→“uplift of mood”→“increase of effect”)/

Control target environment item: “sound (hearing sense type)”

“ease (entertainment by lighting)”

Classification item: “comfort” (Sub item: “comfort if necessary” “increase of physical condition”→“expectation”)/

Control target environment item: “sound (hearing sense type)”

(outside vehicle)

“looking at outside”

Classification item: “comfort” (Sub item: “comfort if necessary”→“removal of discomfort”→“removal of target”)/

Control target environment item: “brightness (visual sense type)”

“looking at remarkable object”

Classification item: “comfort” (Sub item: “comfort if necessary”→“uplift of mood”→“expectation”)/

Control target environment item: “brightness (visual sense type)”

“prevention of entering of and decomposition of bad smell”

Classification item: “comfort” (Sub item: “comfort if necessary”→“removal of discomfort”→“removal of target”)/

Control target environment item: “smell/fragrance (olfactory sense type)”

“introduction of aroma”

Classification item: “comfort” (Sub item: “comfort if necessary”→“uplift of mood”→“expectation”)/

Control target environment item: “smell/fragrance (olfactory sense type)”

“extraction of important sound”

Classification item: “safety” (Sub item: “prevention of injury and breakage”→“removal of obstacles”→“avoidance”)/

Control target environment item: “sound (hearing sense type)”

“prevention of interference of noise”

Classification item: “easy” (Sub item: “avoidance of troublesomeness”→“saving of trouble”→“efficient work”)/

Control target environment item: “sound (hearing sense type)”

“removal of noise”

Classification item: “comfort” (Sub item: “comfort if necessary”→“removal of discomfort”-4 “removal of target”)/

Control target environment item: “sound (hearing sense type)”

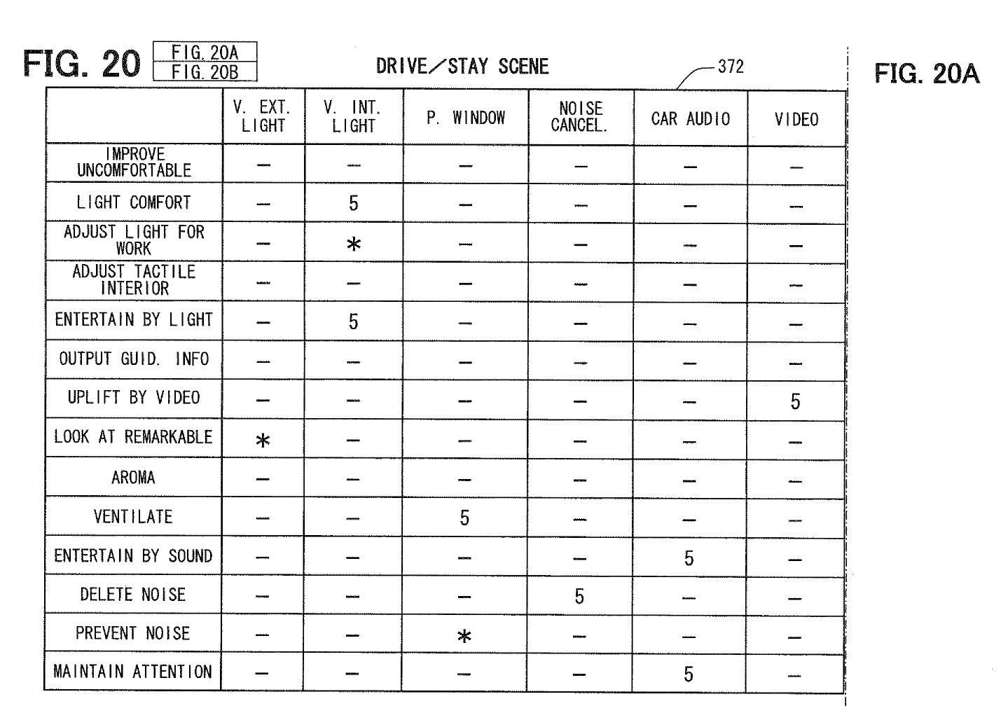

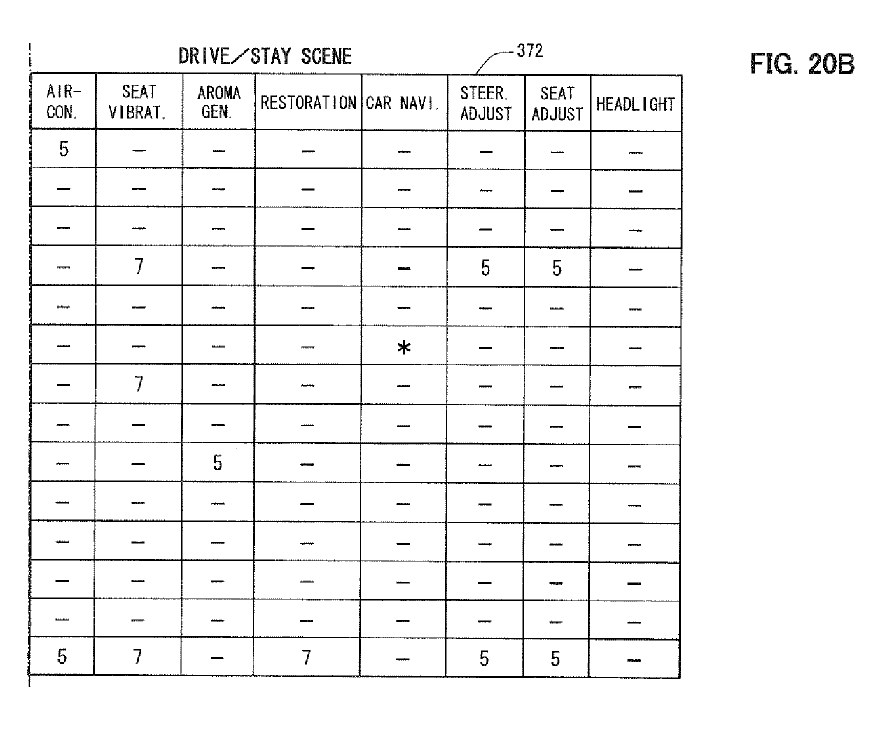

FIG. 20 shows part of the function extraction matrix 372 corresponding to the drive/stay scene.

Its content is as follows.

“improvement of uncomfortable temperature (maintenance of attention, adjustment for physical condition)” (first type hospitality object)

Selected function: air conditioner (state-dependent function)

“comfortable brightness (lighting)” (first type hospitality object)

Selected function: vehicle interior light (state-dependent function)

“brightness suitable for work (prevention of hit, understanding of situation of facilities)” (first type hospitality object)

Selected function: interior light (uniform control target function)

“tactile sense type interior”

Selected function: electric seat, steering wheel, seat vibrator (These are all state-dependent functions.)

“entertainment by lighting (uplift/ease)” (first type hospitality object)

Selected function: vehicle interior light (state-dependent function)

“output of guidance information” (first type hospitality object)

Selected function: car navigation system (uniform control target function: output of guidance information by car navigation system)

“uplift by video”

Selected function: video output device (state-dependent function), seat vibrating mechanism (state-dependent function)

“looking at outside (looking at remarkable objet)”

Selected function: headlamp (and fog lamp) (uniform control target function)

“aroma (prevention of entering of and decomposition of bad smell)”

Selected function: fragrance (aroma) generation portion (state-dependent function)

“introduction and ventilation of fragrance”

Selected function: power window (state-dependent function)

“sound entertainment (uplift of work, uplift of work/conversation, ease)”

Selected function: car audio system (state-dependent function)

“prevention of entering of bad smell” “prevention of interference of noise”

Selected function: power window (uniform control target function; full closing of window)

“deletion of noise (extraction of important sound, prioritizing of conversation and sound)”

Selected function: noise canceller (state-dependent function)

“prevention of interference of noise”

Selected function: power window (uniform control target function; full closing of window)

“maintenance of attention”

Selected function: car audio system, air conditioner, seat vibration, restoration, steering adjustment mechanism, seat adjustment mechanism (These are all state-dependent functions.)

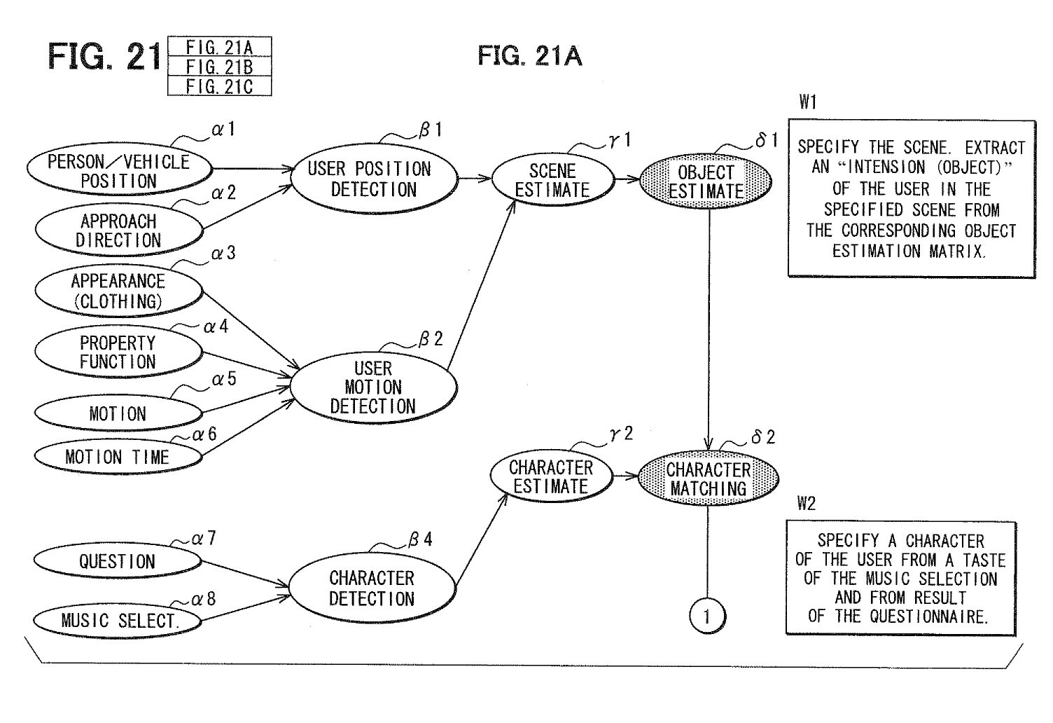

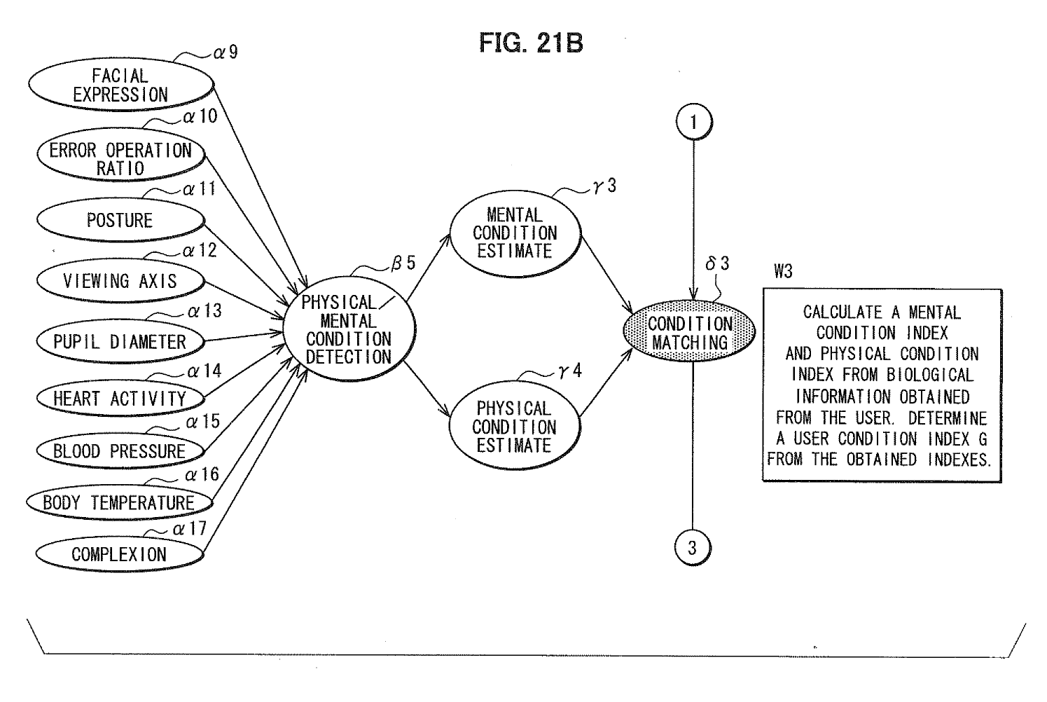

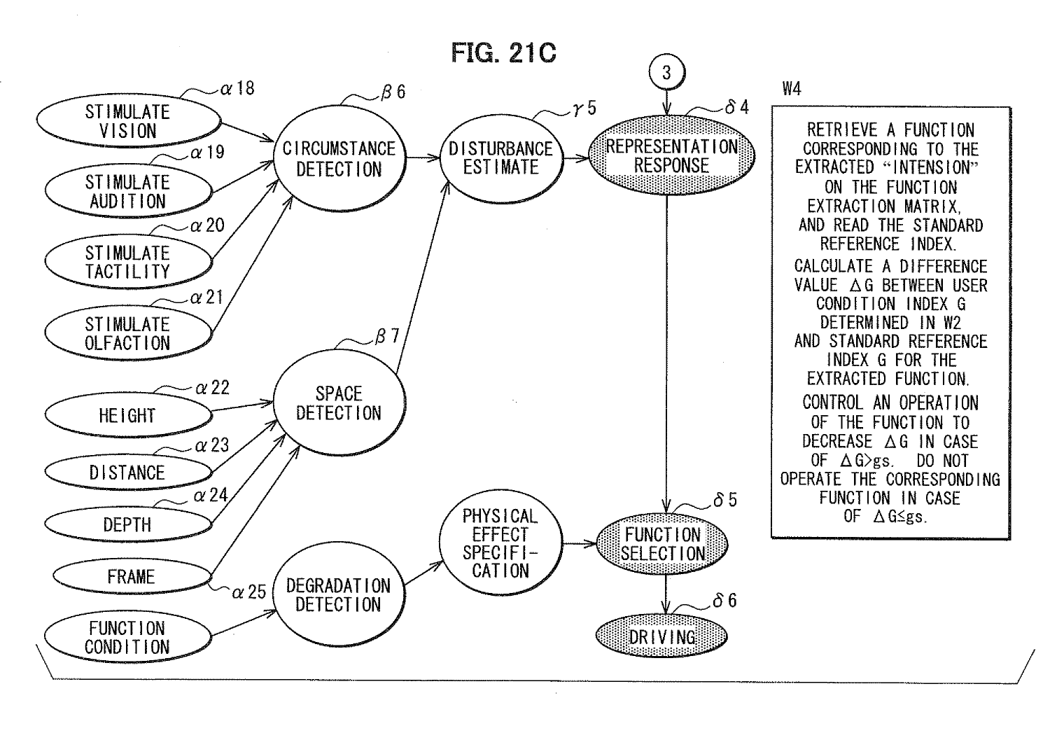

Operations of a vehicular user hospitality system (hereinafter called just a “system”) 100 is explained below. FIG. 21 schematically shows an overall algorithm of a series of processes from the hospitality determination to the hospitality operation execution. The main hospitality process includes the steps of “object estimation (δ1),” “character matching (δ2),” “condition matching (δ3),” “representation response (or entertainment response) (δ4),” “function selecting (δ5),” and “driving (δ6).”

In “object estimation (δ1),” a current scene is estimated by a user position detection (β1) and user motion detection (β2). The user position detection (β1) is executed by grasping and specifying a relationship (α1) between a user and a vehicle. In this embodiment, an approach direction (α2) of the user is also considered. Fundamentally, the user motion detection (β2) is executed by use of outputs of the sensors (scene estimation information obtaining means) for detecting motions uniquely defined to determine scenes, such as the opening and closing of the door and the seating on the seat (α5). As well as detecting a shift from the preparation scene to the drive/stay scene in accordance with a seating duration, a duration of a specified motion (α6) is also considered.

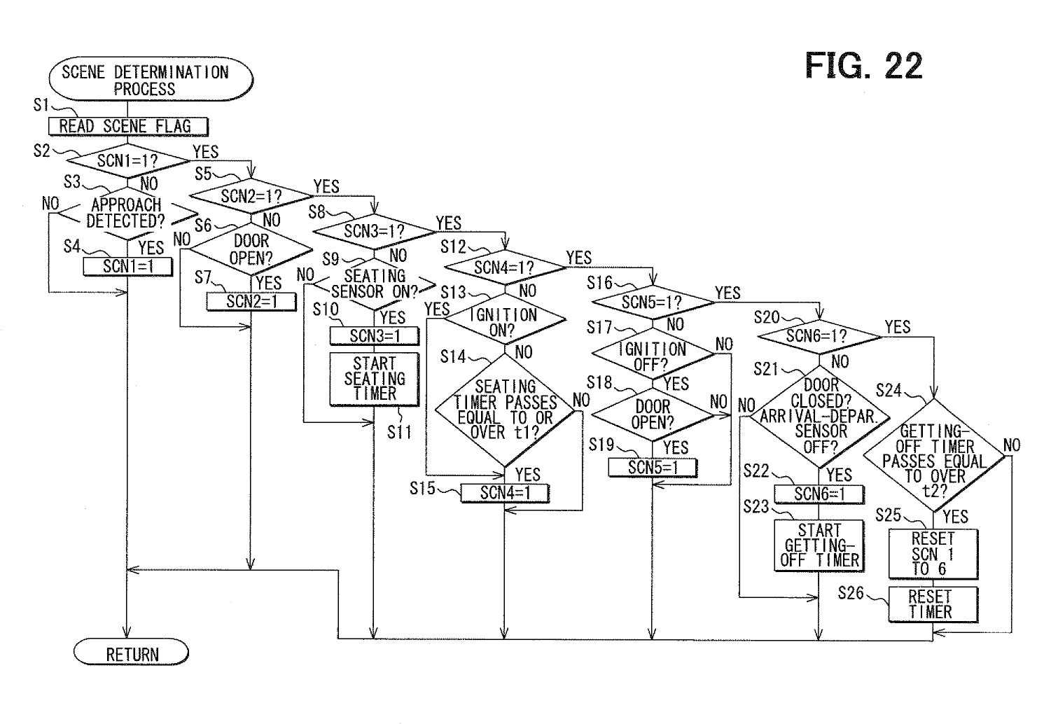

FIG. 22 is a flowchart showing a flow of a process for determining the scene. This process is executed repeatedly in a predetermined cycle while the vehicle is being used. First at Step S1, the scene flag 350 of FIG. 12 is read. At Step S2, Step S5, Step S8, Step S12, Step S16, and Step S20, which scene is ongoing is determined from a state of the scene flag 350. In the scene flag 350, the flags are set in the time sequential order of the scenes. The flag of a following scene is not set separately by bypassing the flag of the preceding scene.

At Step S2 to Step S4, the approach scene is specified. First at Step S2, a flag SCN1 of the approach scene is confirmed not to be “1” (namely, the approach scene is not ongoing). At Step S3, from position information specified by the vehicle GPS 533 (FIG. 1) and user GPS (for example, built in the mobile phone 1), it is determined whether the user approaches to within a predetermined distance (for example, 50 m) to the vehicle. When the user approaches to within the predetermined distance, it is determined that the shift to the approach scene is done and SCN1 is set to “1” at Step S4 (in this embodiment, the approach scene is further divided into an approach scene for “long distance” and an approach scene for “short distance” in accordance with the distance between the user and vehicle).

At Step S5 to Step S7, the getting-in scene is specified. At Step S5, a flag SCN2 of the getting-in scene is confirmed not to be “1.” At Step S6, from input information from the door courtesy switch 537, it is determined whether the door is opened. When the door is opened, it is determined that the shift to the getting-in scene is done, and SCN2 is set to “1” at Step S7. Since the current scene is confirmed to be SCN=1, namely, the approach scene, it can be easily determined that the door opening in this situation is done in getting in the vehicle.

At Step S8 to Step S11, the preparation scene is specified. At Step S8, a flag SCN3 for the preparation scene is confirmed not to be “1.” At Step S9, it is determined whether the user is seated on the seat, from the input information from the seating sensor 520. When the seating of the user is detected, the shift to the preparation scene is determined to be done, and SCN3 is set to “1” at Step S10. In this stage, only the complete of the seating is detected. The preparation stage where the user shifts to driving or staying in the vehicle completely, is only specified. At Step S11, a seating timer used for determining the shift to the drive/stay scene starts.

At Step S12 to Step S15, the drive/stay scene is specified. At Step S12, a flag SCN4 for the drive/stay scene is confirmed not to be “1” and it is determined whether the user starts the engine in accordance with the input information from the ignition switch 538. When the engine starts, the shift to the drive/stay scene is done immediately. The process jumps to Step S15 to set SCN4 to “1.” On the other hand, even when the engine does not start, but when the seating timer shows that a predetermined time (t1) elapses, the user is determined to get in and stay in the vehicle (e.g., for the purpose other than driving). The process goes to Step S15 to set SCN4 to “1” (when t1 does not elapse, the process skips Step S15 to continue the preparation scene).

At Step S16 to Step S19, the getting-off scene is specified. At Step S16, a flag SCN5 for the getting-off scene is confirmed not to be “1.” At Step S17, it is determined whether the user stops the engine in accordance with the input information from the ignition switch 538. When the engine stops, the process goes to Step S18. It is determined whether the user opens the door in accordance with the input information of the door courtesy switch 537. When the door is opened, the shift to the getting-off scene is determined to be done. At Step S19, SCN5 is set to “1.”

At Step S20 to Step S23, the separation scene is specified. At Step S20, a flag SCN6 for the separation scene is confirmed not to be “1.” At Step S21, in accordance with the ignition switch 538 and input information from the seating sensor 520, it is determined whether the user closes the door while separating from the seat. When Yes, the process goes to Step S22 to set SCN6 to “1.” At Step S23, a getting-off timer is started. At Step S20, when SCN6 is 1 (the separation scene is in progress), the process goes to Step S24 or further. A time t2 required for the hospitality process in the getting-off scene is measured by the getting-off timer. When t2 already elapses at Step S24, the scene flag is reset for the next hospitality process at Step S25. At Step S26, the seating timer and the getting-off timer are reset.

In FIG. 21, when the scene is determined at γ1, the hospitality object for the scene is estimated at δ1. Specifically, as shown in W1, the hospitality objects are selected from the object estimation matrix 371 exampled in FIG. 13, 15, 17 or 19 and corresponding to the specified scene is selected. In the respective classification items for safety, convenience, and comfort, the hospitality object matching the control target environment items for the tactile sense type, visual sense type, olfactory sense type, and hearing sense type, is retrieved. When the hospitality object is retrieved, the corresponding function extraction matrix 372 for each scene, exampled in FIG. 14, 16, 18 or 20, is referenced to extract the hospitality function corresponding to the determined hospitality object. Specifically, a matrix cell corresponding to each hospitality object is retrieved sequentially. When the matrix cell contains the standard reference index, the corresponding function is extracted as the state-dependent function. When the matrix cell contains the identification information “*,” the corresponding function is extracted as the state-dependent function.

Next, in δ2, the hospitality content is matched with a character of the user. Especially, in accordance with the after-mentioned user character detection process and the determined character, each hospitality process is weighted appropriately. Namely, to match the hospitality with a character of each user, a combination of multiple hospitality operations is customized properly or a level of the hospitality operation is changed. To specify the character, a character detection process β4 is required. The process β4 uses a method for obtaining a character classification from an input by the user, such as a questionnaire process (α7), and a method for determining more analytically a character classification from a motion, act, thought pattern, or facial expression of the user. The latter method is shown in the after-mentioned embodiment as a concrete example for determining a character classification from statistics of music selection (α8: see W2).

Next, the hospitality content is matched with the user mental/physical condition in δ3. A detailed concrete example of this process is described later. In accordance with detection information of the user biological characteristic information obtaining means, the mental/physical condition information reflecting the mental and physical condition of the user is obtained. In accordance with the obtained content, the mental or physical condition of the user is estimated. Specifically, the physical condition index and mental condition index are calculated from the user biological characteristic information obtained from the user. Further, in accordance with the physical condition index or mental condition index, the user condition index G is calculated (W3).

The user biological characteristic information obtaining means can use an infrared sensor 519 (complexion: α17), a face camera 521 (facial expression: α9, posture: α11, viewing axis (line of sight): α12, and pupil diameter: α13), a pulse sensor (pulse (electrical heart activity): α14), and so on. Additionally, sensors for detecting a history of the operations (502w, 530, 531, 532, 532a; error operation ratio: a10), a blood pressure sensor (α15), a seating sensor 520 (the pressure sensor measures a weight distribution on the seat and detects small weight shifts to determine loss of calm in driving, and detects a biased weight to determine a level of fatigue of the driver). The detail is explained later.

The object of the process is as follows. An output from the user biological characteristic information obtaining means is replaced with a numeral parameter showing the mental and physical conditions (β5). In accordance with the numeral parameter and its time change, the mental and physical conditions of the user are estimated (γ3, γ4). Each hospitality process is weighted properly. Namely, to match the hospitality operations with the estimated user mental and physical conditions, a combination of the multiple hospitality operations is customized properly, or a level of the hospitality operation is changed. Even in the same scene, as described above, the hospitality operation matching a different character of each user is preferably executed. A type and level of even the hospitality for the same user is preferably adjusted in accordance with the mental and physical conditions.

For example, in case of the lighting, a color of the lighting requested by the user often differs in accordance with a character of the user (for example, an active user requests reddish color, and a gentle user requests greenish and bluish colors). A required brightness often differs in accordance with the physical condition of the user (in case of poor physical condition, a brightness is decreased to restrict soreness by the lighting). In the former, a frequency or wavelength (a waveform becomes shorter in the order of red, green, and blue) is adjusted as the hospitality. In the latter, an amplitude of the light is adjusted as the hospitality. The mental condition is a factor related to the frequency or wavelength and amplitude. To further uplift a little cheerful mental condition, a red light can be used (frequency adjustment). Without changing a color of the light, the brightness can be changed (amplitude adjustment), To calm a too much excited condition, a blue light can be used (frequency adjustment). Without changing a color of the light, the brightness can be decreased (amplitude adjustment). Since music contains various frequency elements, more complex processes are needed. To increase an awakening effect, a sound wave in a high sound area of about some hundreds Hz to 10 kHz is emphasized. To calm the mood of the user, the so-called α wave music in which a central frequency of a fluctuation of a sound wave is superimposed to a frequency (7 to 13 Hz: Schumann resonance) of the brain wave when relaxed (a wave) is used, for example. The control pattern can be grasped in accordance with the frequency or amplitude.

With respect to the brightness and the level of the sound wave in the vehicle, an appropriate level can be set as a numeral in each scene in view of a character and mental and physical conditions. This setting is done using the above function extraction matrix 372.

Next, in δ4, the hospitality for entertainment is processed. For example, from an output of the illumination sensor 539 (visual sense stimulation: α18) and sound pressure sensor (hearing sense stimulation: α19), information (disturbance stimulation) about what level of the stimulation the user receives is obtained (environment estimation: β6). By converting the disturbance stimulation to a value comparable to the user condition index G (or the difference ΔG between the user condition index G and the standard reference index G0), numeral estimation of the disturbance is executed (γ5). As disturbance stimulations to be specified, a tactile sense stimulation (α20: for example, the pressure sensor 523 mounted to the steering wheel) and a smell stimulation (α21: the smell sensor) can be used. With respect to the disturbance estimation, an indirect stimulation from a space surrounding the user, concretely, a height (α22), a distance (α23), a depth (α24), and physical frames (α25) of the user and passengers can be considered (space detection: β7).

In δ5, the function selection process is executed. As described above, in case of the state-dependent function, the difference value ΔG is calculated by subtracting the standard reference index G0 from the user condition index G. Then, the hospitality function selected for decreasing the difference value ΔG is controlled. Specifically, as a gap from the appropriate state G0 of the user, namely, the difference value ΔG becomes greater, an electric output level of the function for canceling the gap can be increased greater. On the other hand, in view of canceling the influence of disturbance, as the detected disturbance level becomes greater, an electric output level of the function for canceling the disturbance level can be increased greater. The control of the combination of the difference and disturbance is as follows.

For example, when the maximum value of an electric output level for canceling the occurred disturbance is Pmax, the maximum value of an assumed disturbance level is Emax, and the maximum value of the difference value ΔG is ΔGmax, an electric output level P to set is P=Pmax·(E/Emax)·(ΔG/ΔGmax). In this method, as a detected disturbance E becomes greater the electric output level P is set larger and the contribution of the disturbance to the dissatisfaction, the disturbance being different for each user, is considered by the difference value ΔG. When ΔG is a predetermined lowermost value gs or under (0, for example), the operation of the hospitality function stops (or enters an idling state equivalent to the stop).

When the disturbance level E is unknown, or the detection accuracy of over a predetermined level cannot be obtained, the electric output level P of the function is set to a predetermined excess setting value in the initial setting (for example, in case of “hot,” the cooling output of the air conditioner is set to the maximum value Pmax or an excess setting value Pe near the maximum value Pmax). Then, the shrinking of the difference value ΔG is monitored by continuously detecting the user biological characteristic information to gradually decreasing the electric output level P. Finally, a control algorithm for stabilizing the electric output level P at a value at which the difference value ΔG is minimized can be used. Also in this case, as the difference value ΔG becomes greater, the duration in which the electric output level P is set large continues for long time, so that an average of the electric output levels required for stabilization increases. When the difference value ΔG starts increasing after the stabilization, the electric output level P can be increased in accordance with an increment of the difference value ΔG.

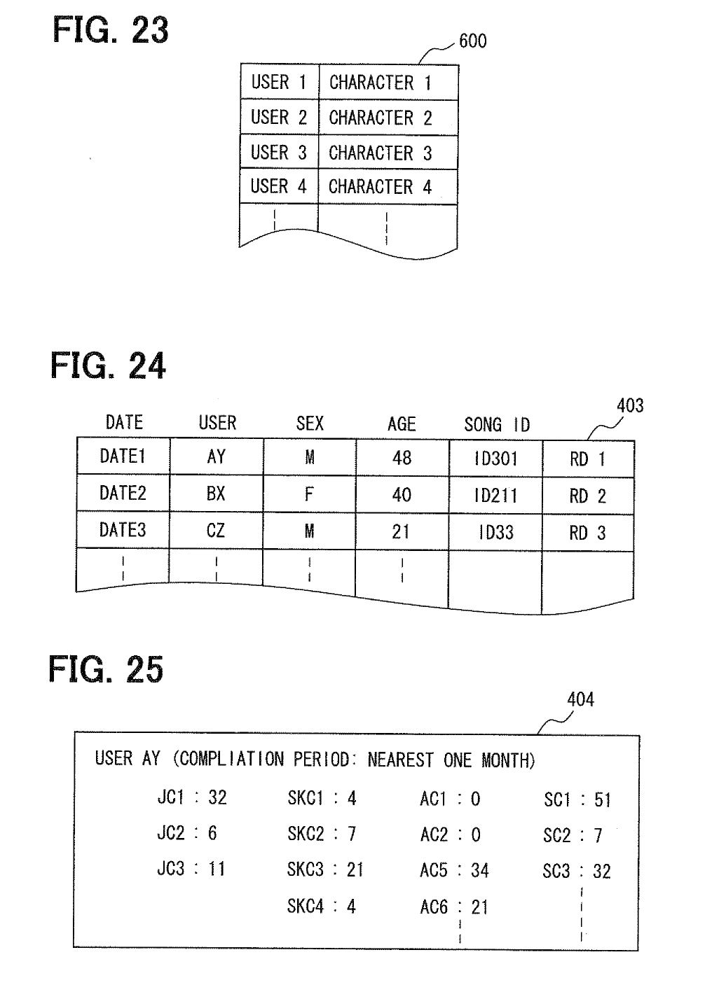

The character types are defined through the following method. Users of a vehicle can be previously registered in a user registration portion 600 formed in the ROM (preferably, a rewritable flash ROM), as shown in FIG. 23. In this user registration portion 600, names of the users (or user IDs and personal identification numbers) and character types are registered corresponding to each other. This character types are estimated in accordance with music selection statistics information of the car audio system, which is accumulated while the user is using the vehicle. When the music selection statistics information is accumulated insufficiently, such as just after the user starts using the vehicle, or when the character type is to be estimated without collecting the operation history information daringly, the user may be made to input character type information or information required to specify the character type information. Then, the character type may be determined in accordance with the input result.

For example, the monitor 536 of FIG. 1 (which may be replaced by the monitor of the car navigation system 534) displays the character types. The user can select the character type matching himself or herself, and input it from the input portion 529. Instead of a direct input of the character type, a questionnaire input for the character type determination may be executed. In this case, question items of the questionnaire are displayed on the monitor 536. The user selects from the answer choices (the selection buttons 529B form the choices, and by touching a corresponding position of the touch panel 529 on the buttons, the selection input is done). By answering all the questions, one character type is uniquely determined from the character type group in accordance with a combination of the answers.

The user registration input including names of the users is executed from the input portion 529. The names and determined character types are stored in the user registration portion 600. These inputs can be executed from the mobile phone 1. In this case, the input information is sent to the vehicle by radio. When a user buys a vehicle, the user registration input can be previously done by a dealer by use of the input portion 529 or a dedicated input tool.

The determination of a character type in accordance with the statistics information about the music selection of the car audio system is explained below. In the car audio system 515 of FIG. 6, the user can always select and enjoy his or her favorite song by executing an input from the operation portion 515d. When the user selects a song, the user specifying information (user name or user ID), an ID of the selected music source data, and the above hospitality reference data RD (character type code, age code, sex code, genre code, and song mode code) correspond to each other, and are stored in the music selection history portion 403 (formed in the storage device 535 of FIG. 1), as shown in FIG. 24. In this embodiment, a date of the music selection and a sex and age of the user are also stored.

In the music selection history portion 403, statistics information 404 (stored in the storage device 535 of FIG. 1) about the music selection history is produced for each user, as shown in FIG. 25. In the statistics information 404, the music selection data is counted for each character type code (SKC), and what character type corresponds to the most frequently selected song is specified as a numeral parameter. The most simple process is such that a character type corresponding to the most frequently selected song can be specified as a character of the user. For example, when the number of the music selection histories stored in the statistics information 404 reaches a predetermined level, the character type initially set from the input by the user may be replaced with the character type obtained from the statistics information 404 as described above.

The types of the characters of users are complicated actually. The character type is not simple enough to be determined from only the taste in music. In accordance with a life environment of the user (for example, whether the user is satisfied or stressed), the character and taste may change in a short term. In this case, it is natural that the taste in music also change and the character type obtained from the statistics of the music selection changes. In this case, as shown in FIG. 25, when the statistics information 404 about the music selection is produced for only the nearest predetermined period (for example, one to six months), instead of obtaining the statistics of the music selection histories unlimitedly, the short-term change of the character type can be reflected by the statistics result. As a result, a content of the hospitality using music can be changed flexibly in accordance with a condition of the user.

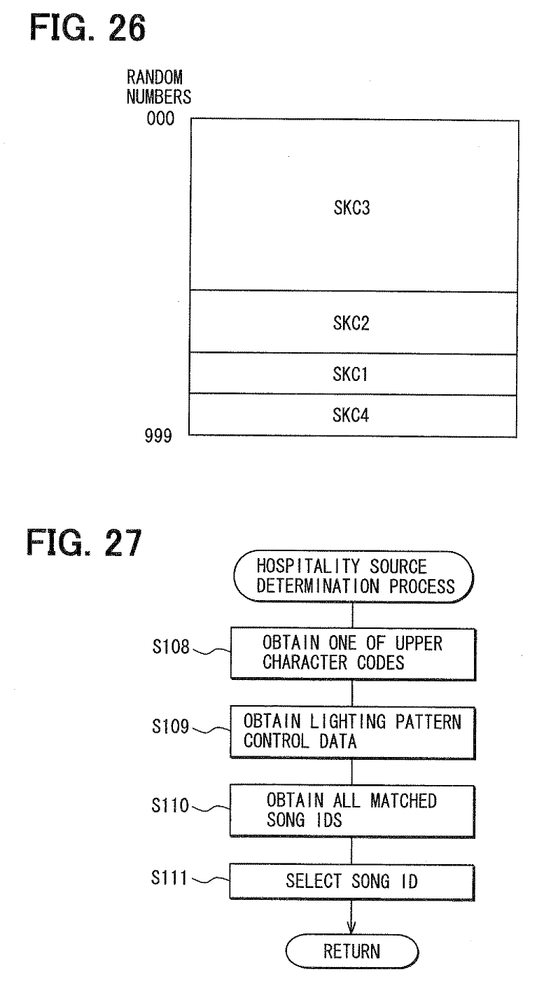

Even the same user does not always select the music corresponding to the same character type, but may select the music corresponding to another character type. In this case, when the music selection is done in accordance with only the character type corresponding to the song most frequently selected by the user, the situation undesirable for switching a mood of the user may occur. Music selection probability expectation values are assigned to the respective character types in accordance with music selection frequencies shown by the statistics information 404. Songs can be selected randomly from the songs of the character types weighted in accordance with the expectation values. Accordingly, with respect to the music source in which the user is interested more or less (namely, selected by the user), the songs of the multiple character types are selected preferentially in the descending order of a selection frequency. The user can sometimes receive the hospitality using the music not corresponding to the character type of the user, resulting in a good switch of the mood. Specifically, as shown in FIG. 26, a random number table including the predetermined number of random values is stored. The number of the random values are assigned to the respective character types in proportion to the music selection frequency. Next, a random number is generated by a known random number generation algorithm. It is checked to which character type the obtained random number value is assigned, so that the character type to be selected can be specified.

In the statistics information 404, music selection frequencies in accordance with the music genre (JC), age (AC), and sex (SC) are counted. As well as in the above method in case of the character types, the music source data belonging to the genre, age group, or sex where songs are frequently selected, can be preferentially selected. Accordingly, the hospitality music selection matching the taste of the user is possible. The multiple character types can be assigned to one music source data.

FIG. 27 is a flowchart showing one example of the process. As shown in FIG. 25, when the music selection frequency statistics for each character type are obtained, random numbers on the random number table are assigned to the respective character types in proportion to the respective music selection frequencies, as shown in FIG. 26. Next, at Step S108 of the flowchart, one arbitrary random number value is generated, and the character type code corresponding to the obtained random number value is selected on the random number table. Next, at Step S109, from the lighting control data group of FIG. 3, the lighting pattern control data corresponding to the character code is selected. At Step S110, all the music source data corresponding to the genre, age group, and sex having the highest music selection frequencies in FIG. 25, are extracted from the music source data corresponding to the obtained character type (as well as in case of the determination of the character type, the genre, age, and sex of the music selection may be selected by use of the random numbers assigned in proportional to the frequency of each genre, age, and sex). When the multiple music source data are extracted, an ID of one of the music source data may be selected by use of a random number, as well as at Step S111. Additionally, the list of the music source data is shown on the monitor 536 (FIG. 1), and the user selects the music source data manually by use of the operation portion 515d (FIG. 6). In accordance with the selected lighting control data, the lighting of the lighting device in the vehicle which is being driven by the user (or in which the user stays) is controlled. The music is played in the car audio system by use of the selected music source data.

Before the user uses the vehicle, the user authentication is required. Especially when multiple users are registered, a different character type is set to each user, and thus a content of the hospitality differs in accordance with each user. The most simple authentication is such that a user ID and personal identification number are sent from the mobile phone 1 to the hospitality determination section 2 on the vehicle. Then, the hospitality determination section 2 checks the sent user ID and personal identification number to the registered user IDs and personal identification numbers. The biometrics authentication such as verification of a photograph of a face by use of a camera provided to the mobile phone 1, voice authentication, and fingerprint authentication, can be used. On the other hand, when the user approaches the vehicle, a simple authentication using a user ID and personal identification number may be executed. After the user unlocks the door and gets in the vehicle, the biometrics authentication using, e.g., the face camera 521, the microphone 522, the retina camera 526, the iris camera 527, or the vein camera 528 may be executed.

The representative example of the hospitality in each scene is explained below.

In the approach scene, a direction of an approach to the vehicle by the user (terminal device 1) is specified. On the vehicle, from positional information of the GPS 533 and a history of changes of the traveling direction until the parking, a position and direction of the vehicle can be specified. Accordingly, by referencing positional information sent from the mobile phone 1 (from the GPS), a direction of an approach to the vehicle by the user, for example, an approach from the front, rear, or side, and a distance between the vehicle and the user can be recognized.

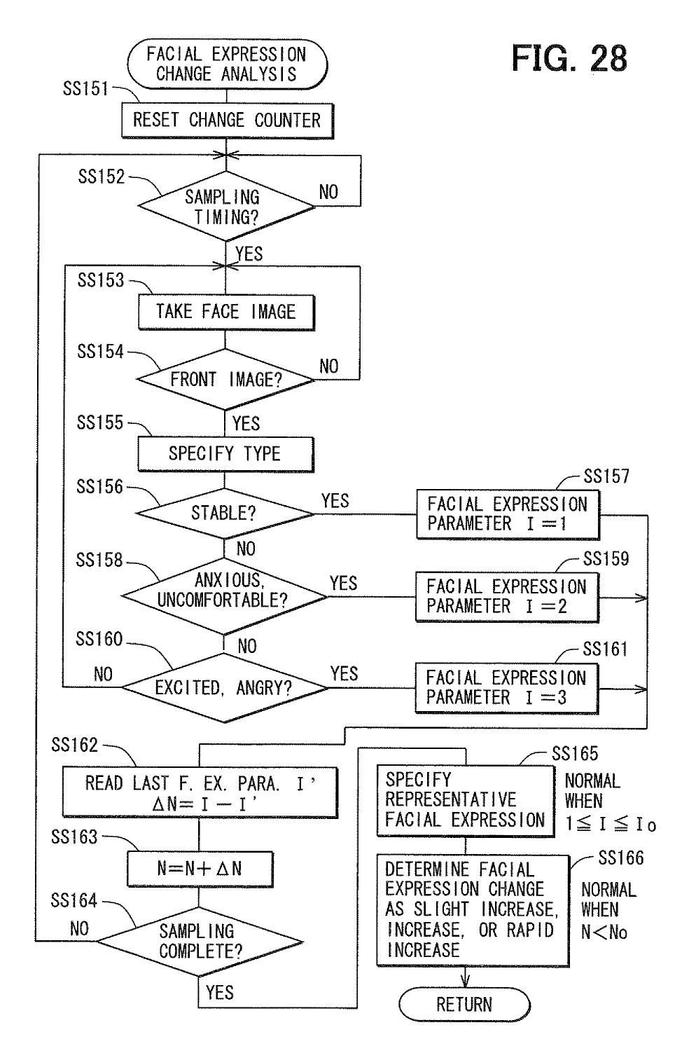

Next, by measuring time changes of a facial expression (which can be taken by the vehicle exterior camera 518) of the user approaching the vehicle and a body temperature (which can be measured by the infrared sensor 519) of the user, the mental or physical condition of the user can be estimated from the time changes, FIG. 28 shows one example of a flowchart of a facial expression change analysis process. At Step SS151, a change counter N is reset. At Step SS152, when a sampling timing comes, the process goes to Step SS153 to take a face image. The face image is taken repeatedly until the front image in which a facial expression can be specified is obtained (Step SS154 to Step SS153). When the front image is obtained, the front image is sequentially compared to master images (contained in biological authentication master data 432 in the storage device 535) to specify a facial expression type (Step SS155). When the specified facial expression type is “stable,” a expression parameter I is set to “1” (Step SS156 to Step SS157). When the specified facial expression type is “anxious and displeasure,” the expression parameter I is set to “2” (Step SS158 to Step SS159), When the specified facial expression type is “excitation and anger,” the expression parameter I is set to “3” (Step SS160 to Step SS161).

At Step SS162, the last obtained facial expression parameter I′ is read to calculate its change value ΔN. At Step SS163, the change value is added to the change counter N. The above process is repeated until a determined sampling period ends (Step SS164 to Step SS152). When the sampling period ends, the process goes to Step SS165. At Step SS165, an average value I of the facial expression parameter I (made to be an integer) is calculated. The mental condition corresponding to the facial expression value can be determined. The greater a value of the change counter N is, the greater the facial expression change is. For example, a threshold is set in a value of N. From a value of N, a change of the facial expression can be determined as “small change,” “increase,” “slight increase,” and “rapid increase.”

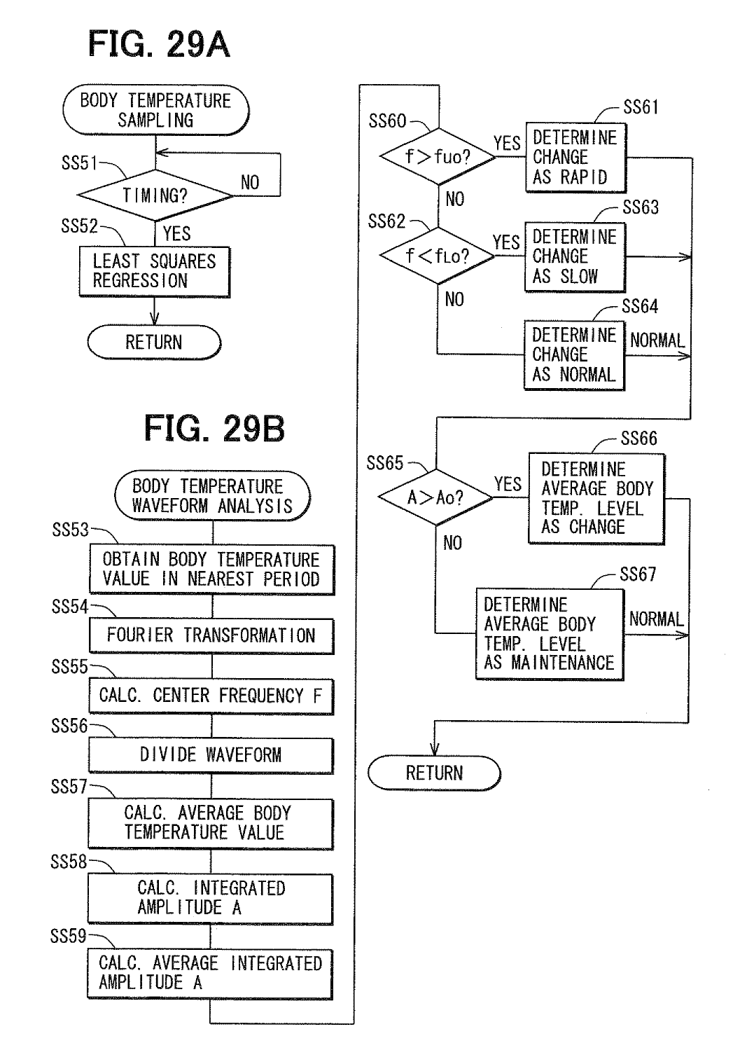

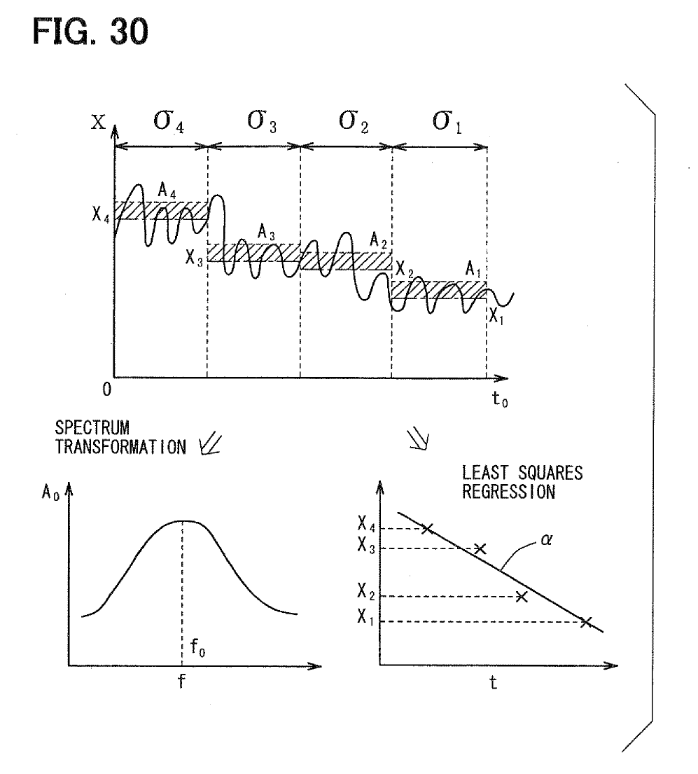

On the other hand, FIGS. 29A, 29B show one example of a flowchart of a body temperature waveform analysis process. In a sampling routine, each time that a sampling timing comes at a predetermined interval, a body temperature detected by the infrared sensor 519 is sampled, and its waveform is recorded. In a waveform analysis routine, waveforms of body temperatures sampled during the nearest predetermined period are obtained at Step SS53. The known fast Fourier transformation is applied to the waveforms at Step SS54 to obtain a frequency spectrum at Step SS54. A center frequency of the spectrum (or peak frequency) f is calculated at Step SS55. At Step SS56, as shown in FIG. 30, the waveform is divided into the predetermined number of sections σ1, σ2, and so on, and at Step SS57, an average value of the body temperature in each section is calculated. In the respective sections, by use of the average values of the body temperatures as waveform center lines, integrated amplitudes A1, A2, and so on (each obtained by integrating an absolute value of the waveform change on the basis of the center line, and dividing the integral value by each section width σ1, σ2, and so on) are calculated. At Step SS59, the integrated amplitudes A in the sections are averaged, and the average is determined as a representative value of the waveform amplitudes.

The information sampling program for obtaining the waveforms, including the following processes, is scheduled to start at predetermined intervals for only the user biological characteristic information obtaining means relating to the specified scene. Not shown in the figures, the sampling is not repeated without limit. After the sampling period defined for obtaining samplings required for the waveform analysis, the repetition ends.

At Step SS60, it is checked whether a frequency f is over an upper limit threshold fu0. When the frequency f is over the upper limit threshold fu0, a change of the monitored body temperature is determined to be “rapid.” At Step SS62) it is checked whether the frequency f is under a lower limit threshold fL0 (>fu0). When the frequency f is under the lower limit threshold fL0 (>fu0), a change of the monitored body temperature is determined to be “slow.” When fu0≧f≧fL0, the process goes to Step SS64. At Step SS64, the monitored body temperature is determined to be “normal.” Next, the process goes to Step SS65. At Step SS65, an integrated amplitude A (average value) is compared to a threshold A0. When A≧A0, the monitored body temperature is determined to “change.” When A≦A0, the monitored body temperature is determined to be “maintained (stable).”

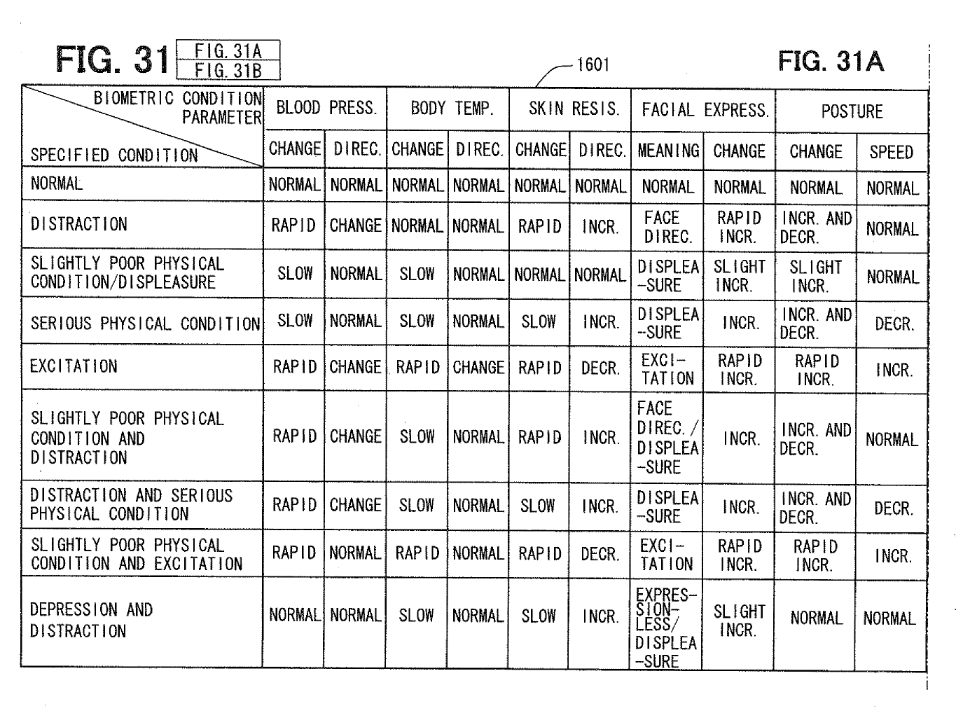

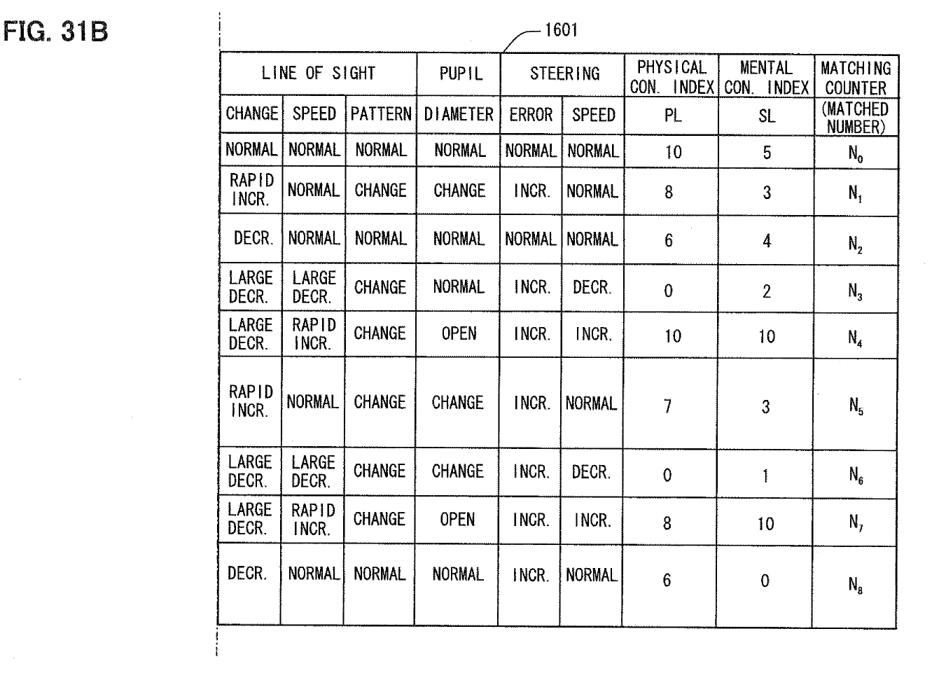

By use of the determination results of time changes of the obtained biological condition parameters, concrete mental or physical condition of the user is determined (estimated) Concretely, a determination table 1601 is stored in the storage device 535. As shown in FIG. 31, in the determination table 1601, each of the multiple specified conditions corresponds to each of combinations of time changes of the biological condition parameters detected by the multiple user biological characteristic information obtaining means, the combination being required to establish each specified condition. In this determination table 1601, values of the physical condition index PL and mental condition index SL corresponding to each physical/mental condition are stored.

In this embodiment, as the specified conditions, “normal,” “distraction,” “poor physical condition,” “excitation,” and “depression” are determined. The “poor physical condition” is divided into multiple levels, “slightly poor physical condition” and “serious physical condition.” The “distraction” and “excitation” can be divided into multiple levels to estimate more detailed mental or physical condition. In this embodiment, in addition to the above basic specified conditions, a combination of time changes of the biological condition parameters is uniquely defined for each of combined conditions of physical and mental conditions. The estimation accuracies of the combined conditions are improved. When the user experiences discomfort due to, e.g., nonconformity of the hospitality operation and a shortage or excess of its level, the user often shows the same biological condition as the slightly poor physical condition. In this embodiment, the “discomfort” and “slightly poor physical condition” are integrated with each other as a specified condition (of course, for example, by changing thresholds of the related parameters, each may be specified separately).

The example of setting the physical condition index PL and mental condition index SL corresponding to each specified condition is shown in the determination table 1601. Each index is defined as a value within a predetermined range having the maximum value (“10” herein) and minimum value (“0” herein). The physical condition index of the maximum value (“10” herein) in the numeral range corresponds to “normal.” As the value of the physical condition index decreases from the maximum value, the physical condition is worsened. On the other hand, a middle value within the numeral range of the mental condition index SL corresponds to “normal” (showing mental “stabilization” or “moderation”: the value is set to “5,” but the value showing “normal” does not always need to be a middle value). The mental condition index SL swinging to the maximum value shows the “uplift or excitation” condition, and the mental condition index SL swinging to the minimum value shows the “depressed” condition.

As the biological condition parameters, “blood pressure,” “body temperature,” “skin resistance,” “facial expression,” “attitude,” “line of sight,” “pupil (scale),” and “steering,” including the parameters used in the subsequent scenes, are used. The sensor or camera more advantageously for obtaining the same target biological condition parameter is selected in accordance with the scene.

As described above, in this approach scene, a facial expression of the user, taken by the vehicle exterior camera 518, and a body temperature of the user, measured by the infrared sensor 519, can be used as the biological condition parameter. In the determination table 1601, in case of distraction, a change of the facial expression increases rapidly, and in case of poor physical condition and excitation, a change of the facial expression tends to increase. These cases can be recognized to be different from a normal condition, but each mental or physical condition is difficult to recognize in detail. In case of distraction, a body temperature does not change widely (almost the same as a normal condition). In case of poor physical condition, a body temperature changes slowly. In case of excitation, a body temperature changes rapidly. Accordingly, by combining these parameters with each other, “distraction,” “poor physical condition,” and “excitation” can be recognized separately.

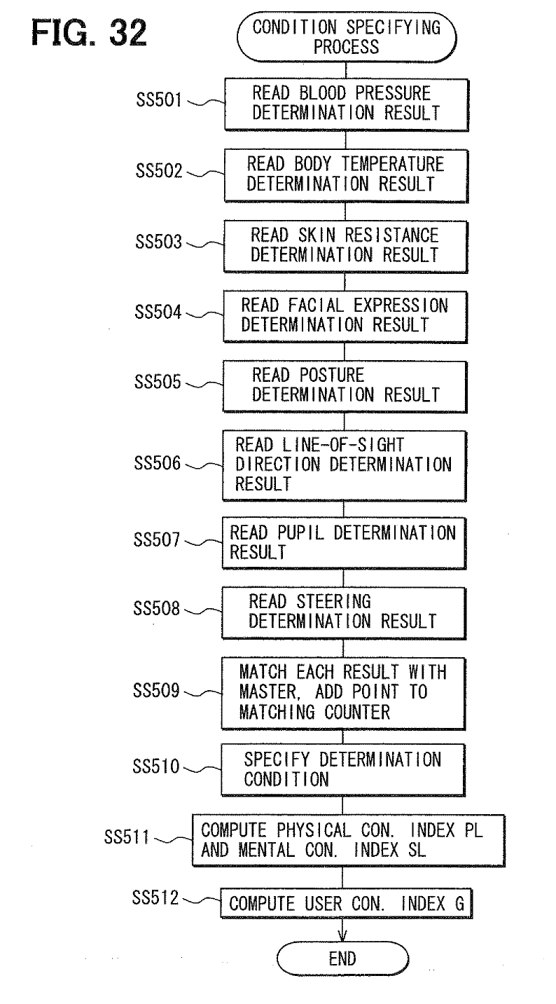

A process in this case are shown in FIG. 32 (this can be determined under the same concept regardless of the scenes, and the same flow is basically executed in the after-mentioned drive/stay scene). Basically, the multiple biological condition parameters (facial expression and body temperature) are matched with matched information on the determination table. The specified condition corresponding to the matched combination is specified as a currently established specified condition. At Step SS501 to Step SS508, determination results (for example, “rapid decrease” and “increase”) of the time changes of the biological condition parameters obtained through the analysis processes shown in the flowcharts of FIGS. 54 to 57, 60 to 62, or 64, 65, are read. At Step SS509, the matched information showing how each biological parameter in the determination table 1601 changes to determine that each specified condition is established, is matched with the above determination results. A matching counter of the specified condition whose matched information matches the determination result is incremented. In this case, for example, only the specified condition whose matched information matches the determination results of all the biological condition parameters, may be used. When many biological condition parameters are referenced, the matched information rarely matches the determination results of all the biological condition parameters. The physical or mental condition of the user cannot be estimated flexibly. Accordingly, a point (N) of the matching counter is used as a “matching degree,” and the specified condition corresponding to the highest point, namely, the highest matching degree, is effectively determined as a current specified condition (Step S5510).

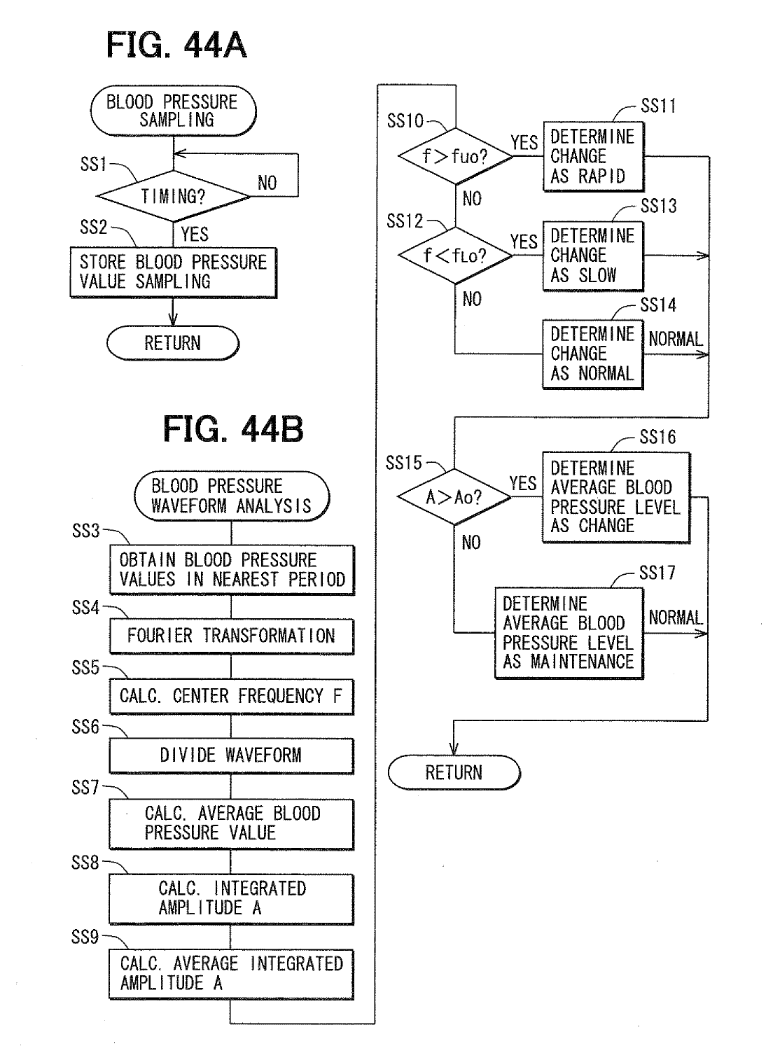

In FIGS. 44A, 44B, like the case where an average blood pressure level is determined to “change,” the same biological condition parameter sometimes contributes to the establishment of the multiple specified conditions (“distraction” or “excitation”) positively. In this case, the matching counter of each specified condition is incremented. For example, the average blood pressure level is determined to “change,” the four matching counter values N1, N4, N5, and N6 are incremented.

As described above, in most cases, it is determined whether the matched information matches the determination results, in comparison with thresholds of the biological condition parameters (such as frequency or amplitude). When the matching is determined in binary (white or black), information about a deviation between an instruction value and threshold of an actual parameter is buried. When the matching is determined in accordance with a value near the threshold, the determination is “gray.” In comparison to the case where the matching is determined in accordance with a value far from the threshold (for example, the value is over the threshold considerably), it is fundamentally preferable that the value near the threshold less contributes to the determination result.

Instead of the addition to the matching counter only when the matched information and determination result match each other completely, when the matched information and determination result do not match each other completely, but the near result is obtained within a predetermined range, this result is added to the matching counter although the addition is limited more largely than that in case of the complete matching. For example, when the matched information is “rapid increase,” and the determination result is “rapid increase,” three points are added. When the matched information is “rapid increase,” and the determination result is “increase,” two points are added. When the matched information is “rapid increase,” and the determination result is “slight increase,” one point is added.

In FIG. 32, by use of the above result, the physical condition indexes and mental condition indexes are calculated (SS511). Concretely, as an average value of the physical condition indexes or mental condition indexes corresponding to the specified conditions shown by the biological condition parameters can be calculated by the formula (a), (b) in the determination table 1601.

[Equation 1]

n: the total number of specified conditions

PLi: physical condition index value corresponding to i-th specified condition

SLi: mental condition index value corresponding to i-th specified condition

Ni: matching counter value corresponding to i-th specified condition

$$\begin{matrix}PL = \frac{{\sum }_{i = 1}^{n} Ni \cdot PLi}{{\sum }_{i = 1}^{p} Ni} & ( a ) \\ SL = \frac{{\sum }_{i = 1}^{a} Ni \cdot SLi}{{\sum }_{i = 1}^{n} Ni} & ( b )\end{matrix}$$

In the above example, contributions of the parameters to the determination of the specified conditions are treated equivalently. The parameters may be distinguished into important ones and unimportant ones, which may be provided with different weights. In this case, a weight factor is Wj provided to each biological condition parameter, and the physical condition index PL and mental condition index SL can be calculated in the below (c), (d).

[Equation 2]

k: the total number of considered biological condition parameters

PLj: physical condition index corresponding to specified condition shown by j-th biological condition parameter

SLj: mental condition index corresponding to specified condition shown by j-th biological condition parameter

Wj: weight factor corresponding to specified condition shown by j-th biological condition parameter

$$\begin{matrix}PL = \frac{{\sum }_{j = 1}^{k} Wj \cdot PLj}{{\sum }_{j = 1}^{p} Wj} & ( c ) \\ SL = \frac{{\sum }_{j = 1}^{k} Wj \cdot SLj}{{\sum }_{j = 1}^{k} Wj} & ( d )\end{matrix}$$

When the weight factors Wj are all one, namely when no weight is provided, the formulae are the below (a′), (b′) (these are the same values as the above formulae (a), (b)).

[Equation 3]

When all Wj are 1 in formulae (c), (d) (no weight).

$$\begin{matrix}PL = \frac{{\sum }_{j = 1}^{k} Ni \cdot PLi}{k} & ( {a}^{′} ) \\ SL = \frac{{\sum }_{j = 1}^{k} Ni \cdot SLj}{k} & ( {b}^{′} )\end{matrix}$$

By use of the physical condition index PL and mental condition index SL determined as described above, the user condition index G is calculated (Step SS512). For example, the physical condition index PL can be equal to the user condition index G, namely, G=SL . . . (e).

When the physical condition index PL and mental condition index SL are both used, the user condition index G can be determined as an average of the physical condition index PL and mental condition index SL, namely, G=(PL+SL)/2 . . . (f) or G=(PL×SL)^{1/2} . . . (g).

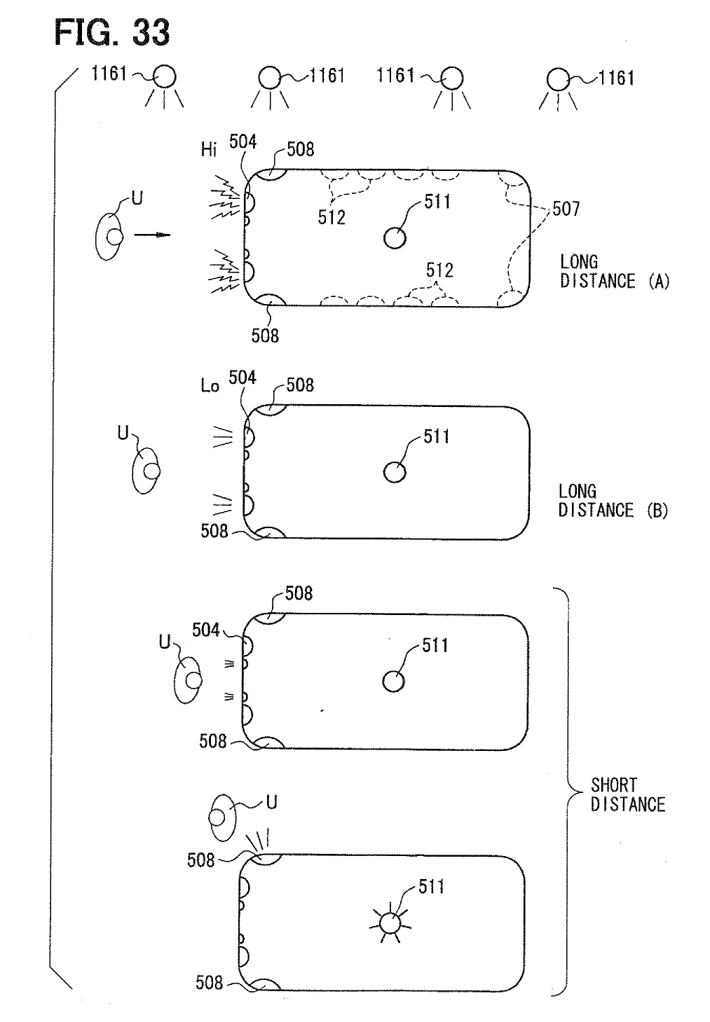

The hospitality control in the approach scene is explained again. For example, when the user approaches from the front as shown in FIG. 33, a front lamp group is selected. As the front lamp group, a headlamp 504, a fog lamp 505, and a cornering lamp 508 can be used. When the user approaches from the rear, a rear lamp group is selected. As the rear lamp group, a tale lamp 507, a backup lamp 509, and a stop lamp 510 can be used in this embodiment. In other cases, the approach is determined to be from the side, a side lamp group is selected. As the side lamp group, a hazard lamp 506, the tale lamp 507, and a under-floor lamp 512 can be used. An exterior light 1161 (light of a building) provided to a peripheral facility such as a building around a parking area of the vehicle also forms the hospitality function for lighting up the vehicle and its periphery.

When a distance between the vehicle and the user is over an uppermost value (for example, 20 m or over), a long distance lighting mode is selected, and when the distance is under 20 m, a short distance lighting mode is selected. As shown in FIGS. 13, 14, in the approach scene (long distance), the hospitality object is to secure the safety approach to the vehicle (to avoid stumble), and the exterior light 1161 is selected as the hospitality function. By use of the first vehicle exterior light (the headlamp 504 in case of the approach from the front, the tale lamp 507 in case of the approach from the rear, and the under-floor lamp 512 in case of the approach from the side), the second vehicle exterior light (the fog lamp 505, the cornering lamp 508, and hazard lamp 506, in case of the approach from the front), and the interior light (interior light) 511, the lighting entertainment is done for receiving the user. The user can understand a direction of the vehicle in accordance with which light is tuned on.

As described above, the first vehicle exterior light, the second vehicle exterior light, and the interior light 511 are state-dependent functions, in which their brightness changes in accordance with a value of ΔG. When the value of ΔG becomes zero, the lighting is turned off. As shown in FIG. 14, all the first and second vehicle exterior lights and interior lights are tuned on when the user condition index is over six, only the first and second exterior lights are turned on when the user condition index is between four and six, only the first vehicle exterior light is turned on when the user condition index is between two and four, and no lighting entertainment is done when the user condition index is under two. As a function for the entertainment, a horn 502 can be also installed.

The headlamp 504 of the first vehicle exterior lights is turned on to produce a high beam when the user condition index G is over a predetermined value (for example, four), and turned on to produce a low beam when the user condition index G is not over the predetermined value. In other words, the brightness viewed from the user changes, but the electric output does not change. On the other hand, the output control of the interior light (brightness control) is done in the LED lighting control circuit of FIG. 4 by use of a duty ratio based on a value of ΔG. The output control of the vehicle exterior lights (under-floor lamp 512) other than ones for securing the front view (headlamp or fog lamp) can be done in the same LED circuit by use of a duty ratio based on a value of ΔG.

In a lighting pattern imaging a destination to which the user travels from now, illumination is done. When the destination is the sea, lighting is effectively executed in the illumination pattern for gradually increasing and then gradually decreasing brightness of a blue light, and thus for imaging waves. Such illumination may be suitably done using the vehicle exterior light 511.

In this case, a color of the illumination can be changed in accordance with a mental condition of the user. In this case, as shown in FIG. 5, when the above mental condition index SL is large (excellent), a color of the light used for the illumination shifts toward shorter wavelengths (bluish and greenish), and when the above mental condition index SL is small (poor), a color of the light used for the illumination shifts toward longer wavelengths (yellowish and reddish). In FIG. 5, numerals 5, 6, and 7 show only values of the mental condition indexes SL corresponding to pale blue, white, and pale orange. When the mental condition index SL is other than these values, an RGB setting value corresponding to the mental condition index SL is determined by compensation by use of RGB setting values of the numerals 5, 6, and 7.

In the approach scene, the speaker (voice output portion) 311 provided to the mobile phone 1 (user terminal device) can be used as the hospitality operation portion, in addition to the above lighting devices. In this case, the communications device 4 of the vehicle detects the approach of the mobile phone 1, namely the user, and makes the speaker 311 output the hospitality voice which differs in accordance with a character type corresponding to the user (namely, the obtained user biological condition information). In this embodiment, the hospitality voice data is the music source data. The hospitality voice data may be data of sound effects and human voices (so-called ring voices). The hospitality voice data may be stored in the storage device 535 of the vehicle as shown in FIG. 1. Only the required data may be sent to the mobile phone 1 via the communications device 4, or may be stored in a flash ROM for sound data in the mobile phone 1. The both cases may be possible simultaneously.

Next, in the approach scene (short distance), as shown in FIGS. 15, 16, the exterior light 1161 and under-floor light 512 continue lighting to prevent the user from stumbling. The vehicle interior light 511 is used for entertainment in the approach scene (short distance). In the approach scene (long distance), the vehicle interior light 511 is used only for the assist of the entertainment. In the approach scene (short distance), to grasp a position of the door (entrance), the standard reference index G0 is set small (“4” herein), and the usage priority of the vehicle interior light 511 is made high.

The music play by the car audio system 515 is emphasized as the sound entertainment, and the car audio system 515 is allocated the standard reference index G0 smaller than that of the mobile phone 1. Further, to add a new entertainment using the olfaction sense, the fragrance generation portion 548 is allocated the standard reference index G0 as the usage target function. The power window 599 is defined as the usage target function and allocated the standard reference index G0 so that the play sound from the car audio system 515 and fragrance (aroma) from the fragrance generation portion 548 reach the user outside the vehicle. Accordingly, when the user index G (difference value ΔG) is large, the music entertainment is done by the car audio system 515 and mobile phone 1. As the user index G (difference value ΔG) is larger, an opening degree of the power window 599 becomes larger. The leakage of the music sound from the car audio system 515 and fragrance from the fragrance generation portion 548 is increased. On the other hand, when the user index G (difference value ΔG) becomes small, the mobile phone 1 is removed from the sound entertainment functions, the opening degree of the power window 599 becomes small, and the leakage of the music sound from the car audio system 515 and fragrance from the fragrance generation portion 548 is decreased.

In the relationship between the music played from the car audio system 515 and estimated mental or physical conditions, a music mainly having low sound range instead of stimulated high sound range is played in case of poor physical condition, or the sound volume is lowered and the tempo is set slow in case of relatively serious physical condition. In case of excitation, a tempo of the music is effectively set slow. In case of distraction, the volume is raised, and the music effective in awaking the mood, such as strong percussion, scream songs, or a dissonance of piano (such as free jazz, hard rock, heavy metal, and avant-garde music) is played effectively. Specifically, in the database of the music source data of FIG. 11, after rough music selection, the music selection is done using the physical condition index PL and mental condition index SL. In the database, the physical condition indexes PL and mental condition indexes SL provided to the songs are provided with different value ranges respectively. The song corresponding to the physical condition index PL and mental condition index SL determined by the above procedure, which are both in the value ranges, is selected, and played.

Next, in the getting-in scene, as shown in FIGS. 17, 18, to prevent the user from colliding with the vehicle, the exterior light 1161 and under-floor light 512 continue lighting. The vehicle interior light 511 is used in the getting-in scene for the entertainment. To grasp the situation inside the vehicle and to assist the operations in the dark, the standard reference index G0 is set smaller than that in the approach scene (short distance) (“2” herein), and the brightness is made greater than that in the approach scene (short distance). The air conditioning, the sound entertainment by the car audio system 515, the entertainment using olfaction by the fragrance generation portion 548 continue. The power window 599 is fully closed just before getting in the vehicle to prevent entry of bad smell and of noise after the user gets in the vehicle. On the other hand, when the approach to the door by the user is detected, the corresponding door opens automatically by the door assist mechanism 541 to assist entry of the user (uniform control target function). Accordingly, the entertainment using olfaction by the fragrance generation portion 548 is recognized by the user when the door opens. When the vehicle exterior camera 518 detects that the user carries large baggage, and that the user is estimated to be in poor physical condition, the user is notified about a position of the luggage room, and the luggage room is opened automatically, to assist the loading of the large baggage.

On the other hand, voice of messages for precautions before traveling are outputted (voice data can be stored in the ROM of the hospitality control section 3, and outputted by use of voice output hardware of the car audio system). The messages for the precautions are as follows, as actual examples.

“Did you carry a license and wallet?”

“Did you carry a passport?” (When a destination set in the car navigation system is an airport.)

“Did you lock the entrance?”

“Did you close the back windows?”

“Did you turn off the air conditioner in the vehicle?”

“Did you turn off the gas?”

Next, the drive/stay scene occupies the main portion of the hospitality process for the user in the vehicle. As shown in FIGS. 19, 20, the most hospitality objects and hospitality functions relate to the drive/stay scene. First, the main hospitality objects and hospitality functions are explained. In “improvement of uncomfortable temperature (maintenance of attention, consideration of physical condition),” the air conditioning (air conditioner 514) is selected as a state-dependent function. Then, a vehicle interior air conditioning temperature and humidity are regulated to make the user feel comfortable.

The control of the vehicle interior light 511 used for securing “comfortable brightness” and “entertainment” is basically the same as in the getting-in scene. Since the user stays in the vehicle, the standard reference index G0 is made large to slightly reduce the brightness. On the other hand, when the user is ready to operate the air conditioner 514, car navigation device 534, or car stereo 515 (detected by a camera for producing an image of the periphery of the panel and by a touch sensor provided to the panel (not shown in FIG. 1)), the vehicle interior light 511 is switched to the uniform control target function to provide lighting of sufficient uniform brightness for the assist of the operations (a spot light near the panel may be used).

The power seat-steering 516 of the tactile sense type interior is such that a position of a steering, an anteroposterior position of a seat, or an angle of a back rest is automatically regulated optimally by a motor in accordance with a condition of the user. For example, when a sense of tension is determined to be released, the back rest is raised and the seat is moved forward, and a position of the steering wheel is raised, so that the driver can concentrate on driving. When the driver is determined to be tired, an angle of the back rest is effectively adjusted slightly so that movement of the driver showing displeasure is stilled. To stimulate the user, the seat vibrator 550 is always operated. The standard reference index G0 of the power seat-steering 516 is set smaller than that of the seat vibrator 550 so that the power seat-steering 516 is operated in priority to the seat vibrator 550.

In the car navigation 534, when a destination is set, a situation of the destination and route is obtained via the radio communications network, and the hospitality operations displayed on the monitor are executed. When the user feels tired or bored, it is effective that the user is guided to a spot for change of pace on a detour route. The hospitality operation for outputting effective videos is properly done in accordance with the mood of the user. As the monitor for outputting the videos, the car navigation device 534 may be used.

The exterior lights such as the headlamp 504 and fog lamp 505 are used as uniform control target functions. When the periphery of the vehicle darkens, the exterior lights are controlled to secure the brightness required for the traveling.

The fragrance generation portion 548 continues operating in the getting-in scene. In accordance with the user condition index G (difference value ΔG0), an amount of the appropriate fragrance is regulated in each case. By opening and closing the power window 599, ventilation and introduction of fragrance from the outside are executed. To awake the user from heavy sleepiness, the ammonia generating portion 549 generates ammonia as needed.

In the sound entertainment, the play by the car stereo (car audio system) 515 continues from the getting-in scene. Since various noises generate in traveling, noise cancellation by the noise canceller 1001B is done. The noise reduction level is properly regulated in accordance with the user condition index G (difference value ΔG0). The level for loading important sounds and conversations is regulated in the same way as above. To prevent noises from entering from the outside, the power window 599 is always fully closed unless ventilation is necessary.

Many concrete examples of the function controls in the drive/stay scene can be considered. For example, as described about the preceding scenes, in accordance with the mental and physical conditions of the driver (user), the music selection is changed, and a setting temperature of the air conditioner and the lighting color or brightness in the vehicle are adjusted. For example, when a sense of tension is determined to be released (distraction), the back rest is raised and the seat is moved forward, and a position of the steering wheel is raised in accordance with the difference value ΔG so that the driver can concentrate on driving. When the driver is determined to be tired, an angle of the back rest is effectively adjusted slightly so that movement of the driver showing displeasure is decreased.

The modes other than the above ones are as follows.

In case of excitation (when the mood of the driver is determined to be excited too much or to feel anger and stress): Still and comfortable music is played to calm the mood of the driver. Then, a light of a color of a shorter wavelength (blue) effective for cool-down is used for the vehicle interior lighting. Additionally, a temperature of the air conditioner is decreased, and slow (longer cycle than that in case of the after-mentioned distraction) rhythm vibration is generated by the seat vibrator 550, to relax the driver. The output of fragrance is increased for mental stability by aromatherapy.

In case of distraction: Strong vibrations is generated by the steering wheel vibrator 551 and seat vibrator 550 impulsively to promote concentration. The ammonia generation portion 549 generates strong smell for awaking. Further, a flashing light and a light of a stimulated wavelength cab be outputted by the vehicle interior lighting to alert the user. It is effective to output a warning sound.

In case of poor physical condition: The safety driving such as speed reduction and the stop and rest are promoted. When approaching a railroad crossing and red signal, caution information is outputted by use of voice. In the worst case, a notification, e.g., for stopping driving, is outputted and displayed on the monitor. The direction generation portion generates a fragrance for relaxing. With respect to sleepiness, the same hospitality operation as in case of the distraction is effective. By reducing an unnecessary light, visibility is improved when the user approaches the vehicle. For example, a reddish lighting output is reduced. On the other hand, it can be effective to execute equalization mainly for low sound of the audio output other than the specified required sounds (alert/important sounds). With respect to the audio setting, not only the control appropriate value of the sound volume level but a control appropriate value of the tone setting can be changed. A preset value of the low sound can be increased relative to a preset value of the high sound. The set temperature of the air conditioning is raised, and a humidifier (not shown in FIG. 1) can be used simultaneously.

In case of depression: A joyful music is played, and a red light is selected to uplift the mood.

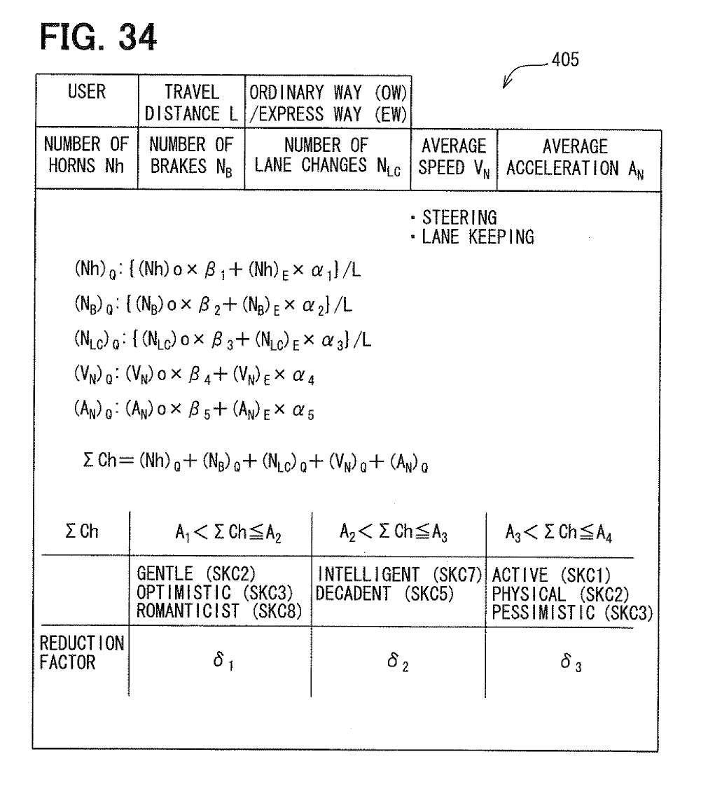

In the drive/stay scene, a character type of the user can be estimated by use of information other than the music selection history of the music sources. For example, driving history data of each user is stored. In accordance with an analysis result of the driving history data, the character type of the user can be specified. The specifying process is explained below. As shown in FIG. 34, the operations which tend to be executed when the user feels stressed in driving are predetermined as stress reflection operations. The corresponding detection portion detects the stress reflection operations. The detection result is stored and accumulated as a stress reflection operation statistics storage portion 405 (FIG. 1: in the storage device 535). In accordance with the result of the stored data, a character type of the user is estimated. The following embodiment is focused on how to restrict the influence of the character elements unfavorable for driving a vehicle.

In this embodiment, as the stress reflection operations, horn operations (when the user blows the horn many times impatiently), the frequency of brakes (when the user brakes many times due to a too short distance to a vehicle in front), and the frequency of lane changing (when the user changes lanes frequently to pass a vehicle in front: the lane changing can be detected from the operation of the turn signal and the steering angle after the operation of the turn signal (an angle of the steering operation is under a predetermined angle, the lane changing is considered to be done)) are selected. A horn switch 502a, brake sensor 530, turn signal switch 502W, and acceleration sensor 532 operate as the stress reflection operation detection portions. Each time each operation is executed, the corresponding counter in a stress reflection operation statistics storage portion 405 is counted up, and the frequency of the operations is recorded. These operations can reflect a tendency toward “dangerous driving.”

A speed of a running vehicle is detected by the vehicle speed sensor 531. The acceleration is detected by the acceleration sensor 532. An average speed V_{N} and average acceleration A_{N} are calculated, and stored in the stress reflection operation statistics storage portion 405. The average acceleration A_{N} is obtained only while the acceleration increases by a predetermined level or over. The duration of the low speed traveling while the acceleration changes small is not used for calculating the average value. Accordingly, a value of the average acceleration A_{N} reflects whether the user likes to depress the accelerator frequently in case of, e.g., passing, or to start suddenly. A traveling distance is calculated from an output integration value of the vehicle speed sensor 531, and stored in the stress reflection operation statistics storage portion 405.

The stress reflection operation statistics is produced for a general way section and an express way section separately (this distinction is possible by referencing the traveling information of the car navigation system 534). In traveling on an express way, when vehicles travel smoothly, a user who drives normally does not blow the horn, depress the brake, and change lanes many times. Therefore, the number of the detections of these stress reflecting operations on the express way is to be weighted greater than that on the general way section. The average speed and average acceleration on the express way section are naturally higher than those on the general way section, so that this influence can be decreased by taking statistics on the express way section and general way section separately as described above.

One example of an algorithm for determining a character by use of the stress reflection operation statistics is shown below. The algorithm is not limited to the following. Values of the number of horns Nh, the number of brakes N_{B}, and the number of lane changes N_{LC} on the ordinary way section (shown by a suffix “O”) are multiplied by a weighting factor α, and the values on the express way section (shown by a suffix “E”) are multiplied by a weighting factor β (α<β: one of the factors may be fixed to 1, the other may be a relative value). Then, the values are added. The added value is divided by a travel distance L as a converted number (shown by a suffix “Q”). The values of the average speeds and average accelerations in the ordinary road section and express way section are weighted by the weighting factors, and added, and calculated as a converted average speed and a converted average acceleration. A value obtained by adding all the values is a character estimation parameter ΣCh. In accordance with the value ΣCh, the character is estimated.

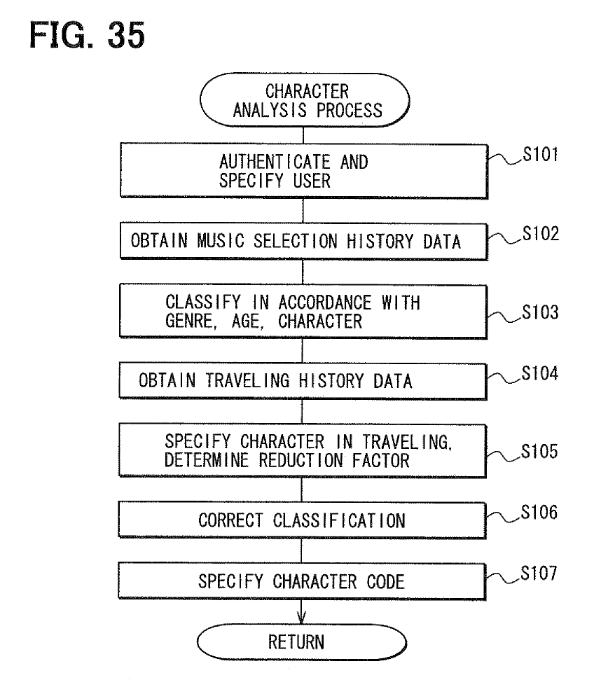

In this embodiment, a range of the value ΣCh is divided into multiple sections by predetermined different boundary values A1, A2, A3, and A4. The character types are assigned to the sections. Contraction factors δ1, δ2, and δ3 (these are over 0 and under 1) are defined corresponding to the section to which the calculated value ΣCh belongs. FIG. 35 shows one example of a flow of a concrete character analysis process using ΣCh. As described above, a user authentication is done at Step S101. At Step S102, music selection history data in the music selection history portion 403 of FIG. 24 is obtained. At Step S103, the statistics information 404 for the music selection history of FIG. 25 is produced. Next, at Step S104, the information (traveling history data) accumulated in the stress reflection operation statistics storage portion 405 of FIG. 34 is read. At Step S105, through the above method, a value ΣCh is calculated. A character type is specified corresponding to the value ΣCh. Then, a contraction factor 6 is obtained. At Step S106, the character type corresponding to most frequently selected songs is specified in the statistics information 404, and multiplied by the contraction factor 6 to contract an apparent frequency. Accordingly, for example, when ΣCh becomes high to show an “active” user, this means that a tendency toward a dangerous driving is increased due to the active character such that ΣCh becomes high. The frequency of selecting the song which promotes the dangerous driving can be restricted by being multiplied by the contraction factor δ. Accordingly, the user can be introduced to safety driving. When ΣCh becomes low to show a “gentle” user, a frequency of selecting song corresponding to “gentle” is multiplied by the contraction factor 6, and thus restricted. A frequency of selecting active songs increases relatively. Accordingly, the user can receive moderate stimulation and drive smart, enhancing safety.

Next, when the user is driving, the mental and physical condition further needs to be considered, in addition to the character. When a user (driver) is seated on the driver's seat, more sensors and cameras can be used as the user biological characteristic information obtaining means for obtaining the biological condition parameters. Specifically, the infrared sensor 519, seating sensor 520, face camera 521, microphone 522, pressure sensor 523, blood pressure 524, body temperature sensor 525, iris camera 527, and skin resistance sensor 545 of FIG. 1 can be used. The user biological characteristic information obtaining means can grasp vital reaction of the user who is driving, variously. The hospitality determination section 2 estimates mental and physical conditions of the user from the time change information of the biological condition parameters detected by the user biological characteristic information obtaining means, and executes the hospitality operation matching the condition, as described in detail in the embodiment of the approach scene.

As well as described above, information about a facial expression can be obtained from a still image of the face taken by the face camera 521. By comparing the image of the whole face (or part of the face: for example, eyes or the mouth) to master images of various mental or physical conditions, whether the user is angry, calm, good humored (for example, exhilarated), bad humored (for example, depressed or sad), or anxious or tensioned, can be estimated. Instead of using a master image unique to a user, positions and shapes of a face, eyes (irises), mouth, and nose are extracted as a facial feature amount common to all users. The feature amount is compared to standard feature amounts previously measured and stored in case of various mental and physical conditions, so that the same determination as above can be made. Types of faces are classified by characters by use of the face feature amounts, and matched with the character types, so that a character type of the user can be specified.

In accordance with information about motions of the body, such as a moving image of the user taken by the face camera 521 (for example, wiggling motion or contorted face), and about the conditions detected by the pressure sensor 523 (for example, the user releases his or her hand from the steering wheel frequently), whether the user who is driving is bad humored, can de determined.

The body temperature can be detected and specified by the body temperature detection portions such as the body temperature sensor 525 mounted to the steering wheel and a thermography of the face obtained by the infrared sensor 519. By use of the same algorithm as shown in FIGS. 29A, 29B, a speed of the body temperature changing and a change or maintenance of the average body temperature level can be determined. A normal body temperature of the user is registered in advance. The body temperature detection portions measure the temperature shift from the normal body temperature (particularly to a higher temperature), so that a slighter body temperature change, a slighter emotional swing due to the change, and so on can be detected.

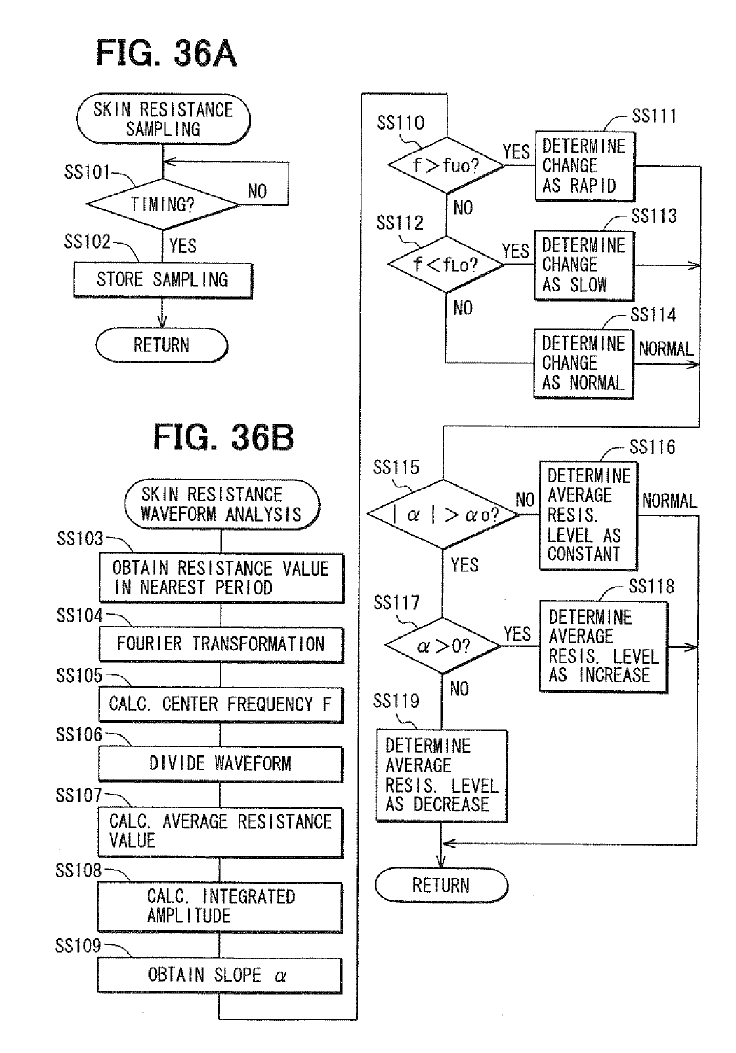

FIGS. 36A, 36B show one example of a flowchart of a skin resistance change waveform analysis process. In the sampling routine, each time a sampling timing determined at a predetermined interval comes, a skin resistance value detected by the skin resistance sensor 545 is sampled, and its waveform is recorded. In the waveform analysis routine, the skin resistance value sampled during the nearest predetermined interval is obtained as a waveform at Step SS103, a known fast Fourier transformation process is applied to the waveform at Step SS104 to obtain a frequency spectrum, and a center frequency (or peak frequency) f of the spectrum is calculated at Step SS105. At Step SS106, as shown in FIG. 30, the waveform is divided into the predetermined number of sections σ1, σ2, and so on, and an average skin resistance value is calculated at Step SS107. In each section, by use of the average skin resistance value as a waveform center line, the integrated amplitudes A1, A2, and so on are calculated. At Step SS109, the integrated amplitude A in each section is plotted to a time t, and by use of least-square regression, an inclination α is obtained.

At Step SS110, it is checked whether a frequency f is over an upper limit threshold fu0, and when the frequency f is over the upper limit threshold fu0, a skin resistance change being monitored is determined to be “rapid.” At Step SS112, it is checked whether the frequency f is under an lower limit threshold fL0 (>fu0), and when the frequency f is under the lower limit threshold fL0, the skin resistance change being monitored is determined to be “slow.” When fu0≧f≧fL0, the process goes to Step SS114, and the skin resistance change being monitored is determined to be “normal.” Next, at Step SS115, an absolute value of the inclination α is compared to a threshold α0. When |α|≦α0, a skin resistance level being monitored is determined to be “constant.” When |α|≧α0, and a sign of u is plus, the skin resistance level being monitored is determined to “increase.” When |α|>α0, and a sign of α is minus, the skin resistance level being monitored is determined to “decrease.”

As shown in FIG. 31, when a change of the skin resistance detection value is rapid and the change is in the “increasing” direction, the mental condition can be estimated to be in “distraction.” With respect to the poor physical condition, a slightly poor physical condition is not so reflected by a time change of the skin resistance. When the poor physical condition progresses, a change of the skin resistance value increases slowly, so that the change is effective to estimate a “serious poor physical condition.” When the skin resistance value decreases fast, the condition can be estimated to be in “excitation (anger)” quite accurately.

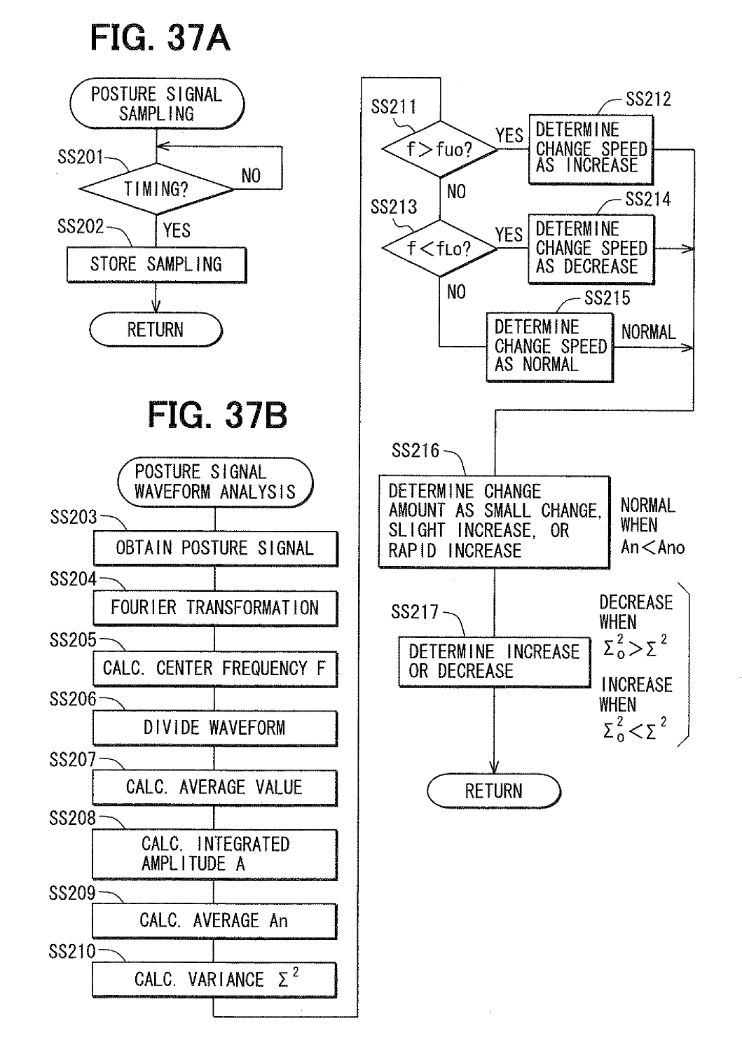

Next, FIGS. 37A, 37B show one example of a flowchart of an attitude signal waveform analysis process. In the sampling routine, at each sampling timing determined at a predetermined interval, the attitude signal value (Vout) explained in FIG. 9 is sampled, and its waveform is recorded (Step SS201, Step SS202). In the waveform analysis routine, the attitude signal value sampled during the nearest predetermined interval at Step SS203 is obtained as a waveform. At Step SS204, the known fast Fourier transformation process is applied to the waveform to obtain a frequency spectrum. At Step SS205, a center frequency (or a peak frequency) f is calculated. At Step SS206, as shown in FIG. 30, the waveform is divided into the predetermined number of sections σ1, σ2, and so on. At Step SS207, an average attitude signal value in each section is calculated. In each section, by use of the average attitude signal value as a waveform center line, integrated amplitudes A1, A2, and so on are calculated. At Step SS209, the integrated amplitudes A in the sections are averaged, and determined as a representative value of a waveform amplitude. At Step SS210, a variance Σ² of the integrated amplitudes A is calculated.

At Step SS211, it is checked whether a frequency f is over an upper limit threshold fu0. When the frequency f is over the upper limit threshold fu0, an attitude change speed being monitored is determined to be “increase.” At Step SS213, it is checked whether the frequency f is under a lower limit threshold fL0 (>fu0). When the frequency f is under the lower limit threshold fL0, the attitude change speed being monitored is determined to be “decrease.” When fu0≧f≧fL0, the process goes to Step SS215, and the attitude change speed being monitored is determined to be “normal.” Next, at Step SS216, an average value An of the integrated amplitudes A is compared to a predetermined threshold, and an attitude change amount is determined to be one of “small change,” “slight increase,” or “rapid increase” (as the average value An is greater, the attitude transition amount tends to increase further). At Step SS217, when a value of a variance Σ² of A is over the threshold, the attitude change tends to increase or decrease.

Because the change of the attitude shows a quite different tendency in accordance with a change of the basic specified conditions (“poor physical condition,” “distraction,” and “excitation”), the change is a particularly effective parameter to distinguish the basic specified conditions. In the normal condition, a user who is driving maintains an appropriate attitude and a sense of tension required for driving. When the poor physical condition occurs, the user sometimes changes the attitude obviously to soften the pain. Then, the attitude change amount tends to increase slightly. When the poor physical condition progresses further (or the user feels sleepy extremely), the attitude becomes unstable to shake, and the attitude change tends to increase and decrease. Since the attitude change at this time is uncontrollable and unstable, a speed of the attitude change decreases considerably. In case of the distraction, the attitude change increases and decreases loosely, but the body can be controlled, so that a difference is seen in that the attitude change speed does not decrease considerably. In case of the excitation, the user becomes restless and nervous, so that the attitude change increases rapidly, and the change speed becomes high.

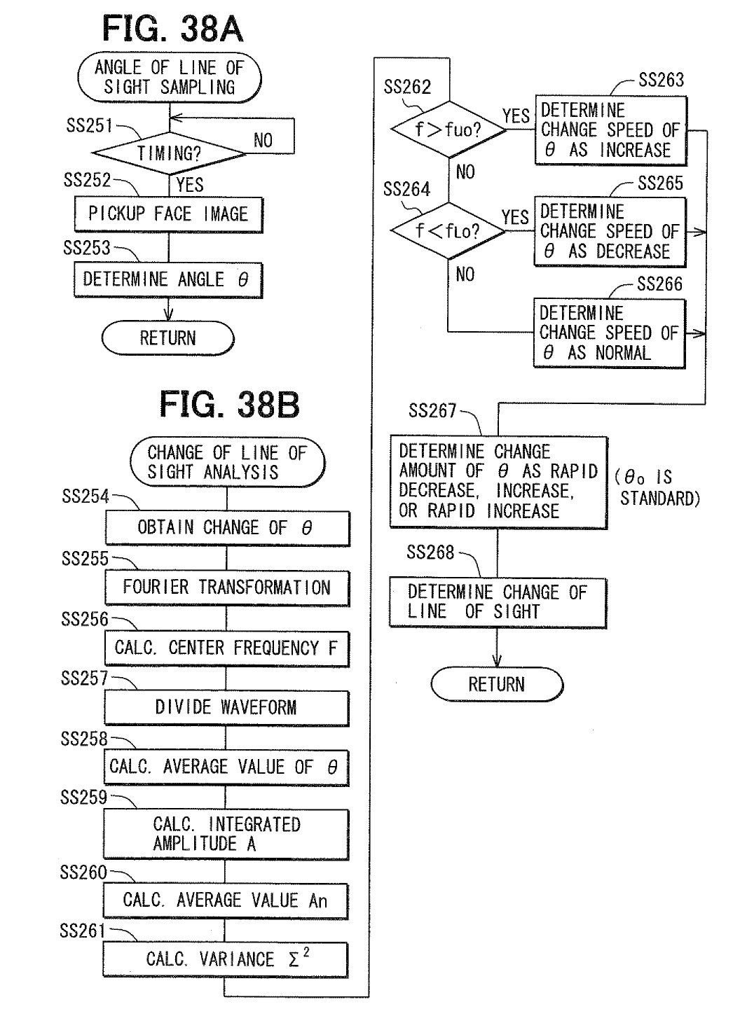

FIGS. 38A, 38B show one example of a flowchart of a process for analyzing a waveform of an angle of a line of sight. In the sampling routine, at each sampling time determined at a predetermined interval, a face image is taken, positions of a pupil and center of the face are specified at Step SS252, and a difference from a front direction of the pupil relative to the center position of the face is calculated in Step SS253, so that an angle θ of the line of sight can be obtained. In the waveform analysis routine, a line-of-sight angle value sampled during the nearest predetermined interval is obtained as a waveform at Step SS254, the known fast Fourier transformation process is applied to the waveform to obtain a frequency spectrum at Step SS255, and a center frequency (or peak frequency) f of the spectrum is calculated at Step SS256. At Step SS257, as shown in FIG. 30, the waveform is divided into the predetermined number of sections σ1, σ2, and so on. At Step SS258, an average line-of-sight angle value in each section is calculated. At Step SS259, by use of the average line-of-sight angle value as a waveform center line, integrated amplitudes A1, A2, and so on are calculated in each section. At Step SS260, the integrated amplitudes A in the sections are averaged, and determined as a representative value An of the waveform amplitudes. At Step SS261, a variance 2 of the integrated amplitudes A is calculated.

At Step SS262, it is checked whether the frequency f is over an upper limit threshold fu0. When the frequency f is over the upper limit threshold fu0, a change speed of a line-of-sight angle θ being monitored is determined to be “increase.” At Step SS264, it is checked whether the frequency f is under a lower limit threshold fL0 (>fu0). When the frequency f is under the lower limit threshold fL0, a change speed of the line-of-sight angle θ being monitored is determined to be “decrease.” When fu0≧f≧fL0, the process goes to Step SS266, and a change speed of the line-of-sight angle θ being monitored is determined to be “normal.” Next, at Step SS267, the average value An of the integrated amplitudes A is compared to a predetermined threshold, and a change amount of the line-of-sight angle θ is determined to be one of “small change,” “slight increase,” and “fast increase” (as the average value An is greater, the change amount of the line-of-sight angle θ tends to increase). At Step SS268, when a variance Σ² of A is a threshold or over, a change of the line-of-sight angle θ tends to increase and decrease, namely, the line-of-sight is determined to be in “changing” condition (namely, the eyes rove).

In case of the distraction, a change amount of the line-of-sight angle θ increases rapidly and the eyes rove. Accordingly, the change amount is an important determining factor to estimate the distraction. In case of the poor physical condition, the line-of-sight change amount decreases in accordance with a degree of the poor physical condition. Accordingly, the change amount is an important determining factor to estimate the poor physical condition. The line-of-sight change amount decreases in case of the excitation. In case of the poor physical condition, when a change occurs in a visual range, it is difficult for the line-of-sight to follow the change, and the line-of-sight change speed decreases. In case of the excitation, the line-of-sight sharply responds to, and stares at, e.g., a change in a visual range, namely, a speed of the line-of-sight change which sometimes occurs is very high. The poor physical condition and excitation can be distinguished.

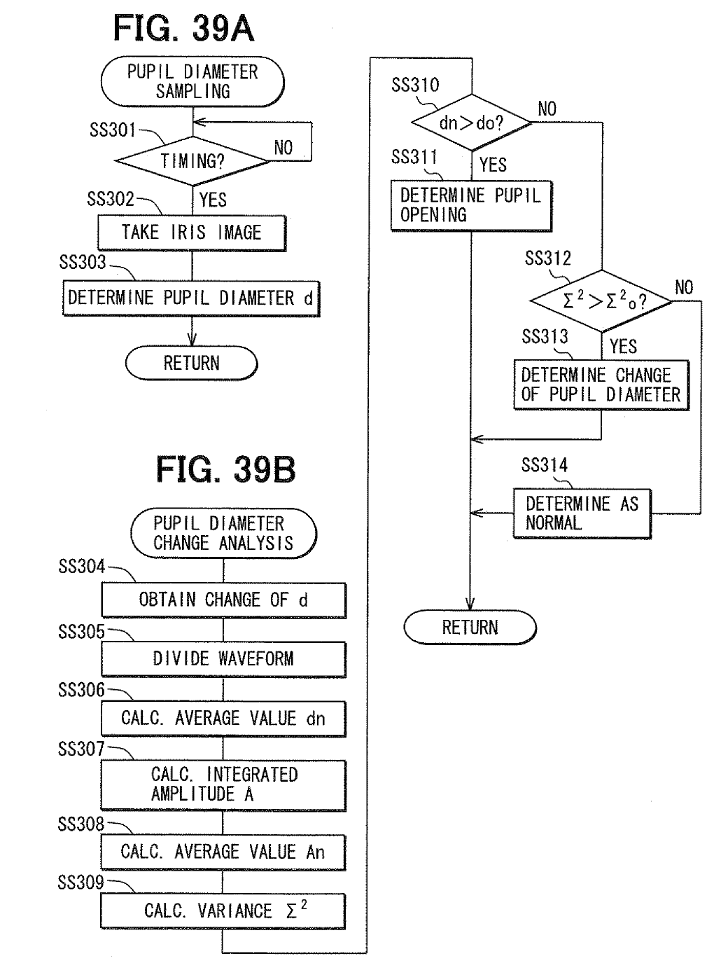

FIGS. 39A, 39B show one example of a flowchart of a pupil diameter change analysis process. In the sampling routine, at each sampling timing determined at a predetermined interval, an iris of a user is taken by the iris camera 527 (FIG. 1), and a pupil diameter d is determined on the image at Step SS303. In the analysis routine, the pupil diameter d sampled during the nearest predetermined interval is obtained as a waveform at Step SS304. At Step SS305, as shown in FIG. 30, the waveform is divided into the predetermined number of sections σ1, σ2, and so on. At Step SS306, an average pupil diameter value dn in each section is calculated. At Step SS307, in each section, by use of the average pupil diameter value as a waveform center line, integrated amplitude A1, A2, and so on are calculated. At Step SS308, an average value An of the integrated amplitudes in the sections is calculated. At Step SS309, a variance Σ² of the integrated amplitudes A is calculated.

At Step SS310, it is checked whether the average pupil diameter value dn is over a threshold d0. When the average pupil diameter value dn is over the threshold d0, the process goes to Step SS311 to determine that “the pupil opens.” When the average pupil diameter value dn is not over the threshold d0, the process goes to Step SS312 to check whether the variance Σ² of the integrated amplitudes A is over a threshold Σ²0. When the variance Σ² of the integrated amplitudes A is over the threshold Σ²0, it is determined that “a diameter of the pupil changes.” When the variance Σ² of the integrated amplitudes A is not over the threshold Σ²0, the pupil is determined to be “normal.”

As shown in FIG. 31, the pupil diameter d changes in accordance with the mental condition of the user. Particularly, in accordance with whether the pupil is in a specific condition, it can be estimated whether the user is in excitation, accurately. When the pupil diameter changes, the user can be estimated to be in distraction.

In the present invention, a steering condition of a driver is also used as a biological condition parameter for estimating a mental or physical condition of the driver. The steering is sampled and evaluated only in straight traveling. When a steering angle can be estimated to be naturally greater, e.g., in case of turning right or left or changing lanes, it is preferable that the steering is not monitored and evaluated (the steering by the driver in normal can be determined to be unstable). For example, when the turn signal is lighted, during the turn signal lighting period and a predetermined period before and after the anticipated steering (for example, about five seconds before the lighting and about ten seconds after the lighting), the steering may not be evaluated.

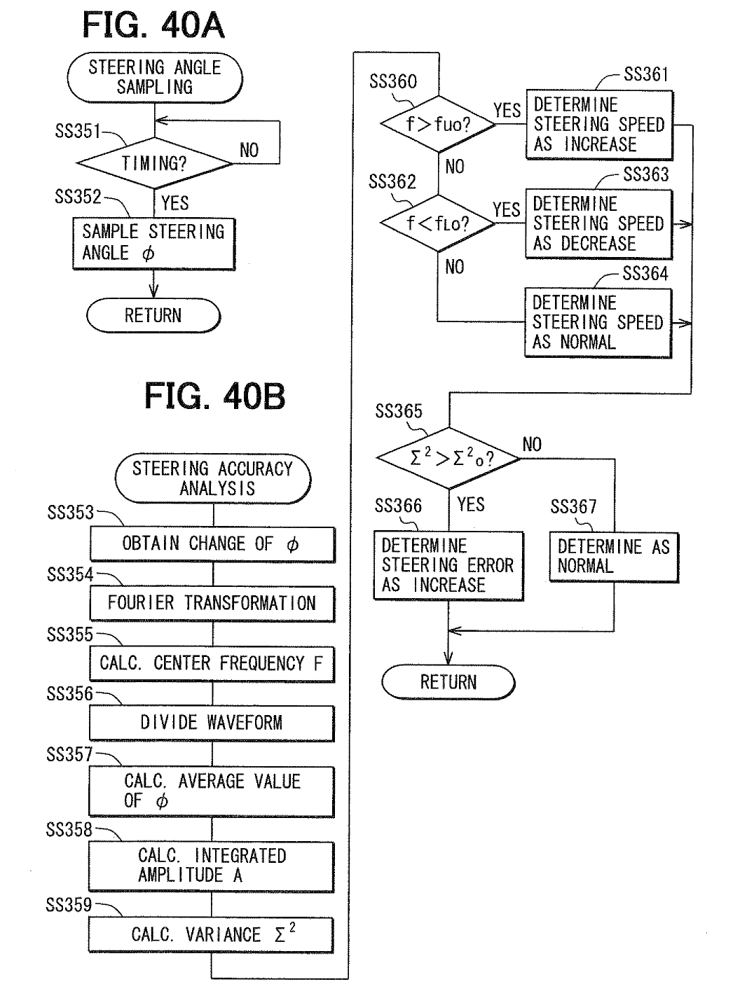

FIGS. 40A, 40B show one example of a flowchart of a steering angle waveform analysis process. In the sampling routine, at each regular sampling timing determined at a predetermined interval, at Step SS352, a current steering angle θ is read (for example, θ=0 degree in the straight neutral condition, defined as a deflection angle to the right or left (for example, the angle in the right direction is positive, and the angle in the left direction is negative)). In a steering accuracy analysis routine, a steering angle value sampled during the nearest regular period is obtained as a waveform at Step SS353, the known fast Fourier transformation process is applied to the waveform to obtain a frequency spectrum at Step SS354, and a center frequency f of the spectrum (or peak frequency) is calculated at Step SS355. At Step SS356, as shown in FIG. 30, the waveform is divided into the predetermined number of sections σ1, σ2, and so on. At Step SS357, an average steering angle value in each section is calculated. At Step SS358, in each section, by use of the average steering angle value as a waveform center line, integrated amplitudes A1, A2, and so on are calculated. At Step SS359, a variance Σ² of the integrated amplitudes A is calculated.

At Step SS360, it is checked whether the frequency f is over an upper limit threshold fu0. When the frequency f is over the upper limit threshold fu0, the process goes to Step SS361 to determine that a changing speed of the steering angle θ being monitored “increases.” At Step SS362, it is checked whether the frequency f is under a lower limit threshold fL0 (>fu0). When the frequency f is under the lower limit threshold fL0, a changing speed of the steering angle θ being monitored is determined to “decrease.” When fu0≧f≧fL0, the process goes to Step SS364 to determine that the steering angle θ being monitored is “normal.” Next, at Step SS365, the variance Σ² of the integrated amplitudes A of the changing waveform of the steering angle θ is over a threshold Σ²0, When the variance Σ² is over the threshold Σ²0, a steering error is determined to “increase” (Step SS366). When the variance Σ² is not over the threshold Σ²0, the steering error is determined to be “normal” (Step SS367).

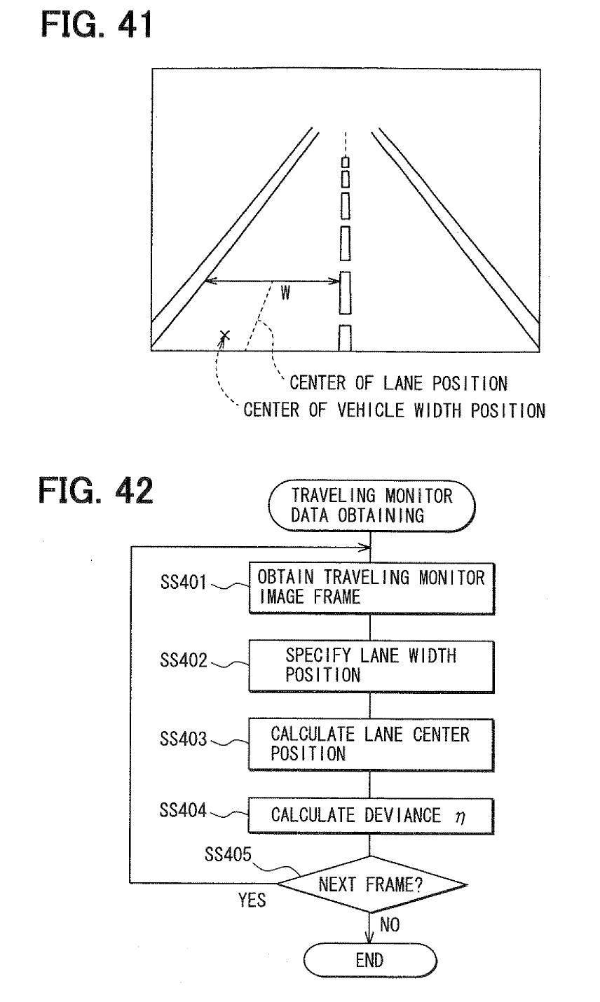

The steering error can be detected from a monitoring image of a traveling monitor camera 546 of FIG. 1, as well as from the above steering angle. The traveling monitor camera 546 can be mounted to the front center (for example, the center of a front grill) of the vehicle, and takes a front visual range in the traveling direction, as shown in FIG. 41. When the mounting position of the camera relative to the vehicle is determined, a vehicle width center position (vehicle standard position) is determined in the traveling direction on the taking visual range. For example, by distinguishing a road shoulder line, a center line, or a lane separating line on the image, the center position of the lane where the user is in traveling can be specified on the image. When an offset of the vehicle width center position from the lane center position is found, whether the vehicle driven by the user keeps the center of the lane can be monitored. FIG. 42 is a flowchart showing an example of a flow of the process. At Step SS401, a frame of the travel monitoring image is obtained. At Step SS402, lane side edge lines of the road shoulder line and the white line (or an orange line of the no-passing zone) showing a center line or lane separating line are extracted by a known image processing, and specified as lane width positions. At Step SS403, a position dividing a distance between the edge lines into two is used as a lane center position to execute the calculation. On the other hand, at Step SS404, the vehicle width center position is plotted on the image frame, and an offset amount η from the lane center position in the road width direction is calculated. This process is repeated for image frames loaded at predetermined intervals, and the offset amounts η are recorded as a time change waveform (Step SS405 to Step SS401).

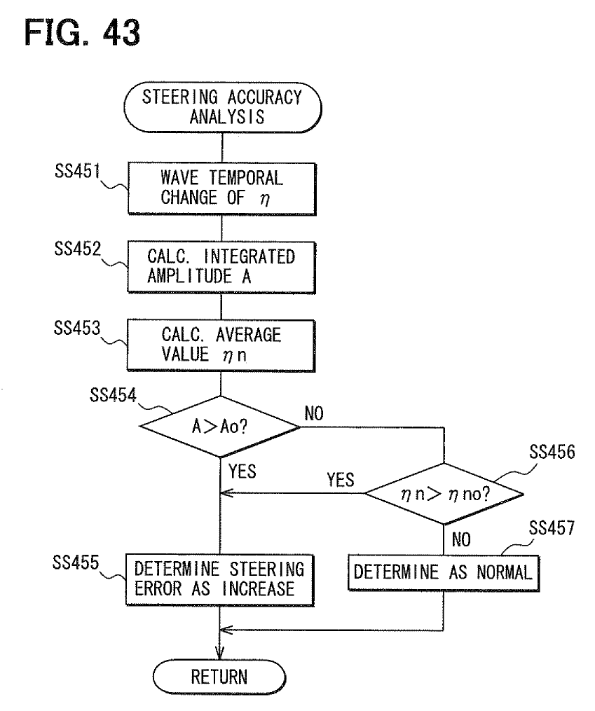

The steering accuracy analysis process in this case can be executed along a flow shown in FIG. 43, for example. At Step SS451, an integrated amplitude A relative to a center line of a waveform during the nearest predetermined period is calculated. At Step SS453, an average valueηn of an offset amount q from the lane center position is calculated. At Step SS454, the integrated amplitude A is compared to a predetermined threshold A0. When the integrated amplitude A is over the predetermined threshold A0, the process goes to Step SS455 to determine that the steering error “increases.” When the integrated amplitude A is over the predetermined threshold A0, an offset amount η oscillates relative to time considerably, showing a tendency of a kind of unstable traveling. When a tendency to move toward the corner continues because the vehicle cannot keep traveling on the lane center, the offset amount η becomes great. The tendency is to be determined as abnormal even when the integrated amplitude A is under the threshold A0. Therefore, in this case, the process goes to Step SS456. When the average value ηn of the offset amounts is over the threshold ηη0, the process goes to Step SS455 to determine that the steering error “increases.” On the other hand, When the average value ηn of the offset amounts is under the threshold ηn0, the process goes to Step SS457 to determine that the steering error is “normal.”

With respect to the steering speed (response to the steering), the known fast Fourier transformation process is applied to the waveform to obtain a frequency spectrum. A center frequency (or peak frequency) f of the spectrum is calculated. From f, a tendency of the steering speed can be determined. In this case, it is checked whether the frequency f is over an upper limit threshold fu0. When the frequency f is over the upper limit threshold fu0, the steering speed is determined to “increase.” At Step SS362, it is checked whether the frequency f is under a lower limit threshold fL0 (>fu0). When the frequency f is under the lower limit threshold fL0, the steering speed is determined to “decrease,” When fu0≧f≧fL0, the steering speed is determined to be “normal.”

As shown in FIG. 30, by detecting the increase of the steering error, the driver can be estimated to be in the distraction or excitation. On the other hand, in case of the serious physical condition (including drowsiness), normal steering is prevented. Accordingly, from a tendency of the increase of the error, the condition can be estimated. On the other hand, the response to the steering tends to be delayed in case of the poor physical condition or distraction. From the decrease of the steering speed, the poor physical condition or distraction can be estimated. In the excitation the driver tends to turn the steering wheel from impatience. Accordingly, from the increase of the steering speed, the excitation can be estimated.

In the drive/stay scene, the process for specifying the specified condition along a flow of FIG. 32 is executed. In this case, many biological condition parameters are referenced. The points of the matching counter are considered as a “matching degree.” The condition having the highest points, namely, the highest matching degree, is effectively determined as the specified condition. As described above, the addition to the matching counter can be executed such that, when the approximate result can be obtained within a determined range although the specified information and the determination result are not matched with each other completely, the result can be added to the matching counter while the addition is limited to lower points than that in case of the perfect matching.

On the other hand, FIGS. 44A, 44B show one example of a flowchart of a blood pressure waveform analysis process. In a sampling routine, each time that a sampling timing comes at a predetermined interval, a blood pressure detected by the blood pressure sensor 524 is sampled, and its waveform is recorded. In a waveform analysis routine, waveforms of blood pressures sampled during the nearest predetermined period are obtained at Step SS3. The known fast Fourier transformation is applied to the waveforms at Step SS4 to obtain a frequency spectrum. A center frequency of the spectrum (or peak frequency) f is calculated at Step SS5. At Step SS6, as shown in FIG. 30, the waveform is divided into the predetermined number of sections σ1, σ2, and so on, and at Step SS7, an average value of the blood pressure in each section is calculated. In the respective sections, by use of the average values of the blood pressures as waveform center lines, integrated amplitudes A1, A2, and so on are calculated.

At Step SS10, it is checked whether the frequency f is over the uppermost threshold fu0. When the frequency f is over the uppermost threshold fu0, the blood pressure change under monitoring is determined to be “rapid.” At Step SS12, it is checked whether the frequency f is under the lowermost threshold fL0 (>fu0). When the frequency f is under the lowermost threshold fL0, the blood pressure change under monitoring is determined to be “slow.” When the frequency f is fu0≧f≧fL0, the process goes to Step SS14, in which the blood pressure change under monitoring is determined to be “normal.” Next, the process goes to Step SS15, in which the amplitude A is compared to the threshold A0. In case of A≦A0 the average blood pressure level under monitoring is determined to be “constant.” The average blood pressure level under monitoring is determined to be “change.”

As shown in FIG. 31, when the change of the blood pressure detection value is rapid and the direction of the change is “change,” the mental condition is estimated to be “distraction,” In case of the poor physical condition, the change of the blood pressure is slow. When the blood pressure changes rapidly, the mental condition is estimated to be “excitation (anger).”

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

Aspects of the subject matter described herein are set out in the following clauses.

As an aspect, a vehicular user hospitality system is provided to comprise: hospitality operation portions for executing a hospitality operation to assist use of a vehicle by a user or to entertain the user in each of a plurality of scenes, into which a series of motions of the user using the vehicle when the user approaches, gets on, drives or stays in, and gets off the vehicle are divided; a hospitality determination section including (i) a scene estimation information obtaining means for obtaining a position or a motion of the user as scene estimation information, the position and the motion being predetermined in each of the scenes, (ii) a scene specifying means for specifying each of the scenes in accordance with the obtained scene estimation information, and (iii) a hospitality content determining means for determining a hospitality operation portion to be used and a content of a hospitality operation by the hospitality operation portion to be used in accordance with the specified scene; and a hospitality control section (3) for executing the hospitality operation in accordance with the content determined by the hospitality determination section by controlling an operation of the corresponding hospitality operation portion. Here, the hospitality determination section further includes (i) a function extraction matrix storage portion for storing a function extraction matrix having a two-dimensional array formed by type items of hospitality objects prepared for each of the scenes and function items of the hospitality operation portions, the function extraction matrix including standard reference information referenced as a standard to recognize whether a function corresponding to each matrix cell matches the hospitality object corresponding to the each matrix cell when an operation of the function is controlled, (ii) a function extracting means for extracting a function matching the hospitality object for the specified scene, and reading the standard reference information corresponding to the extracted function, (iii) a user biological characteristic information obtaining means for obtaining at least one of a physical condition and a mental condition of the user, and (iv) an operation content determining means for determining an operation content of a corresponding function in accordance with the obtained user biological characteristic information and the obtained standard reference information.

In the above configuration, a scene defined by a relationship between a user and a vehicle is grasped as a condition of the user. Specifically, the series of the motions of the user using the vehicle when the user approaches, gets on, drives or stays in, and gets off the vehicle are divided into the predetermined scenes. A hospitality operation is executed to assist the use of the vehicle by the user or to entertain the user in the respective scenes.

The scene can be specified, so that the hospitality object unique to the scene can be obtained. Accordingly, the hospitality function desired by the user can be specified properly from the hospitality object.

Further, an operation content of the hospitality operation portion changes in accordance with a content of the user biological characteristic information. Additionally, a service (hospitality) for the user in using the vehicle can be further optimized in accordance with a mental or physical condition of the user. Specifically, standard reference information when a function specified from a function extraction matrix is controlled is extracted. The physical or mental condition reflected by the separately obtained user biological characteristic information is added to this standard reference information, so that the operation content of the selected function can be optimized.

As a result, in each of the various scenes relating to the use of the vehicle by the user, the hospitality operation executed on the vehicle changes, and the function matching the hospitality object estimated in each scene can be operated timely and at a level or content optimized in accordance with the physical or mental condition of the user, and thus proper, fine services can be provided.

The scenes are determined with respect to “the use of a vehicle by a user.” The basic flow in which the user approaches, gets on, and drives or stays in the vehicle, and opens the door and gets off the vehicle is not changed. Therefore, it is important to divide the flow into the scenes for providing natural hospitality to the user. In this case, the following structure may be used. Namely, a current scene specifying information storing means is provided for storing current scene information which specifies a current scene. The scene specifying means grasps a current scene in accordance with a storage content of the current scene specifying information. On the premise that the current scene is gasped, when the predetermined scene estimation information obtaining means detects a position or motion of the user unique to the following scene, the scene specifying unit determines that the current scene has shifted to the following scene, and makes the current scene specifying information storage means store the specifying information about the following scene as the current scene specifying information. When the current scene can be grasped, the next scene can be estimated from the motions of the user using the vehicle. By detecting a position or motion of the user unique to the following scene, the shift between the scenes can be grasped accurately. For instance, the door is opened and closed when the user gets on the vehicle and also when the user gets off the vehicle. It is therefore easily understandable that the same following scene specifying information (the scene of opening and closing the door) corresponds to the multiple scenes. Even in such a case, by grasping the current scene, an error can be avoided when the following scene is grasped. Accordingly, hospitality operations can be switched accurately.

The scene specifying means can specify the approach scene when the user approaches the vehicle and the drive-stay scene when the user drives or stays in the vehicle. The hospitality content determining means determines the hospitality operation portion used for each scene and a content of the hospitality operation by the hospitality operation portion. Since it takes long time to drive or stay in the vehicle, it is important to emphasize the hospitality in the drive-stay scene for the comfortable use of the vehicle by the user. The approach scene, preceding the drive-stay scene, takes the longest time next to the drive-stay scene. The approach scene is used efficiently as a chance for the hospitality, so that the mental condition of the user ready to face the drive-stay scene is improved, and the hospitality effect is further increased in the drive/stay scene.

To specify the above approach scene, the scene estimation information obtaining means can include an approach detection means for detecting an approach to the vehicle by the user in accordance with a relative distance between the vehicle and the user located outside the vehicle. The scene estimation information obtaining means can include a seat detection means for detecting a user who has sat on a seat of the vehicle. In both cases, the approach scene and drive-stay scene can be specified accurately.

In the approach scene, lighting devices mounted to the vehicle and lighting a space outside the vehicle (such as a headlamp, a tale lamp, and a hazard lamp: leak of an interior light through the windows can light the space outside the vehicle) can be defined as hospitality operation portions. Lighting of the lighting devices for receiving the user can be defined as a content of the hospitality operation. Therefore, the lights mounted in the vehicle can be used as illumination for the entertainment of receiving the user, and contributes to the uplift of the mood. Additionally, in the night and dark place, a position of the parked vehicle can be grasped easily.

The hospitality operation portions are not limited to facilities mounted to a vehicle, but may be peripheral facilities around a parked vehicle (for example, a fixture of a specified parking area), and may be personal effects always carried by the user. As one example of the latter case, the following structure can be shown. A host communications means provided to a parked vehicle or a peripheral facility of the vehicle and communicating with an outer terminal device, and a user terminal device carried by a user of the vehicle and having a terminal communications means which communicates with the host communications means via a radio communications network are provided. In the above approach scene, the hospitality operation portion can be a voice output portion provided to the user terminal device. In this case, the host communications means is the hospitality control section, which instructs the user terminal device to operate the voice output portion by means of radio communications. In this mode, when the user approaches the vehicle, the host communications means sends a radio instruction to the user terminal device so that the user terminal device, carried by the user, outputs a hospitality voice (such as music, sound effect, and reception terms), Then, the hospitality using the voice of the user approaching the vehicle can be executed effectively from the user terminal device carried by the user. The car audio system mounted to the vehicle using the voice can be used as the voice output portion. However, when the window is closed, the voice does not reach the user sufficiently. When the window is opened to leak the voice to the outside of the vehicle, this causes a nuisance to the neighbors. When the user terminal device is used as the hospitality voice output portion, the voice can be outputted under user's hand, increasing the hospitality effect considerably. The hospitality voice does not spread far, so that the nuisance is not caused.

In this case, the output of music and reception words from the voice output portion contributes to the improvement of the mental condition of the user. There is also a method for outputting messages for promoting the confirmation of precautions before start. Therefore, even in the same approach scene, another object to prevent a contingency can be achieved when the user does not confirm the precautions. For example, the message for promoting the confirmation of precautions can be a message for prompting confirmation about whether something is left and about lockup, but is not limited to this message.

In the drive-stay scene, an air conditioner mounted to the vehicle is defined as a hospitality operation portion. In this case, a set temperature of the air conditioner can be changed in accordance with the mental/physical condition of the user. Accordingly, human, kind control of the air conditioner is achieved in consideration of the user's feeling. In the drive-stay scene, a car audio system mounted to the vehicle can be defined as the hospitality operation portion.

Next, as finer (i.e., segmentalized) scenes, the scene specifying means can specify an approach scene when the user approaches the vehicle, a getting-on scene when the user gets on the vehicle, a drive-stay scene when the user drives or stays in the vehicle, and a getting-off scene when the user gets off the vehicle, sequentially. The hospitality content determining means can determine a hospitality operation portion for each scene and a content of a hospitality operation by the hospitality operation portion. In this mode, the getting-on scene and the getting-off scene are newly added to the above structure. Each of these scenes takes a short time. However, the work with great physical or mental burden such as opening and closing the door and loading and unloading luggage or such as consideration for obstacles and traffic danger when the door is opened or closed, are related to the scenes. When hospitality operations unique to these scenes are set to assist the work, the user can be certainly followed up before and after the drive-stay scene, which is the main scene. Additionally, more consistency and continuity are brought to the hospitality content received by the user from the vehicle, so that the user is further satisfied. Specifically, for example, in the getting-on scene and getting-off scene, the hospitality operation portion is defined as an automatic opening-closing device or an opening-closing assist mechanism for the door of the vehicle. The operation of the automatic opening-closing device or opening-closing assist mechanism for assisting the user in getting on the vehicle can be defined as content of the hospitality operation. In case of providing the opening-closing assist mechanism, a door opening restriction means can be provided for detecting an obstacle outside the vehicle to restrict the opening of the door and to avoid the interference of the obstacle with the door especially when the door is opened.

After the user gets off the vehicle, another scene such as a separation scene when the user separates from the vehicle can be added, and the corresponding hospitality operation can be done.

Next, the hospitality determination section can include: (i) an object estimation matrix storage portion for storing an object estimation matrix prepared in each of the scenes, the object estimation matrix having a two dimensional array formed by classification items for security, convenience, and comfort of the user using the vehicle and control target environment items belonging to at least a tactile sense, a visual sense, and a hearing sense relating to environment of the user outside or inside the vehicle, the object estimation matrix storage portion containing, in respective matrix cells, the hospitality objects which correspond to the classification items and the control target environment items and which are estimated to be desired by the user in each of the scenes, and (ii) a hospitality object extracting means for extracting the hospitality object corresponding to each of the classification items in each of the control target environment items in the object estimation matrix corresponding to the specified scene. The function extracting means can extract the function matching the extracted hospitality object from the function extraction matrix, and read the standard reference information corresponding to the extracted function.

In the object estimation matrix, since the hospitality objects are classified into at least tactile sense items, visual sense items, and hearing sense items in accordance with the five senses of the user directly receiving the hospitality effect, an output parameter and hospitality object to be controlled by the device can be related to each other directly. As a result, the hospitality function required in each scene can be specified easily and correctly for the hospitality object of the function extraction matrix.

The hospitality objects can be exampled as follows. As a tactile sense type hospitality object, a temperature can be a control target item. In this case, in the function extraction matrix, an air conditioner can be prepared as a function corresponding to this hospitality object. The air conditioner adjusts a temperature in the vehicle, and is used mainly in the drive/stay scene. For example, a set temperature of the air conditioner is lowered to calm the uplifted (or excited) mental condition, and to soften the feverish physical condition due to fatigue.

As a tactile sense type hospitality object, a vehicle interior inhabitancy condition is a control target item. A height and position of a seat have a great influence on the vehicle interior comfort condition. A position of a steering wheel is also important for the driver. Therefore, in the function extraction matrix, as functions for this hospitality object, a seat position adjustment function and a steering wheel position adjustment function can be prepared. These functions are used mainly in the drive/stay scene. For example, in case of distraction due to poor physical condition, a position of the seat is forwarded, and a position of the steering wheel is made slightly high, to assist the improvement of attention for driving. In contrast, in case of excitation or fatigue, a position of the seat is made backward, and a position of the steering wheel is made slightly low, to ease the excitation or fatigue.

Next, as a visual sense type hospitality object, brightness (inside and outside the vehicle) can be a control target item. In the function extraction matrix, as a function corresponding to this hospitality object, lighting devices outside and inside the vehicle can be prepared. The vehicle exterior illumination light includes a function necessary for traveling in the night, such as a headlamp. The vehicle exterior illumination light can be used as illumination for reception in the scene where the user approaches the vehicle. The vehicle exterior illumination light plays an important role in forming an atmosphere in the vehicle, as well as in grasping a position of operation devices in the vehicle. In this case, brightness and color of light can be adjusted in accordance with physical and mental conditions.

As a visual sense type hospitality object, visual sense information can be a control target item. The visual sense information is, for example, map information and video information such as television and DVD outputted to the car navigation device in the drive/stay scene. Therefore, in the function extraction matrix, as a function corresponding to this hospitality object, the car navigation device or a video output device is prepared.

As a hearing sense type hospitality object, sound can be a control target item. In the function extraction matrix, as a function corresponding to this hospitality object, a car audio system can be prepared. In this case, an output volume of the car audio system and a content of music selection of an outputted music source can be changed in accordance with the mental and physical condition information of the user. Accordingly, the music source desired by the user is automatically selected and played, so that the user driving or staying in the vehicle can be pleased timely. On the other hand, in the function extraction matrix, as a function operating on the background to adjust sound environment in the vehicle and corresponding to this hospitality object, a sound noise canceling system can be prepared.

Next, in the vehicular user hospitality system, a user condition calculating means for calculating a user condition index reflecting at least a physical condition of the user as a value in accordance with obtained user biological characteristic information can be provided. In this case, the standard reference information can be provided as a standard reference index reflecting a user condition, the index being a standard for controlling the corresponding function. The operation content determining means can include a value instruction information calculating means for calculating function operation instruction information as value instruction information relating to at least a physical condition of the user shown by the user biological characteristic information by compensating the standard reference index by the user condition index. Accordingly, the hospitality determination section can control the (selected) function at an appropriate operation level based on the user condition.

The above user condition index (and the standard reference index) can be a parameter reflecting only the physical condition, but physical condition and mental condition are usually related to each other. Therefore, the compensation for the user condition index can be done in accordance with the mental condition. Accordingly, selection of functions and setting of an operation level of a selected function can be determined more appropriately.

The standard reference index is a parameter showing an operation level of the corresponding function. As long as the standard reference index is a parameter directly used in calculation for determining the operation level, the standard reference index does not need to be a parameter showing only the operation level.

The user condition index can be calculated as a parameter uniquely increasing and decreasing in accordance with the physical condition of the user. In this case, the value instruction information calculation means can calculate value instruction information as information reflecting a difference value between the user condition index and standard reference index. In this structure, the standard reference index is obtained as a standard value of a branch point for determining whether to operate the function to be selected actively for improving the physical condition A difference value between the standard reference index and a user condition index reflecting the actual physical condition level can be obtained as a parameter directly showing a gap from a condition in which the function effect is the most optimized, namely, from a target situation in which the user is most satisfied. Therefore, as the difference value becomes larger, the hospitality control section can set the operation level of the function so that the physical condition reflected by the user condition index is improved more greatly or prevented from becoming worse more strongly. As a result, the function operation level can be optimized in accordance with the physical condition of the user.

The standard reference index in the above concept does not show an absolute level of the control value, but defines a standard level of the user condition index showing at least the physical condition of the user calculated in accordance with the user biological characteristic information. The standard reference index is a parameter for relatively determining whether the user is satisfied in the current controlled condition (regardless of the absolute level of the control value) in reference to the physical or mental condition of the user. When a difference (to be improved) is generated between the user condition index showing the actual physical or mental condition of the user and the standard reference index, the related functions are controlled to decrease the difference.

The user becomes dissatisfied due to the disturbance to some appropriate environment condition defined for the user. In the conventional concept, the appropriate environment condition is provided statistically as a fixed standard environment condition applicable to everybody, and the entire system is controlled in reference to only the standard environment condition. In the above concept, the appropriate environment condition is defined in reference to a physical or mental condition of each user to be provided with hospitality. Even the departure from the appropriate environment at the same disturbance level always changes in accordance with each user having a unique physical or mental condition. In other words, a difference value between the user condition index and standard reference index shows a degree of dissatisfaction of the user to be provided with hospitality as a value, but does not show a level of disturbance to be cancelled.

In the simple example, in accordance with how each user feels a vehicle interior temperature of 28° C. to be hot (uncomfortable), a range of decrease of the temperature can be changed. In other words, at the initial temperature of 28° C., the hospitality control section determines that a user A having a relatively large difference value is calmed down at a control value setting level of about 23° C., and a user B having a relatively small difference value is calmed down at a control value setting level of about 25° C.

Next, in the function extraction matrix, multiple different functions can be allocated to the same hospitality object. When the different standard reference indexes are applied to respective functions, the hospitality control section can prioritize an operation of a function having the different standard reference index causing a larger difference value in the function extraction matrix. When multiple functions relate to the same hospitality function, different standard reference indexes are provided to the respective functions, so that the usage priority of each function can be defined. Additionally, the number of functions operating in accordance with the condition of the user can be increased and decreased properly. In this case, the hospitality control section can prohibit an operation of the function having the standard reference index causing a difference value of a predetermined lowermost value or less in the function extraction matrix. By actively prohibiting an operation of the function having a difference value of under a predetermined lowermost value and thus having the low usage priority, excess operations of the functions can be excluded for the hospitality object, and hospitality operations can be further optimized.

As the physical condition of the user reflected by the obtained user biological characteristic information is more excellent, the user condition index calculating means can calculate the user condition index so that the user condition index uniquely changes more greatly only in one direction of either the predetermined increasing or decreasing direction. In this case, the operation content determining means can adjust an electric output level of a function in accordance with a value of the user condition index. Accordingly, the user can be satisfied quickly.

Specifically, when the function is an air conditioner, the operation content determining means determines a content of the operation so that an air conditioning output level increases more largely as the difference value is larger. Accordingly, it can be obtained how much the user feels “hot” or “cold” from a value of the user condition index, and the output level of the air conditioner (heating or cooling) can be controlled to achieve an appropriate condition of each user.

When the function is a car audio system, the operation content determining means can determine a content of the operation so that a volume of the output sound increases further as the difference value becomes greater. Accordingly, as the physical condition (or mental condition) of the user becomes more excellent, the audio output increases further, so that the mood of the user can be uplifted, and the fatigue can be restrained from progressing. On the other hand, when the function is a car audio system, the operation content determining means can change a music selection of music source outputted from the car audio system in accordance with the difference value. Accordingly, appropriate music selection can be done in accordance with the physical and mental conditions in each case. For example, what music source (song) is appropriate in each physical or mental condition is obtained experientially (for example, from a music selection statistics, described later) to define an unambiguous relationship between songs and the user condition indexes (or the difference values). Accordingly, music selection can be easily optimized in accordance with the user condition index (or the difference value).

When the selected function is a vehicle interior lighting device, the operation content determining means can determine a content of the operation so that an amount of the light increases further as the difference value becomes greater. Accordingly, as the physical condition (or mental condition) of the user becomes more excellent, an amount of the vehicle interior light increases further, so that the mood of the user can be uplifted.

As described above, usually, the physical condition and mental condition are not independent of each other extremely. The physical condition and mental condition are usually related to each other, so that a content of the function determined in priority to the physical condition usually matches a content of fine adjustment (compensation) using the mental condition. Accordingly, the user condition index is calculated to reflect the physical condition of the user mainly, and the operation content determining means can adjust a content of the operation output of the function in accordance with the mental condition of the user reflected by the obtained user biological characteristic information, independently of the adjustment of the electric output level. The outline of the operation output content of the function is determined in priority to the physical condition, and the operation output content is fine adjusted in accordance with the mental condition, so that the hospitality control algorithm can be simplified although the hospitality control is done in consideration of both the physical and mental conditions.

Specifically, when the function is a vehicle interior lighting device, the operation content determining means can determine the operation output content of the vehicle interior lighting device so that a light color of a shorter wavelength (for example, pale green, blue, pale blue, and bluish white) is generated as the mental condition of the user reflected by the obtained user biological characteristic information is uplifted higher. These colors of the light are cold colors, which ease the uplifted mental condition, and provide refreshing effect in the vehicle interior environment. On the other hand, when the mental condition is depressed, the color of the light is shifted to colors of a longer wavelength (yellow, umber, red, pink, or white tinged with these colors). The colors of the lights are warm colors, which provides relaxation by the warm entertainment for uplifting the mood.

On the other hand, when the function is an air conditioner, the operation content determining means can determine the operation output content so that the set temperature decreases further as the mental condition of the user reflected by the obtained user biological characteristic information is uplifted higher. In case of a too much uplifted mental condition, the body temperature tends to increase, which can be cooled down by decreasing a temperature of the air conditioning. On the other hand, in case of a depressed mental condition, the set temperature is increased, and sweating and blood circulation can be promoted to uplift the mood and physical condition.

When the function is a car audio system, the operation content determining means can select music matching the mental condition of the user in accordance with the mental condition reflected by the obtained user biological characteristic information, and determine an operation output content of the car audio system to adjust the output volume in accordance with a value of the user condition index. Accordingly, the proper music selection can be done in accordance with the mental condition, and the user can enjoy the selected music at a sound volume suitable for the physical condition. In the music selection, as well as the mental condition, the physical condition can be considered.

Next, the user biological characteristic information obtaining means can include: the user biological condition change detection portion for detecting a predetermined biological condition of the user as a temporal change of a biological condition parameter, which is a numeral parameter reflecting the biological condition; and a mental/physical condition estimating means for generating user biological characteristic information as information for estimating a physical and mental conditions of the user in accordance with a temporal change of the detected biological condition parameter.

The biological condition change detection portion can detect a waveform of a temporal change of a biological condition parameter In this case, the mental/physical condition estimating means can estimate a physical condition of the user in accordance with amplitude information about the waveform. For example, when a physical condition of the user decreases, a biological condition reflecting the physical condition changes small. Namely, from the fact that an amplitude of a temporal change waveform of the biological condition parameter tends to decrease, an abnormality of the physical condition such as the disease and fatigue can be detected accurately. On the other hand, the mental/physical condition estimating means can estimate a mental condition of the user in accordance with a frequency information of the Waveform. Stability or instability of the mental condition is often reflected by a changing speed of the biological condition, and the changing speed is reflected by a frequency of a parameter waveform of the biological condition, so that a mental condition of the user can be estimated accurately in accordance with the frequency information.

The biological condition change detection portion can detect a temporal change condition of a body temperature of the user as temporal change information about a biological condition parameter. A body temperature reflects a physical condition and mental condition, particularly reflects the physical condition remarkably (for example, a fluctuation range of the body temperature (waveform amplitude) becomes small in case of poor physical condition), and a remote measurement of a body temperature by an infrared measurement (such as thermography of a face) is possible. In various scenes when the user approaches, gets on, gets off, and separates from the vehicle, in addition to the scene when the user drives (or stays) in the vehicle, the body temperature can be used for estimating a condition of the user, contributing to diversification of the scenes where accurate hospitality operations are to be provided.

The biological condition change detection portion can obtain a temporal change condition of at least one of a facial expression and viewing direction of the user as a temporal change condition of the biological condition parameter. These two parameters reflect the physical condition and mental condition of the user significantly (particularly reflect the mental condition). The remote measurement of the parameters by use of image capturing is possible. In various scenes when the user approaches, gets on, gets off, and separates from the vehicle, in addition to the scene when the user drives or stays in the vehicle, the two parameters can be used for estimating a condition of the user, contributing to diversification of the scenes where accurate hospitality operations are to be provided.

The hospitality operation portion can execute a hospitality operation while the user is driving the vehicle. The biological condition change detection portion can detect a temporal change of a biological condition parameter while the user is driving the vehicle. Accordingly, the hospitality operation on the driving is optimized in accordance with a mental or physical condition of the driver (user), so that a comfortable, safer driving of the vehicle can be achieved.

The biological condition change detection portion can obtain temporal change conditions of first type biological condition parameters including one or more of a blood pressure, heart rate, body temperature, skin resistance, and sweating, as a temporal change condition of the biological condition parameter. The first type biological condition parameter shows a change of an inner physical condition of the driver. A temporal change (waveform) of the first type biological condition parameter reflects a mental condition (or psychological condition) and physical condition of the driver, particularly reflects the mental condition. Accordingly, by analyzing the first type biological condition parameter, the hospitality operation for the driver can be optimized effectively. The first type biological condition parameter can be measured directly from a sensor mounted to a grasped position of a steering wheel by the user. The temporal change of the first type biological condition parameter can be obtained sharply. Specifically, when the driver senses a danger, and thus feels cold, or flares up at interruption or overtaking (mental excitation), sweating appears significantly, and heartbeat rises. Then, waveforms (particularly, amplitudes) of the first type biological condition parameters such as a blood pressure, heart rate, body temperature, and skin resistance (sweating) change significantly. Also when the driver is distracted by looking aside, waveforms of the first type biological condition parameters change in the same way as above. In this case, the mental-physical condition estimation means can estimate that a mental condition of the user is abnormal when a waveform frequency of the first type biological condition parameter becomes equal to or higher than a predetermined level.

The biological condition change detection portion can detect a temporal change condition of a second type biological condition parameter including at least one of a driving attitude, viewing direction, and facial expression of the user, as a temporal change condition of a biological condition parameter. The second type biological condition parameter shows a change of an outer physical condition of the driver. The second type biological condition parameter reflects deconditioning, disease, or fatigue, and an amplitude of the parameter tends to shrink. Therefore, the mental-physical condition estimating means can estimate that an abnormality occurs in a physical condition of the user when a waveform amplitude of the second type biological condition parameter becomes a predetermined level or under.

The waveform of the second type biological condition parameter can be used effectively to grasp a mental condition of the driver. For example, when the driver is excited, an attitude of the driver changes frequently, but the viewing direction changes small, namely, the eyes are set. When the driver is in an instable mental condition, the facial expression changes considerably. In this case, the mental/physical condition estimation means can estimate that an abnormality occurs in the mental condition of the user when a waveform frequency of the second type biological condition parameter becomes a predetermined level or over, or a predetermined level or under (which case is selected depends on a kind of the parameter).

Temporal change information about the biological condition parameter, different from the frequency and amplitude, is also used for grasping a mental or physical condition. For example, the biological condition change detection portion can detect a temporal change of a pupil size of the user as a temporal change of the biological condition parameter. The mental/physical condition estimation means can estimate that an abnormality occurs in the physical condition of the user when the detected pupil size changes to a predetermined level or over. This is because bleary eyes and flickers often appear when focusing and brightness adjustment of the eyes become instable due to fatigue. On the other hand, when the driver is excited abnormally due to anger, the driver often opens his or her eyes wide. In this case, the mental/physical condition estimation means can estimate that an abnormality occurs in the mental condition of the user when the detected pupil size becomes a predetermined level or over.

Multiple biological condition change detection portions can be provided. The mental/physical condition estimation means can estimate a mental or physical condition of the user in accordance with a combination of temporal changes of biological parameters detected by the multiple biological condition change detection portions. By combining the multiple biological condition parameters, types of the mental or physical conditions which can be estimated (namely, identified) can be diversified (or fragmented), and an accuracy of the estimation can be increased. In this case, a determination table is provided for storing the correspondence between estimation levels of the physical or mental conditions of the user to be estimated and combinations of temporal changes of the biological condition parameters to be detected by the multiple biological condition change detecting portions, each of the combinations being required to establish each of the estimation levels. The mental/physical estimating means checks combinations of temporal changes of the detected multiple biological parameters with the combinations of the determination table. The estimation level corresponding to the matched combination can be specified as a currently established estimation level. Accordingly, even when many biological condition parameters are considered, the estimation level can be specified efficiently.

The user condition index calculating means can calculate the user condition index by use of the estimation level of the specified physical or mental condition. Accordingly, by use of the temporal changes of the biological condition parameters detected by the biological condition detecting portions, the physical or mental condition of the user can be digitalized as the user condition index precisely.

The specified conditions can include at least “distraction,” “poor physical condition,” and “excitation.” When the mental/physical condition estimating means estimates that the user (driver) has been distracted, the hospitality control section can make the hospitality operation portion awake the user. Accordingly, the user can concentrate on driving. When the mental/physical condition estimation means estimates that the user is in poor physical condition, the hospitality control section can control the corresponding hospitality operation portion to ease the disturbance influence on the user. Due to the reduction of the disturbance influence, the increase of physical fatigue caused by psychological burden can be restricted, so that the pain of the driver can be decreased. When the mental/physical condition estimating means estimates that the user has been excited, the hospitality control section can make the hospitality operation portion execute an operation for easing mental tension of the user. Accordingly, the excited mental condition of the driver can be calmed, so that cool, mild driving can be achieved.

It will be obvious to those skilled in the art that various changes may be made in the above-described embodiments of the present invention. However, the scope of the present invention should be determined by the following claims.

What is claimed is:

1. A vehicular user hospitality system comprising:
hospitality operation portions for executing a hospitality operation to assist use of a vehicle by a user or to entertain the user in each of a plurality of scenes, into which a series of motions of the user using the vehicle when the user approaches, gets on, drives or stays in, and gets off the vehicle are divided;
a hospitality determination section including
(i) a scene estimation information obtaining means for obtaining a position or a motion of the user as scene estimation information, the position and the motion being predetermined in each of the scenes,
(ii) a scene specifying means for specifying each of the scenes in accordance with the obtained scene estimation information, and
(iii) a hospitality content determining means for determining a hospitality operation portion to be used and a content of a hospitality operation by the hospitality operation portion to be used in accordance with the specified scene; and
a hospitality control section for executing the hospitality operation in accordance with the content determined by the hospitality determination section by controlling an operation of the corresponding hospitality operation portion, wherein
the hospitality determination section includes
(i) a function extraction matrix storage portion for storing a function extraction matrix having a two-dimensional array formed by type items of hospitality objects prepared for each of the scenes and function items of the hospitality operation portions, the function extraction matrix including standard reference information referenced as a standard to recognize whether a function corresponding to each matrix cell matches the hospitality object corresponding to the each matrix cell when an operation of the function is controlled,
(ii) a function extracting means for extracting a function matching the hospitality object for the specified scene, and reading the standard reference information corresponding to the extracted function,
(iii) a user biological characteristic information obtaining means for obtaining at least one of a physical condition and a mental condition of the user, and
(iv) an operation content determining means for determining an operation content of a corresponding function in accordance with the obtained user biological characteristic information and the obtained standard reference information.

2. The vehicular user hospitality system of claim 1, wherein:
the hospitality determination section includes
(i) an object estimation matrix storage portion for storing an object estimation matrix prepared in each of the scenes, the object estimation matrix having a two dimensional array formed by classification items for security, convenience, and comfort of the user using the vehicle and control target environment items belonging to at least a tactile sense, a visual sense, and a hearing sense relating to environment of the user outside or inside the vehicle, the object estimation matrix storage portion containing, in respective matrix cells, the hospitality objects which correspond to the classification items and the control target environment items and which are estimated to be desired by the user in each of the scenes, and
(ii) a hospitality object extracting means for extracting the hospitality object corresponding to each of the classification items in each of the control target environment items in the object estimation matrix corresponding to the specified scene; and
the function extracting means extracts the function matching the extracted hospitality object from the function extraction matrix, and reads the standard reference information corresponding to the extracted function.

3. The vehicular user hospitality system of claim 1, wherein when the hospitality object is directed to a temperature as the control target environment item, an air conditioner is prepared as the function corresponding to the hospitality object in the function extraction matrix.

4. The vehicular user hospitality system of claim 1, wherein when the hospitality object is directed to a brightness as the control target environment item, a lighting device outside or inside the vehicle is prepared as the function corresponding to the hospitality object in the function extraction matrix.

5. The vehicular user hospitality system of claim 1, wherein when the hospitality object is directed to a sound as the control target environment item, a car audio system is prepared as the function corresponding to the hospitality object in the function extraction matrix.

6. The vehicular user hospitality system of claim 1, wherein when the hospitality object is directed to a sound as the control target environment item, a sound noise canceling system is prepared as the function corresponding to the hospitality object in the function extraction matrix.

7. The vehicular user hospitality system of claim 1, further comprising:
a user condition index calculating means for calculating a user condition index reflecting at least a physical condition of the user as a value in accordance with the obtained user biological characteristic information, wherein:
the standard reference information is provided as a standard reference index reflecting a user condition, which is a standard for controlling an operation of the corresponding function;
the operation content determining means includes a value instruction information calculating means for calculating operation instruction information for the function as value instruction information relating to at least the physical condition of the user, the physical condition being shown by the user biological characteristic information, by compensating the standard reference index with the user condition index; and
the hospitality control section controls the operation of the function at an operation level corresponding to the value instruction information.

8. The vehicular user hospitality system of claim 7, wherein:
the user condition index is calculated as a parameter uniquely increasing and decreasing in accordance with the physical condition of the user;
the value instruction information calculating means calculates the value instruction information as information reflecting a difference value between the user condition index and the standard reference index; and
the hospitality control section sets an operation level of the function to contribute more significantly to improvement of the physical condition or to inhibition of deterioration of the physical condition as the difference value becomes greater, the physical condition being reflected by the user condition index.

9. The vehicular user hospitality system of claim 8, wherein
when (i) a plurality of functions different from each other are allocated to the same hospitality object and (ii) the standard reference indexes are provided to the functions respectively as different values in the function extraction matrix, the hospitality control section operates the function having the standard reference index generating the greater difference value more preferentially.

10. The vehicular user hospitality system of claim 8, wherein the hospitality control section inhibits an operation of the function having the standard reference index generating the difference value of a predetermined lowermost value or under in the function extraction matrix.

11. The vehicular user hospitality system of claim 8, wherein:
the user condition index calculating means calculates the user condition index so that the user condition index uniquely changes more significantly in one direction of either a predetermined increasing direction or a predetermined decreasing direction as the user condition reflected by the obtained user biological characteristic information is more excellent; and
the operation content determining means adjusts an electric output level of the function in accordance with a value of the user condition index.

12. The vehicular user hospitality system of claim 11, wherein when the function is an air conditioner, the operation content determining means determines the operation content so that an air conditioning output level increases more significantly as the difference value becomes greater.

13. The vehicular user hospitality system of claim 11, wherein when the function is a car audio system, the operation content determining means determines the operation content so that an output sound volume increases more significantly as the difference value becomes greater.

14. The vehicular user hospitality system of claim 11, wherein when the function is the car audio system, the operation content determining means changes a content of music selection of a music source outputted from the car audio system in accordance with the difference value.

15. The vehicular user hospitality system of claim 11, wherein when the function is a vehicle interior light, the operation content determining means determines the operation content so that brightness increases more significantly as the difference value becomes greater.

16. The vehicular user hospitality system of claim 11, wherein the operation content determining means adjusts an operation output content of the function to a content matching mental condition of the user reflected by the user biological characteristic information in accordance with the mental condition, independently of adjustment of the electric output level.

17. The vehicular user hospitality system of claim 16 wherein when the function is a vehicle interior lighting device, the operation content determining means determines an operation content of the vehicle interior lighting device so that a color of the light of the vehicle interior lighting device is a lighting color of a shorter wavelength as the mental condition of the user reflected by the obtained user biological characteristic information is uplifted higher.

18. The vehicular user hospitality system of claim 16, wherein when the function is an air conditioner, the operation content determining means determines an operation content of the air conditioner so that a set temperature of the air conditioner becomes lower as the mental condition of the user reflected by the obtained user biological characteristic information is uplifted higher.

19. The vehicular user hospitality system of claim 16, wherein when the function is a car audio system, the operation content determining means executes music selection matching the mental condition of the user reflected by the obtained user biological characteristic information in accordance with the mental condition and determines an operation output content of the car audio system to adjust an output sound volume in accordance with a value of the user condition index.

20. The vehicular user hospitality system of claim 1, wherein the user biological characteristic information obtaining means includes:
a user biological condition change detection portion for detecting a predetermined biological condition of the user as a temporal change of a biological condition parameter, which is a value parameter reflecting the biological condition; and
a mental/physical condition estimating means for generating the user biological characteristic information as information for estimating physical and mental conditions of the user in accordance with the detected temporal change of the biological condition parameter.

21. The vehicular user hospitality system of claim 20, wherein:
the biological condition change detection portion detects a temporal change waveform of the biological condition parameter; and
the mental/physical condition estimating means generates physical condition estimation information for estimating the physical condition of the user in accordance with amplitude information of the waveform.

22. The vehicular user hospitality system of claim 20, wherein:
the biological condition change detection portion detects a temporal change waveform of the biological condition parameter; and
the mental/physical condition estimating means generates mental condition estimation information for estimating the mental condition of the user in accordance with frequency information of the waveform.

23. The vehicular user hospitality system of claim 20, wherein:
a plurality of biological condition change detection portions are provided; and
the mental/physical condition estimating means estimates the physical or mental condition of the user in accordance with a combination of temporal change conditions of the biological condition parameters detected by the plurality of biological condition change detection portions.

24. The vehicular user hospitality system of claim 23, wherein:
a determination table is provided for storing correspondence between estimation levels of the physical or mental conditions of the user to be estimated and combinations of the temporal change conditions of the biological condition parameters to be detected by the plurality of biological condition change detection portions, each of the combinations being required to establish each of the estimation levels; and
the mental/physical estimation means checks combinations of temporal change conditions of detected biological condition parameters with the combinations on the determination table, and specifies the estimation level corresponding to the matched combination as a currently established estimation level.

25. The vehicular user hospitality system of claim 24, further comprising:
a user condition index calculating means for calculating a user condition index reflecting at least a physical condition of the user as a value in accordance with the obtained user biological characteristic information, wherein:
the standard reference information is provided as a standard reference index reflecting a user condition, which is a standard for controlling an operation of the corresponding function,
the operation content determining means includes a value instruction information calculating means for calculating operation instruction information for the function as value instruction information relating to at least the physical condition of the user, the physical condition being shown by the user biological characteristic information, by compensating the standard reference index with the user condition index;
the hospitality control section controls the operation of the function at an operation level corresponding to the value instruction information; and
the user condition index calculating means calculates the user condition index by use of the specified estimation level of the physical or mental condition.
